(19) United States
(12) Patent Application Publication
(10) Pub. No.: US 2026/0039871 A1
(43) Pub. Date: Feb. 5, 2026

(54) POINT CLOUD ENCODING AND DECODING METHOD AND APPARATUS, DEVICE AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/352,928

(22) Filed: Oct. 8, 2025

Related U.S. Application Data
(63) Continuation of application No. PCT/CN2023/087655, filed on Apr. 11, 2023.

(51) Int. Cl. H04N 19/597; H04N 19/105; H04N 19/169; H04N 19/18; H04N 19/70

(52) U.S. Cl. CPC H04N 19/597; H04N 19/105; H04N 19/18; H04N 19/1883; H04N 19/70

(57) ABSTRACT

The present application provides a point cloud encoding and decoding method, which includes: during attribute encoding or decoding, determining a first parameter, the first parameter being used to indicate a neighborhood search range; determining N neighborhood nodes of a current node based on the neighborhood search range; and performing attribute prediction encoding and decoding on the current node based on attribute information of the N neighborhood nodes.

### CROSS-REFERENCE TO RELATED APPLICATION

This application is a Continuation application of International Application No. PCT/CN2023/087655 filed on Apr. 11, 2023, which is incorporated herein by reference in its entirety.

### TECHNICAL FIELD

The present disclosure relates to the field of point cloud technology, and in particular, to point cloud encoding and decoding methods, apparatuses, a device, and a storage medium.

### RELATED ART

A surface of an object is captured by an acquisition device to form point cloud data, and the point cloud data includes hundreds of thousands or even more points. During a video production process, the point cloud data is transmitted between a point cloud encoding device and a point cloud decoding device in the form of a point cloud media file. However, such a large number of points pose a challenge for transmission. Thus, the point cloud encoding device needs to compress the point cloud data before transmitting the point cloud data.

Point cloud compression is also called point cloud encoding. A point cloud attribute encoding process includes a hierarchical transform prediction, such as region adaptive hierarchical transform (RAHT) transform prediction, that is, the transform is performed continuously from a root node to a voxel node based on a point cloud partition tree. When performing attribute prediction on a current node in the partition tree, the encoding and decoding performance is poor.

### SUMMARY

Embodiments of the present disclosure provide point cloud encoding and decoding methods, apparatuses, a device, and a storage medium.

In a first aspect, an embodiment of the present disclosure provides a point cloud decoding method, which includes:
determining a first parameter, where the first parameter is used to indicate a maximum number M of reference points capable of being buffered in a prediction reference buffer, where M is a positive integer;
determining M reference points based on the first parameter, and storing the M reference points in the prediction reference buffer; and
determining an attribute prediction value of a current point based on the reference points included in the prediction reference buffer.

In a second aspect, the present disclosure provides a point cloud encoding method, which includes:
determining a first parameter, where the first parameter is used to indicate a maximum number M of reference points capable of being buffered in a prediction reference buffer, where M is a positive integer;
determining M reference points based on the first parameter, and storing the M reference points in the prediction reference buffer; and
determining an attribute prediction value of a current point based on the reference points included in the prediction reference buffer.

In a third aspect, the present disclosure provides a point cloud decoding apparatus, which is used to perform the method in the first aspect or in various implementations thereof. In some implementations, the apparatus includes functional units used to perform the method in the first aspect or in various implementations thereof.

In a fourth aspect, the present disclosure provides a point cloud encoding apparatus, which is used to perform the method in the second aspect or in various implementations thereof. In some implementations, the apparatus includes functional units used to perform the method in the second aspect or in various implementations thereof.

In a fifth aspect, a point cloud decoder is provided, which includes a processor and a memory. The memory is used to store a computer program, and the processor is used to call the computer program stored in the memory and run the computer program, to perform the method in the first aspect or in various implementations thereof.

In a sixth aspect, a point cloud encoder is provided, which includes a processor and a memory. The memory is used to store a computer program, and the processor is used to call the computer program stored in the memory and run the computer program, to perform the method in the second aspect or in various implementations thereof.

In a seventh aspect, a point cloud encoding and decoding system is provided, which includes a point cloud encoder and a point cloud decoder. The point cloud decoder is used to perform the method in the first aspect or in various implementations thereof, and the point cloud encoder is used to perform the method in the second aspect or in various implementations thereof.

In an eighth aspect, a chip is provided, which is used to implement the method in any one of the first aspect to the second aspect or in various implementations thereof. In some implementations, the chip includes: a processor, which is used to call a computer program from a memory and run the computer program, to enable a device equipped with the chip to perform the method in any one of the first aspect to the second aspect or in various implementations thereof.

In a ninth aspect, a non-transitory computer-readable storage medium is provided, which is used to store a computer program, the computer program enables a computer to perform the method in any one of the first aspect to the second aspect or in various implementations thereof.

In a tenth aspect, a computer program product is provided, which includes computer program instructions, the computer program instructions enable a computer to perform the method in any one of the first aspect to the second aspect or in various implementations thereof.

In an eleventh aspect, a computer program is provided, and the computer program, when run on a computer, enables the computer to perform the method in any one of the first aspect to the second aspect or in various implementations thereof.

In a twelfth aspect, a bitstream is provided, the bitstream is generated based on the method of the second aspect.

### BRIEF DESCRIPTION OF THE DRAWINGS

FIG. 1A is a schematic diagram of a point cloud.

FIG. 1B is a partially enlarged diagram of a point cloud.

FIG. 2 is a schematic diagram of a point cloud picture at six viewing angles.

FIG. 3 is a schematic block diagram of a point cloud encoding and decoding system involved in embodiments of the present disclosure.

FIG. 4A is a schematic block diagram of a point cloud encoder provided in embodiments of the present disclosure.

FIG. 4B is a schematic block diagram of a point cloud decoder provided in embodiments of the present disclosure.

FIG. 5A is a schematic diagram of a plane.

FIG. 5B is a schematic diagram of a node encoding sequence.

FIG. 5C is a schematic diagram of a planar identification.

FIG. 5D is a schematic diagram of sibling nodes.

FIG. 5E is a schematic diagram of an intersection of a laser radar and a node.

FIG. 5F is a schematic diagram of a neighborhood node at the same partition depth and the same coordinate.

FIG. 5G is a schematic diagram of neighborhood nodes in a case where a node is located at a low planar position of a parent node.

FIG. 5H is a schematic diagram of neighborhood nodes in a case where a node is located at a high planar position of a parent node.

FIG. 5I is a schematic diagram of a predictive encoding of planar position information of a laser radar point cloud.

FIG. 6 is a schematic diagram of infer direct coding model (IDCM) encoding.

FIGS. 7A to 7C are schematic diagrams of a geometric information encoding based on triangle soup.

FIG. 8A is a schematic diagram of a distance-based level of detail (LOD) construction.

FIG. 8B is a subjective schematic diagram of a distance-based LOD generation process.

FIG. 8C is a flowchart of a predictive encoding.

FIG. 8D is a schematic diagram of a LOD partition.

FIG. 8E is a schematic diagram of an inter-level nearest neighbor search.

FIG. 8F is a schematic diagram of a nearest neighbor search based on spatial relationships.

FIG. 8G is a schematic diagram of a nearest neighbor search for co-planar, co-edge and co-vertex.

FIG. 8H is a schematic diagram of a neighbor search.

FIG. 8I is a schematic diagram of a neighbor search.

FIG. 8J is a schematic diagram of a neighbor search based on a fast search algorithm.

FIG. 8K is a schematic diagram of an inter nearest neighbor search.

FIG. 8L is a flowchart of a lifting transform.

FIG. 8M is a schematic diagram of a region adaptive hierarchical transform (RAHT) transform process along x, y, and z directions.

FIG. 8N is a schematic diagram of RAHT transform.

FIG. 8O is a schematic diagram of RAHT forward transform and inverse transform.

FIG. 9A is a schematic diagram of a neighborhood node.

FIG. 9B is a schematic diagram of a process of region adaptive hierarchical predicting transform encoding involved in embodiments of the present disclosure.

FIG. 10 is a flowchart schematic of a point cloud decoding method provided by an embodiment of the present disclosure.

FIG. 11 is a schematic diagram of an octree partition.

FIG. 12 is a schematic diagram of a neighborhood node search.

FIG. 13 is a schematic diagram of an attribute prediction.

FIG. 14 is a schematic flowchart of a point cloud encoding method provided in an embodiment of the present disclosure.

FIG. 15 is a schematic block diagram of a point cloud decoding apparatus provided in embodiments of the present disclosure.

FIG. 16 is a schematic block diagram of a point cloud encoding apparatus provided in embodiments of the present disclosure.

FIG. 17 is a schematic block diagram of an electronic device provided in embodiments of the present disclosure.

FIG. 18 is a schematic block diagram of a point cloud encoding and decoding system provided in embodiments of the present disclosure.

### DETAILED DESCRIPTION

The present disclosure may be applied to the field of point cloud up-sampling technology, for example, may be applied to the field of point cloud compression technology.

To facilitate the understanding of embodiments of the present disclosure, related concepts involved in the embodiments of the present disclosure are briefly introduced as follows.

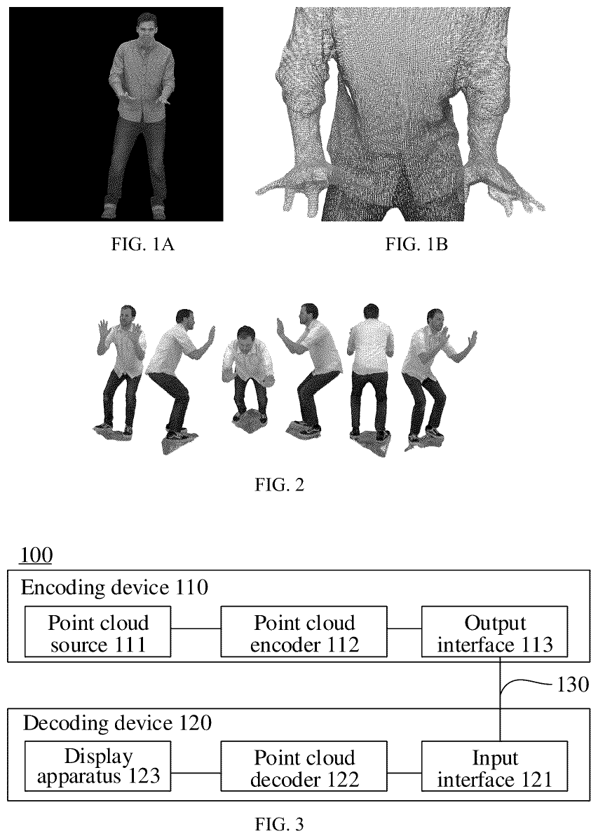

A point cloud refers to a set of discrete points in space that are irregularly distributed and express spatial structures and surface attributes of three-dimensional objects or three-dimensional scenes. FIG. 1A is a schematic diagram of a three-dimensional point cloud picture. FIG. 1B is a partially enlarged diagram of FIG. 1A. It may be seen from FIG. 1A and FIG. 1B that a point cloud surface is composed of densely distributed points.

A two-dimensional picture has information expression at each sample point, with a regular distribution, so there is no need to record position information of the two-dimensional picture additionally. However, distribution of points in a point cloud in three-dimensional space is random and irregular, so it is necessary to record a position of each point in space in order to fully express the entire point cloud. Similar to the two-dimensional picture, each position in a collection process has corresponding attribute information.

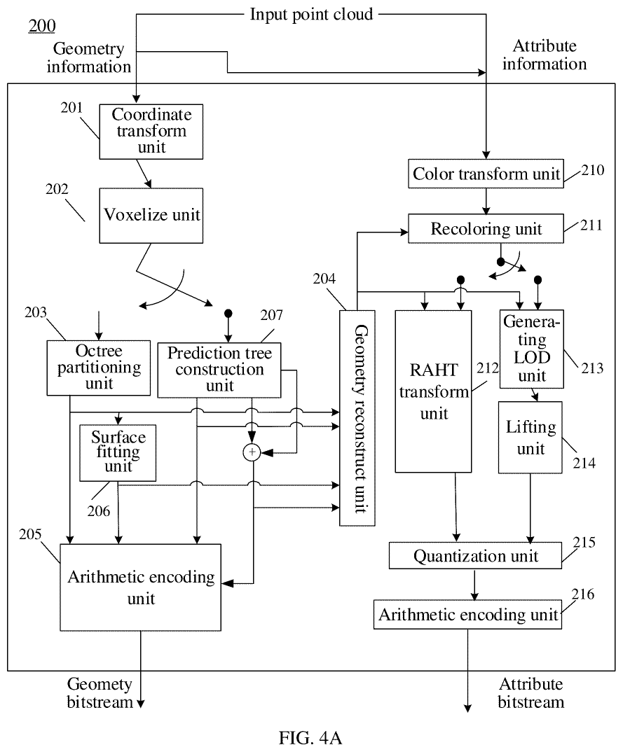

Point cloud data is a specific record form of a point cloud. A point in the point cloud may include position information and attribute information of the point. For example, the position information of the point may be three-dimensional coordinate information of the point. The position information of the point may also be referred to as geometric information of the point. For example, the attribute information of the point may include color information, reflectance information, normal vector information, or the like. The color information reflects a color of an object. The reflectance information reflects a surface material of an object. The color information may be information in any color space. For example, the color information may be RGB. As another example, the color information may be luma and chroma (YCbCr, YUV) information. For example, Y represents luma, Cb (U) represents blue color difference, Cr (V) represents red, and U and V represent chroma for describing color difference information. For example, for a point cloud obtained according to a laser measurement principle, a point in the point cloud may include three-dimensional coordinate information of the point and laser reflectance intensity of the point. As another example, for a point cloud obtained according to a photogrammetry principle, a point in the point cloud may include three-dimensional coordinate information of the point and color information of the point. As yet another example, for a point cloud obtained by combining the laser measurement principle and the photogrammetry principle, a point in the point cloud may include three-dimensional coordinate information of the point, laser reflectance intensity of the point, and color information of the point. FIG. 2 illustrates a point cloud picture, where FIG. 2 illustrates the point cloud picture at six viewing angles. Table 1 shows a point cloud data storage format consisting of a file header information part and a data part.

TABLE 1

| | |
|---|---|
| 1 | ply |
| 2 | format ascii 1.0 |
| 3 | element vertex 207242 |
| 4 | property float x |
| 5 | property float y |
| 6 | property float z |
| 7 | property uchar red |
| 8 | property uchar green |
| 9 | property uchar blue |
| 10 | end_ header |
| 11 | 75 318 0 0 142 0 |
| 12 | 75 319 0 0 143 0 |
| 13 | 75 319 1 1 9 9 |
| 14 | 77 315 0 1 9 9 |

In Table 1, the header information includes data format, data representation type, a total number of points in the point cloud, and the content represented by the point cloud. For example, the point cloud in this example is in “.ply” format, represented by ASCII code, with a total of 207,242 points. Each point has three-dimensional position information XYZ and three-dimensional color information RGB.

The point cloud may flexibly and conveniently express spatial structures and surface attributes of three-dimensional objects or scenes. Moreover, the point cloud is obtained by directly sampling real objects, and the point cloud may provide a strong sense of reality under the premise of ensuring accuracy; therefore, the point cloud has a wide range of applications, which include virtual reality games, computer-aided design, geographic information systems, automatic navigation systems, digital cultural heritage, free-viewpoint broadcasting, three-dimensional immersive remote presentation, and three-dimensional reconstruction of biological tissues and organs.

Acquisition approaches for the point cloud data may include, but are not limited to, at least one of the following: (1) generated by a computer device, where the computer device may generate the point cloud data based on virtual three-dimensional objects and virtual three-dimensional scenes; (2) acquired by 3-Dimension (3D) laser scanning, where point cloud data of three-dimensional objects or three-dimensional scenes of static real world may be acquired by the 3D laser scanning, and millions of point cloud data may be acquired per second; (3) acquired by 3D photogrammetry, where visual scenes of real world are collected by a 3D photography device (i.e., a group of cameras or a camera device with multiple lenses and multiple sensors), to acquire point cloud data of the visual scenes in real world, and point cloud data of three-dimensional objects or three-dimensional scenes of dynamic real world may be acquired by 3D photography; or (4) point cloud data of biological tissues and organs acquired by a medical device, where in the medical field, the point cloud data of biological tissues and organs may be acquired by a medical device such as magnetic resonance imaging (MRI), computed tomography (CT), and electromagnetic positioning information.

Point clouds may be classified into dense point clouds and sparse point clouds based on acquisition approaches.

The point clouds are classified into the following types based on a time series of the data:
first type: static point clouds, where an object is stationary and a device for acquiring the point cloud is also stationary;
second type: dynamic point clouds, where an object is in motion but a device for acquiring the point cloud is stationary; and
third type: dynamically acquired point clouds, where a device for acquiring the point cloud is in motion.

The point clouds may be classified into two types based on uses of point clouds:
type 1: point clouds perceived by machines, which may be used in scenes such as autonomous navigation systems, real-time inspection systems, geographic information systems, visual sorting robots, and emergency rescue and disaster relief robots; and
type 2: point clouds perceived by human eyes, which may be used in point cloud application scenes such as digital cultural heritage, free-viewpoint broadcasting, three-dimensional immersive communication, and three-dimensional immersive interaction.

Through the above point cloud acquisition technologies, the cost and time period of acquiring the point cloud data are reduced and the accuracy of the data is improved. Change in the acquisition approaches of the point cloud data makes it possible to acquire a large amount of point cloud data. However, with growth of application requirements, processing of massive 3D point cloud data encounters bottlenecks caused by storage space and transmission bandwidth limitations.

Taking a point cloud video with a frame rate of 30 fps (frames per second) as an example, the number of points in each point cloud picture is 700,000, and each point has coordinate information xyz (float) and color information RGB (uchar), so a data volume of the point cloud video for 10 s is approximately 0.7 million×(4 Byte×3+1 Byte×3)×30 fps×10 s=3.15 GB. However, for a 1,280×720 two-dimensional video with a YUV sampling format of 4:2:0 and the frame rate of 24 fps, its data volume for 10 s is approximately 1,280×720×12 bits×24 frames×10 s≈0.33 GB; and a data volume for a 10 s two-viewing angle 3D video is approximately 0.33×2=0.66 GB. It can be seen that the data volume of the point cloud video far exceeds that of 2D video and 3D video of the same length. Therefore, in order to better fulfill data management, save server storage space, and reduce transmission traffic and transmission time between a server and a client, point cloud compression has become a key issue in promoting the development of point cloud industry.

Related knowledge of point cloud encoding and decoding will be introduced below.

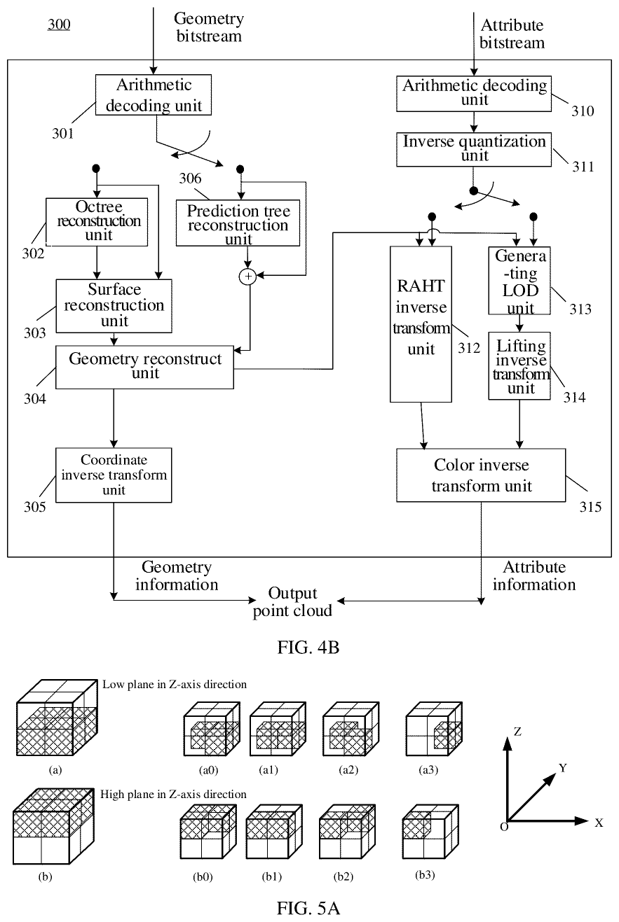

FIG. 3 is a schematic block diagram of a point cloud encoding and decoding system involved in the embodiments of the present disclosure. It will be noted that FIG. 3 only illustrates an example, and the point cloud encoding and decoding system in the embodiments of the present disclosure includes but is not limited to that illustrated in FIG. 3. As illustrated in FIG. 3, the point cloud encoding and decoding system 100 includes an encoding device 110 and a decoding device 120. The encoding device is configured to encode (which may be understood as compress) point cloud data to generate a bitstream, and transmit the bitstream to the decoding device. The decoding device decodes the bitstream generated by the encoding device to obtain decoded point cloud data.

The encoding device 110 in the embodiments of the present disclosure can be understood as a device with a point cloud encoding function, and the decoding device 120 can be understood as a device with a point cloud decoding function. That is, in the embodiments of the present disclosure, the encoding device 110 and the decoding device 120 include a wider range of apparatuses, such as smartphones, desktop computers, mobile computing apparatuses, notebook (e.g., laptop) computers, tablet computers, set-top boxes, televisions, cameras, display apparatuses, digital media players, point cloud game consoles, and in-vehicle computers.

In some embodiments, the encoding device 110 may transmit encoded point cloud data (e.g., the bitstream) to the decoding device 120 via a channel 130. The channel 130 may include one or more media and/or apparatuses which are capable of transmitting the encoded point cloud data from the encoding device 110 to the decoding device 120.

In an instance, the channel 130 includes one or more communication media that enable the encoding device 110 to transmit the encoded point cloud data directly to the decoding device 120 in real time. In this instance, the encoding device 110 may modulate the encoded point cloud data based on a communication standard and transmit modulated point cloud data to the decoding device 120. The communication media includes a wireless communication media, e.g., a radio frequency spectrum. Optionally, the communication media may also include a wired communication media, e.g., one or more physical transmission lines.

In another instance, the channel 130 includes a storage medium, and the storage medium may store the point cloud data encoded by the encoding device 110. The storage medium includes a variety of locally accessible data storage media, such as an optical disk, a DVD, and a flash memory. In this instance, the decoding device 120 may acquire the encoded point cloud data from the storage medium.

In yet another instance, the channel 130 may include a storage server, and the storage server may store the point cloud data encoded by the encoding device 110. In this instance, the decoding device 120 may download the encoded point cloud data stored in the storage server from the storage server. Optionally, the storage server may store the encoded point cloud data and transmit the encoded point cloud data to the decoding device 120. For example, the storage server is a web server (e.g., for a website), a file transfer protocol (FTP) server.

In some embodiments, the encoding device 110 includes a point cloud encoder 112 and an output interface 113. The output interface 113 may include a modulator/demodulator (a modem) and/or a transmitter.

In some embodiments, the encoding device 110 may further include a point cloud source 111 in addition to the point cloud encoder 112 and the output interface 113.

The point cloud source 111 may include at least one of: a point cloud collection apparatus (e.g., a scanner), a point cloud archive, a point cloud input interface, or a computer graphics system. The point cloud input interface is used to receive point cloud data from a point cloud content provider. The computer graphics system is used to generate point cloud data.

The point cloud encoder 112 encodes the point cloud data from the point cloud source 111 to generate a bitstream. The point cloud encoder 112 transmits the encoded point cloud data directly to the decoding device 120 via the output interface 113. The encoded point cloud data may further be stored on a storage medium or a storage server for subsequent reading by the decoding device 120.

In some embodiments, the decoding device 120 includes an input interface 121 and a point cloud decoder 122.

In some embodiments, the decoding device 120 may further include a display apparatus 123 in addition to the input interface 121 and the point cloud decoder 122.

The input interface 121 includes a receiver and/or a modem. The input interface 121 receives the encoded point cloud data via the channel 130.

The point cloud decoder 122 is used to: decode the encoded point cloud data to obtain decoded point cloud data, and transmit the decoded point cloud data to the display apparatus 123.

The display apparatus 123 displays the decoded point cloud data. The display apparatus 123 may be integrated with or external to the decoding device 120. The display apparatus 123 may include various display apparatuses, such as a liquid crystal display (LCD), a plasma display, an organic light-emitting diode (OLED) display, or other types of display apparatuses.

In addition, FIG. 3 only illustrates an example, and the technical solution of the embodiments of the present disclosure is not limited to FIG. 3. For example, the technology of the present disclosure may further be applied to unilateral point cloud encoding or unilateral point cloud decoding.

The current point cloud encoder may adopt two point cloud compression encoding technology routes proposed by the moving picture experts group (MPEG) of the international standards organization, namely video-based point cloud compression (VPCC) and geometry-based point cloud compression (GPCC). The VPCC projects a 3D point cloud into 2D, and encodes a projected 2D picture using existing 2D encoding tools. The GPCC partitions a point cloud into multiple units step by step using a hierarchical structure, and encodes the entire point cloud by encoding and recording the partition process.

The point cloud encoder and the point cloud decoder applicable to the embodiments of the present disclosure will be described below by taking a GPCC encoding and decoding framework as an example.

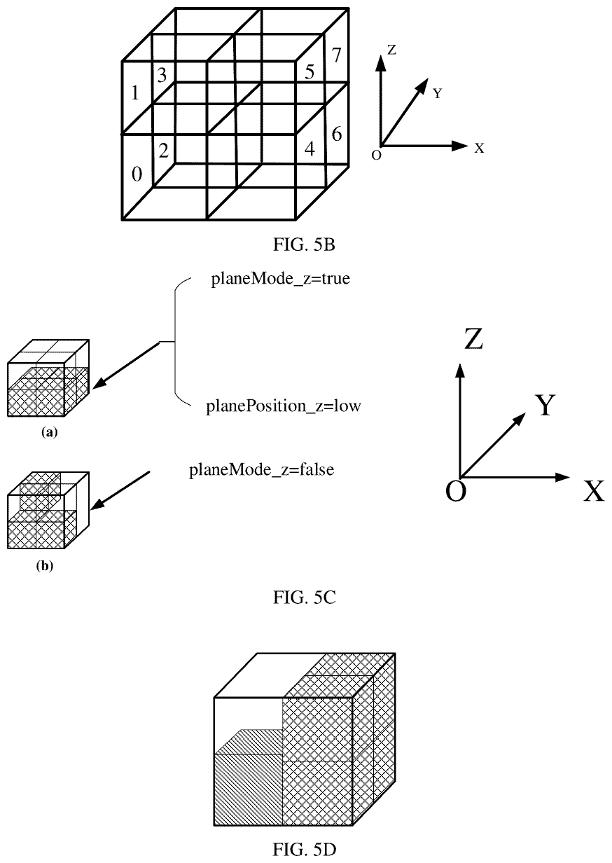

FIG. 4A is a schematic block diagram of a point cloud encoder provided in the embodiments of the present disclosure.

As can be seen from the above, a point in the point cloud may include position information of the point and attribute information of the point. Therefore, the encoding of the point in the point cloud mainly includes position encoding and attribute encoding. In some examples, the position information of the point in the point cloud is referred to as geometric information; correspondingly, the position encoding of the point in the point cloud may be referred to as geometric encoding.

In a GPCC encoding architecture, the geometric information and the corresponding attribute information of the point cloud are encoded separately.

As illustrated in FIG. 4A, the current geometric encoding and decoding of GPCC may be classified into octree-based geometric encoding and decoding and prediction tree-based geometric encoding and decoding.

A process of the position encoding includes: performing preprocessing (e.g., coordinate transform, quantization, and removal of duplicate points) on the points in the point cloud; then, performing geometric encoding on the preprocessed point cloud, e.g., constructing an octree or a prediction tree; and performing geometric encoding on the constructed octree or prediction tree to form a geometric bitstream. At the same time, based on position information output by the constructed octree or prediction tree, position information of each point in the point cloud data is reconstructed to obtain a reconstructed value of the position information of each point.

A process of the attribute encoding includes: selecting, by giving reconstruction information of position information and an original value of attribute information of an input point cloud, one of three prediction modes to perform point cloud prediction; quantizing the predicted result; and performing arithmetic encoding to generate an attribute bitstream.

As illustrated in FIG. 4A, the position encoding may be implemented by the following units:
a coordinate transform (transform coordinates) unit 201, a voxelize unit 202, an octree partitioning (analyze octree) unit 203, a geometry reconstruction (reconstruct geometry) unit 204, an arithmetic encoding (arithmetic encode) unit 205, a surface fitting (analyze surface approximation) unit 206, and a prediction tree construction unit 207.

The coordinate transform unit 201 may be used to transform world coordinates of a point in the point cloud into relative coordinates. For example, minimum values of x, y and z coordinate axes are subtracted from geometric coordinates of the point respectively, which is equivalent to a de-direct current operation, to implement transform of the coordinates of the point in the point cloud from the world coordinates to the relative coordinates.

The voxelize unit 202 is also called a quantize and remove duplicate points (quantize and remove points) unit; the number of coordinates may be reduced through quantization; and after quantization, originally different points may be assigned the same coordinates, based on which, duplicate points may be removed through a deduplication operation. For example, multiple point clouds with the same quantized position and different pieces of attribute information may be merged into one cloud by attribute transform. In some embodiments of the present disclosure, the voxelize unit 202 is an optional unit module.

The octree partitioning unit 203 may encode the position information of the quantized points using an octree encoding manner. For example, the point cloud is partitioned into an octree form, so that positions of the points may be in one-to-one correspondence with positions in the octree. Positions of the points in the octree are counted and flags thereof are marked as 1 for geometric encoding.

In some embodiments, in a process of geometric information encoding based on triangle soup (trisoup), the point cloud is also partitioned into an octree by the octree partitioning unit 203. However, different from the octree-based geometric information encoding, the trisoup does not need to partition the point cloud into unit cubes with side lengths of 1×1×1 step by step, but stops partitioning once there exist blocks (sub-blocks) with a side length of W. Based on a surface formed in each block by distribution of the point cloud, at most twelve vertices (intersections) generated by this surface and twelve sides of the block are obtained, surface fitting is performed on the vertices by the surface fitting unit 206, and geometric encoding is performed on the fitted vertices.

The prediction tree construction unit 207 may encode the position information of the quantized points using a prediction tree encoding manner. For example, the point cloud is partitioned in the form of a prediction tree, whereby positions of the points may be in one-to-one correspondence with positions of nodes in the prediction tree. The positions of the nodes in the prediction tree are counted, different prediction modes are selected for predicting geometric position information of the nodes to obtain prediction residuals, and geometric prediction residuals are quantized using a quantization parameter. Next, the prediction residuals of the position information of the nodes of the prediction tree, a structure of the prediction tree, and the quantization parameter are encoded through continuous iteration, to generate a binary bitstream.

The geometry reconstruction unit 204 may perform position reconstruction based on the position information output by the octree partitioning unit 203 or the vertices fitted by the surface fitting unit 206, to obtain a reconstructed value of the position information of each point in the point cloud data. Alternatively, the geometry reconstruction unit 204 performs position reconstruction based on the position information output by the prediction tree construction unit 207, to obtain a reconstructed value of the position information of each point in the point cloud data.

The arithmetic encoding unit 205 may perform, by using entropy coding, arithmetic encoding on the position information output by the octree partitioning unit 203 or the vertices fitted by the surface fitting unit 206 or the geometric prediction residuals output by the prediction tree construction unit 207, to generate a geometric bitstream, where the geometric bitstream may also be referred to as a geometry bitstream.

The attribute encoding may be implemented by the following units:
a color transform (transform colors) unit 210, a recoloring (transfer attributes) unit 211, a region adaptive hierarchical transform (RAHT) unit 212, a generating LOD (generate LOD) unit 213, a lifting (lifting transform) unit 214, a quantization coefficient (quantize coefficients) unit 215, and an arithmetic encoding unit 216.

It will be noted that a point cloud encoder 200 may include more, fewer, or different functional components than those illustrated in FIG. 4A.

The color transform unit 210 may be used to transform an RGB color space of the points in the point cloud into a YCbCr format or other formats.

The recoloring unit 211 performs recoloring on color information using reconstructed geometric information such that uncoded attribute information corresponds to the reconstructed geometric information.

After an original value of the attribute information of the point is obtained through transform by the recoloring unit 211, any of transform units may be selected to transform the point in the point cloud. The transform units may include: the RAHT transform unit 212 and the lifting (lifting transform) unit 214. Lifting transform depends on generated level of detail (LOD).

Any one of the RAHT transform and lifting transform may be understood as being used to predict attribute information of a point in the point cloud to obtain a predicted value of the attribute information of the point, and to obtain a residual of the attribute information of the point based on the predicted value of the attribute information of the point. For example, the residual of the attribute information of the point may be obtained by subtracting the predicted value of the attribute information of the point from the original value of the attribute information of the point.

In an embodiment of the present disclosure, a process of generating an LOD by the LOD generating unit includes: obtaining Euclidean distances between points based on position information of the points in the point cloud; and partitioning the points into different detail expression levels based on the Euclidean distances. In an embodiment, after the Euclidean distances are sorted, Euclidean distances in different ranges may be partitioned into different detail expression levels. For example, one point may be randomly selected as a first detail expression level; then, Euclidean distances between remaining points and this point are calculated, and points whose Euclidean distances meet a first threshold requirement are classified as a second detail expression level; a centroid of the points in the second detail expression level is obtained, Euclidean distances between points other than the first and second detail expression levels and the centroid are calculated, and points whose Euclidean distances meet a second threshold are classified as a third detail expression level; and so forth, all the points are classified into the detail expression levels. By adjusting a threshold of Euclidean distance, it is possible to make the number of points in each LOD level incremental. It can be understood that the LOD partitioning may also be performed using other manners, which is not limited in the present disclosure.

It will be noted that the point cloud may be directly partitioned into one or more detail expression levels; alternatively, the point cloud may be first partitioned into multiple point cloud slices, and then each point cloud slice may be partitioned into one or more LOD levels.

For example, the point cloud may be partitioned into multiple point cloud slices, and the number of points in each point cloud slice may be in a range from 550 thousand to 1.1 million. Each point cloud slice may be considered as a separate point cloud. Each point cloud slice may be partitioned into multiple detail expression levels, with each detail expression level including multiple points. In an embodiment, partition of the detail expression levels may be made based on Euclidean distances between the points.

The quantization unit 215 maybe used to quantize the residual of the attribute information of the point. For example, in a case where the quantization unit 215 is connected to the RAHT transform unit 212, the quantization unit 215 may be used to quantize the residual of the attribute information of the point output by the RAHT transform unit 212.

The arithmetic encoding unit 216 may perform, by using zero run length coding, entropy coding on the residual of the attribute information of the point, so as to obtain an attribute bitstream. The attribute bitstream may be bitstream information.

FIG. 4B is a schematic block diagram of a point cloud decoder provided in embodiments of the present disclosure.

As illustrated in FIG. 4B, a decoder 300 may obtain a point cloud bitstream from an encoding device, and obtain position information and attribute information of a point in the point cloud by parsing the bitstream. Decoding of the point cloud includes position decoding and attribute decoding.

A process of the position decoding includes: performing arithmetic decoding on a geometric bitstream; performing merge after constructing an octree, and reconstructing the position information of the point to obtain reconstructed information of the position information of the point; and performing coordinate transform on the reconstructed information of the position information of the point to obtain the position information of the point. Position information of a point may also be called geometric information of the point.

A process of the attribute decoding includes: obtaining a residual of the attribute information of the point in the point cloud by parsing an attribute bitstream; obtaining an inverse-quantized residual of the attribute information of the point by performing inverse quantization on the residual of the attribute information of the point; selecting, based on the reconstruction information of the position information of the point obtained in the process of the position decoding, one of the RAHT inverse transform and the lifting inverse transform to perform point cloud prediction to obtain a predicted value, and adding the predicted value to the residual to obtain a reconstructed value of the attribute information of the point; and performing color space inverse transform on the reconstructed value of the attribute information of the point to obtain a decoded point cloud.

As illustrated in FIG. 4B, the position decoding may be implemented by the following units:
an arithmetic decoding unit 301, an octree reconstruction (synthesize octree) unit 302, a surface reconstruction (synthesize surface approximation) unit 303, a geometry reconstruction (reconstruct geometry) unit 304, a coordinate inverse transform (inverse transform coordinates) unit 305, and a prediction tree reconstruction unit 306.

The attribute decoding may be implemented by the following units:
an arithmetic decoding unit 310, an inverse quantization (inverse quantize) unit 311, an RAHT inverse transform unit 312, a generating LOD (generate LOD) unit 313, a lifting inverse transform(inverse lifting) unit 314, and a color inverse transform (inverse transform colors) unit 315.

It will be noted that decompression is an inverse process of compression. Similarly, as for functions of all units in the decoder 300, reference may be made to the functions of the corresponding units in the encoder 200. In addition, the point cloud decoder 300 may include more, fewer, or different functional components than those illustrated in FIG. 4B.

For example, the decoder 300 may partition the point cloud into multiple LODs based on Euclidean distances between points in the point cloud, and decode attribute information of the points in the LODs in turn, e.g., compute the number of zeros (zero_cnt) in a zero-run encoding technique to decode a residual based on zero_cnt. Then, the decoder 300 may perform inverse quantization based on the decoded residual, and obtain a reconstructed value of the point cloud by adding an inverse-quantized residual and a predicted value of a current point, until all points in the point cloud are decoded. The current point will serve as the nearest neighbor to points in a subsequent LOD, and attribute information of the subsequent points will be predicted using the reconstructed value of the current point.

The above is a basic process of the point cloud encoder and decoder based on the GPCC encoding and decoding architecture. With the development of technology, some modules or steps of the architecture or process may be optimized. The present disclosure is applicable to the basic process of the point cloud encoder and decoder based on the GPCC encoding and decoding architecture, but is not limited to the architecture and process.

Next, the octree-based geometric encoding and the prediction tree-based geometric encoding will be introduced below.

The octree-based geometric encoding includes the following steps. Firstly, coordinate transform is performed on geometric information, such that the entire points are contained in a bounding box. Then, quantization is performed, where the step of quantization mainly plays a role in scaling. Due to quantization rounding, geometric information of some points is the same. Whether to remove duplicate points is determined based on a parameter. A process of quantization and removal of duplicate points is referred to as a process of voxelization. Next, tree partition (octree/quadtree/binary tree) is continuously performed on the bounding box in an order of breadth-first traversal, and a placeholder code of each node is encoded. In an implicit geometric partitioning manner, the bounding box (2^{d}^{ₓ}, 2^{d}^{_{y}}, 2^{d}^{_{z}}) of the point cloud is first calculated. It is assumed that the bounding box with dₓ>d_{y}>d_{z} corresponds to a cuboid. During geometric partitioning, binary tree partitioning is first performed based on the x axis all the time to obtain two child nodes; until a condition of dₓ=d_{y}>d_{z} is met, quadtree partitioning is performed based on the x and y axes all the time to obtain four child nodes; and then in a case where a condition of dₓ=d_{y}=d_{z} is finally met, octree partitioning is performed all the time until leaf nodes obtained by partitioning are each a unit cube of 1×1×1, the partitioning will be stopped, and points in the leaf nodes are encoded to generate a binary bitstream. In the process of performing partitioning based on binary tree/quadtree/octree, two parameters are introduced: K and M, in which the parameter K indicates the maximum number that the binary tree/quadtree partitioning is performed before octree partitioning; and the parameter M is used for indicating that a side length of the minimum block corresponding to the binary tree/quadtree partitioning is 2^{M}. At the same time, K and M must meet the following conditions: it is assumed that dₘₐₓ=max(dₓ, d_{y}, d_{z}), dₘᵢₙ=min(dₓ, d_{y}, d_{z}), the parameter K meets K>=dₘₐₓ−dₘᵢₙ; and the parameter M meets M>=dₘᵢₙ. The reason why the parameters K and M meet the above conditions is that in a current process of geometric implicit partitioning of GPCC, the priority of the partitioning manner is binary tree, quadtree and octree. Only in a case where the size of the node block does not meet the conditions of binary tree/quadtree, octree partitioning is performed on the nodes all the time until the nodes are partitioned into leaf nodes with the minimum unit of 1×1×1.

The octree-based geometric information encoding mode may effectively encode the geometric information of the point cloud by using correlation between neighboring points in space. Whereas for some relatively flat nodes or nodes with planar characteristics, the encoding efficiency of the geometric information of the point cloud may be further improved by using planar encoding.

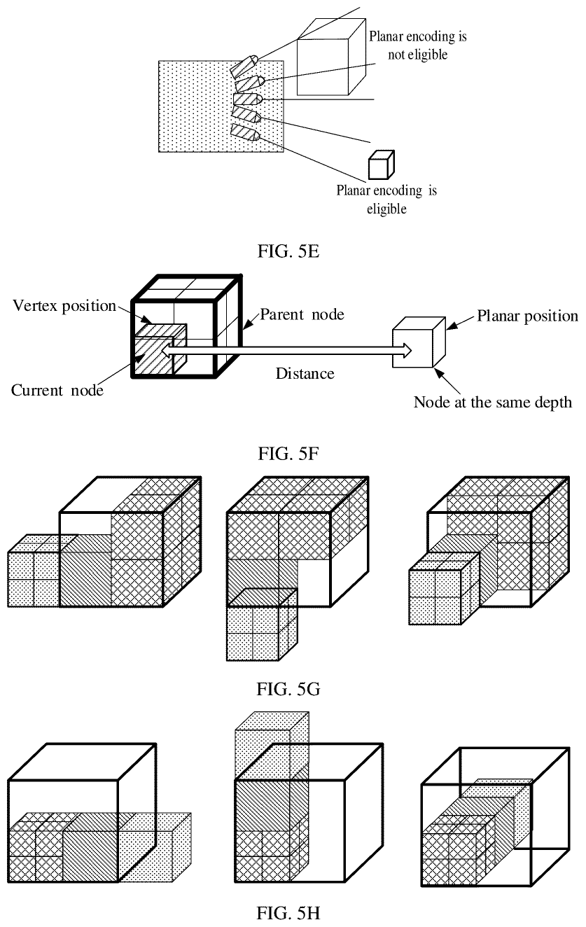

Exemplarily, as illustrated in FIG. 5A, (a) series belongs to a low planar position in a Z axis direction, and (b) series belongs to a high planar position in the Z axis direction. Taking (a) as an example, it can be seen that four occupied child nodes in a current node are all positioned in a low planar position of the current node in the Z axis direction. Therefore, it may be considered that the current node belongs to a Z plane and is a low plane in the Z axis direction. Similarly, (b) indicates that occupied child nodes in the current node are positioned at a high planar position of the current node in the Z axis direction.

Taking (a) as an example, the octree encoding and the planar encoding are compared in terms of efficiency. As illustrated in FIG. 5B, if an octree encoding manner is used for (a) in FIG. 5A, occupancy information of the current node is represented as: 11001100. Whereas if a planar encoding manner is used, firstly, an identifier needs to be encoded to represent that the current node is a plane in the Z axis direction; secondly, if the current node is a plane in the Z axis direction, the planar position of the current node needs to be represented; and then only occupancy information of low planar nodes in the Z axis direction needs to be encoded (e.g., occupancy information of four child nodes 0246). Therefore, based on the planar encoding manner, only 6 bits are needed to encode the current node, which may reduce 2 bits of representation compared to the original octree encoding. Based on this analysis, the planar encoding has more significant encoding efficiency than the octree encoding. Therefore, for an occupied node, if the planar coding is used for encoding in a certain dimension, as illustrated in FIG. 5C, firstly, planar identification (planarMode) information and planar position (PlanePos) information of the current node in this dimension need to be represented, and then occupancy information of the current node is encoded based on planar information of the current node. It will be noted that: for PlaneModeᵢ (i is equal to 0, 1 or 2): 0 represents that the current node is not a plane in an i-axis direction. In a case where the node is a plane in the i-axis direction, for PlanePositionᵢ: 0 represents that the current node is a plane in the i-axis direction with the planar position being a low plane, and 1 represents that the current node is a high plane in the i-axis direction. Exemplarily, i=0 represents the X axis, i=1 represents the Y axis, and i=2 represents the Z axis.

In the current GPCC standard, determining whether a node meets a condition for the planar encoding and predictive encoding of planar identification and planar position information of the node in a case where the node meets the condition for the planar encoding, will be introduced in detail below.

There are three types of determination conditions in the current GPCC for determining whether a node meets the condition for the planar encoding, which will described below one by one.

The first type: determining is performed based on a plane probability of the node in each dimension.

Firstly, a local area density (local_node_density) of a current node and the probability Prob(i) of the current node in each dimension are determined.

In a case where the local area density of the node is less than a threshold Th (Th is equal to 3), the plane probabilities Prob(i) of the current node in three dimensions are compared with thresholds Th0, Th1 and Th2, where Th1 is less than Th2 and greater than Th0 (Th0<Th1<Th2) (Th0 is equal to 0.6, Th1 is equal to 0.77, and Th2 is equal to 0.88). Eligibleᵢ (i is equal to 0, 1 or 2) is used below to represent whether the planar encoding is enabled in each dimension, where a determination process of Eligibleᵢ is shown in formula (1). For example, if Eligibleᵢ is greater than or equal to the threshold (Eligibleᵢ>=threshold), it represents that the planar encoding is enabled in an i-th dimension:

$${Eligible}_{i} = Prob ( i ) >= threshold \qquad ( 1 )$$

It will be noted that the threshold is changed adaptively. For example, in a case where Prob(1) is greater than Prob(0) and less than Prob(2) (Prob(0)>Prob(1)>Prob(2)), a value of the threshold is as shown in formula (2):

$${Eligible}_{0} = Prob ( 0 ) >= Th 0 \qquad ( 2 )$$

$${Eligible}_{1} = Prob ( 1 ) >= Th 1$$

$${Eligible}_{2} = Prob ( 2 ) >= Th 2$$

An update process of local_node_density and the updating of Prob(i) will be described below.

In an example, Prob(i) is updated by the following formula (3):

$${Prob ( i )}_{n e w} = ( Lx Prob ( i ) + δ ( coded node ) ) / L + 1 ; \qquad ( 3 )$$

where L is equal to 255 (L=255); and δ(coded node) is 1 in a case where the coded node is a plane, is 1, otherwise δ(coded node) is 1 is 0.

In an example, local_node_density is updated by the following formula (4):

$$loca1\_node {\_density}_{n e w} = loca1\_node \_density + 4 * numSiblings ; \qquad ( 4 )$$

where local_node_density is initialized to 4, and numSiblings is the number of siblings of the node. As illustrated in FIG. 5D, in a case where the current node is a left node and the right nodes are siblings of the current node, the number of the siblings of the current node is 5 (including the current node itself).

The second type: whether a node of a current level (or referred to as layer) meets the condition for the planar encoding is determined based on the point cloud density of the current level.

Whether the planar encoding is performed on the node of the current level is determined by using the density of points in the current level. It is assumed that the number of points in a current point cloud to be encoded is pointCount and the number of points reconstructed after IDCM encoding is numPointCountRecon, since the encoding for the octree is performed based on an order of breadth-first traversal, the number of nodes to be encoded in the current level may be obtained, assuming as nodeCount. As a result, it is assumed that planarEligibleKOctreeDepth is used for representing whether the planar encoding is enabled in the current level, where the determination process of planarEligibleKOctreeDepth is shown in formula (5):

$$planarEligibleKOctreeDepth = ( pointCount - numPointCountRecon ) < nodeCount * 1.3 \qquad ( 5 )$$

In a case where planarEligibleKOctreeDepth is true, the planar encoding is performed on all nodes in the current level; otherwise, no planar encoding is performed and only the octree encoding is used.

The third type: whether the current node meets the condition for the planar encoding is determined based on a collection parameter of a laser radar point cloud.

As illustrated in FIG. 5E, it may be seen that a node of large cube at top is passed through by two lasers simultaneously, so the current node is not a plane in a direction perpendicular to the Z axis, and a node of small cube at bottom is small enough that it cannot be passed through by two lasers simultaneously, so the current node is likely to be a plane. Therefore, whether the current node meets the condition for the planar encoding is determined based on the number of lasers corresponding to the current node.

For nodes meeting the condition for the planar encoding, the predictive encoding of the planar identification information and the planar position information will be introduced below.

Firstly, the predictive encoding of the planar identification information

Currently, the planar identification information is encoded using three contexts. That is, the context is designed separately for planar representations in each dimension.

Encoding of planar position information of non-lidar point clouds and encoding of planar position information of laser radar point clouds will be introduced separately below.

### 1) Encoding of the Planar Position Information of the Non-Lidar Point Clouds.

### 1. Predictive Encoding of the Planar Position Information

The predictive encoding is performed on the planar position information based on the following information:
(1) the planar position information of the current node being obtained as three elements through predicting by using the occupancy information of the neighborhood node: predicted to be a low plane, predicted to be a high plane, or unpredictable;
(2) a spatial distance between a node at the same partition depth and the same coordinate as the current node and the current node being “near” or “far”;
(3) a planar position of a node at the same partition depth and the same coordinate as the current node; or
(4) a coordinate dimension i being equal to 0, 1 or 2 (i=0, 1, 2).

As illustrated in FIG. 5F, the current node to be encoded is a left node, a neighborhood node is searched for as a right node at the same octree partition depth level and the same vertical coordinate, a distance between those two nodes is determined as “near” or “far”, with reference to the planar position of the node.

In an example, as illustrated in FIG. 5G, a black node is the current node; and if the current node is located at a low plane of a parent node, the planar position of the current node is determined in manners as follows.
a) If any one of child nodes 4 to 7 of a node filled with oblique lines is occupied and none of nodes filled with dots is occupied, it is very likely that there is a plane in the current node, with a relatively low planar position.
b) If none of child nodes 4 to 7 of a node filled with oblique lines is occupied and any node filled with dots is occupied, it is very likely that there is a plane in the current node, with a relatively high planar position.
c) If all of child nodes 4 to 7 of a node filled with oblique lines are empty nodes and all of nodes filled with dots are empty nodes, the planar position cannot be inferred and is therefore marked as unknown.
d) If any one of child nodes 4 to 7 of a node filled with oblique lines is occupied and any one of nodes filled with dots is occupied, the planar position cannot be inferred and is therefore marked as unknown.

In another example, as filled in FIG. 5H, a black node is the current node; and if the current node is located at a high planar position of a parent node, the planar position of the current node is determined in manners as follows.
a) If any one of child nodes 4 to 7 of a node filled with dots is occupied and a node filled with oblique lines is not occupied, it is very likely that there is a plane in the current node, with a relatively low planar position.
b) If none of child nodes 4 to 7 of a node filled with dots is occupied and a node filled with oblique lines is occupied, it is very likely that there is a plane in the current node, with a relatively high planar position.
c) If none of child nodes 4 to 7 of a node filled with dots is occupied and a node filled with oblique lines is not occupied, the planar position cannot be inferred and is therefore marked as unknown.
d) If one of child nodes 4 to 7 of a node filled with dots is occupied and a node filled with oblique lines is occupied, the planar position cannot be inferred and is therefore marked as unknown.

### 2) Encoding of the Planar Position Information of Laser Radar Point Clouds

FIG. 5I illustrates the predictive encoding of the planar position information of the laser radar point cloud. The planar position of the current node is predicted by using parameters collected by a laser radar, and the position is quantized into four intervals by using positions of intersection of the current node and laser rays, and the four intervals finally serve as the context of the planar position of the current node. A specific calculation process is the following: assuming that coordinates of the laser radar are (x_{Lidar}, y_{Lidar}, z_{Lidar}) and geometric coordinates of the current node are (x, y, z), a vertical tangent value tan θ of the current node relative to the laser radar is first calculated with the calculation process shown in formula (6):

$$tan θ = \frac{z - {z}_{L i d a r}}{\sqrt{{( x - {x}_{Lidar} )}^{2} + {( y - {y}_{Lidar} )}^{2}}} \qquad ( 6 )$$

In addition, since each laser has a certain offset angle relative to the laser radar, a relative tangent value tan θ_{corr,L} of the current node relative to the laser is calculated, with the specific calculation process shown in formula (7):

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 7 )$$

Finally, the planar position of the current node is predicted by using a corrected tangent value of the current node. In some implementations, assuming that a tangent value of a lower boundary of the current node is tan(θ bottom), and a tangent value of an upper boundary is tan(θ top), the planar position is quantized into 4 quantization intervals based on tan θ_{corr,L}, that is, the context of the planar position.

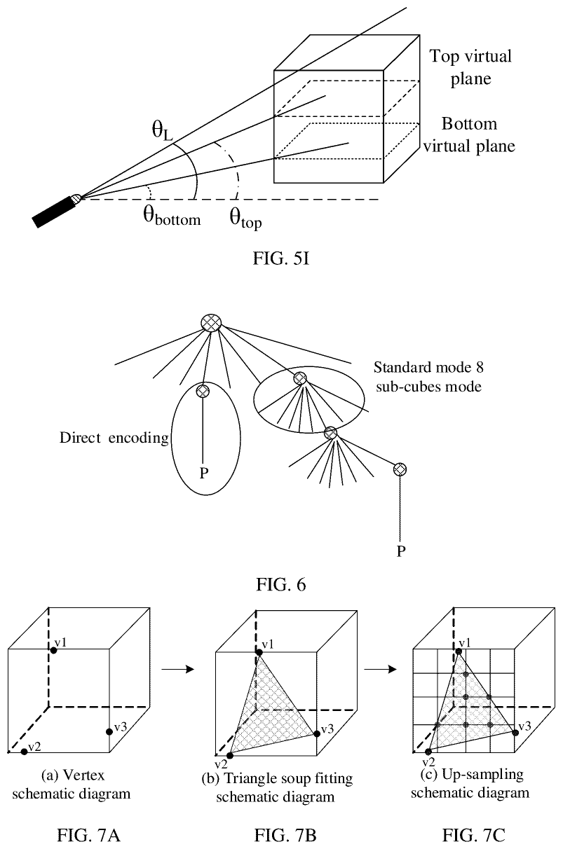

However, the octree-based geometric information encoding mode only has an efficient compression rate for points that are correlated in space. For points that are isolated in the geometric space, use of the direct coding model (DCM) may greatly reduce complexity. For all nodes in the octree, use of DCM is not represented by flag information, but is inferred from the parent node and neighboring information of the current node. There are three manners to determine whether the current node is eligible for the DCM encoding, as illustrated in FIG. 6.
(1) The current node has no sibling child nodes, that is, the parent node of the current node has only one child node, and a parent node of the parent node of the current node has only two occupied child nodes, i.e., the current node has at most one neighborhood node.
(2) The parent node of the current node has only one occupied child node, i.e., the current node, and six neighborhood nodes sharing a face with the current node are also empty nodes.
(3) The number of sibling nodes of the current node is greater than 1.

If the current node is not eligible for the DCM encoding, octree partitioning will be performed on the current node. If the current node is eligible for the DCM encoding, the number of points included in the node will be further determined. In a case where the number of points is less than a threshold of 2, the DCM encoding is performed on the node, otherwise the octree partitioning will be performed continuously. In a case where the DCM encoding mode is applied, it is first necessary to encode whether the current node is a true isolated point, that is, IDCM_flag. In a case where IDCM_flag is true, the DCM encoding is performed on the current node; otherwise, the octree encoding is still performed. In a case where the current node meets the condition for the DCM encoding, a DCM encoding mode of the current node needs to be encoded. There exist two current DCM modes which are: 1: only one point exists (or multiple points exist, but they are duplicate points); and 2: two points are contained. Finally, it is necessary to encode geometric information of each point. Assuming that a side length of the node is 2^{d}, it takes d bits to encode each component of the geometric coordinates of the node, and the bit information is directly encoded into a bitstream. It will be noted here that when encoding the laser radar point cloud, predictive encoding is performed on the three-dimensional coordinate information by using the parameters collected by a laser radar, which may further improve the encoding efficiency of the geometric information.

It will be noted that as the node partitioning proceeds to leaf nodes, the number of duplicate points in the leaf nodes needs to be encoded in a case of geometric lossless encoding. Finally, occupancy information of all nodes is encoded to generate a binary bitstream. In addition, a planar encoding mode is currently introduced in GPCC. In a process of geometric partitioning, whether child nodes of the current node are in the same plane will be determined; and if the child nodes of the current node meet the condition of being in the same plane, the child nodes of the current node will be represented by the plane.

For the octree-based geometric decoding, before decoding the occupancy information of each node, a decoding side will first determine, in the order of breadth-first traversal, whether to perform the planar decoding or the IDCM decoding on the current node by using the reconstructed geometric information. If the current node meets a condition for the planar decoding, the decoding side will first decode the planar identification and planar position information of the current node, and then decode the occupancy information of the current node based on the planar information. If the current node meets a condition for the IDCM decoding, the decoding side will first decode whether the current node is a true IDCM node; and if the current node is a true IDCM node, the decoding side will continue to parse the DCM decoding mode of the current node, and then the decoding side may obtain the number of points in the current DCM node and finally decode the geometric information of each point. For a node that does not meet either the condition for the planar decoding or the condition for the DCM decoding, the occupancy information of the current node will be decoded. By continuously parsing in this manner, an occupancy code of each node is obtained, and the partitioning is continued for the nodes in turn until unit cubes of 1×1×1 are obtained. The number of points included in each leaf node is parsed, and geometric reconstruction point cloud information is restored finally.

In a geometric information encoding architecture based on trisoup (triangle soup), similarly, geometry partitioning is also performed first. However, unlike the binary tree/quadtree/octree-based geometric information encoding, this method does not need to partition the point cloud into unit cubes with side lengths of 1×1×1 step by step, but stops partitioning once there exist blocks (sub-blocks) with a side length of W. Based on a surface formed in each block by the distribution of the point cloud, at most twelve vertices (intersections) generated by this surface and twelve sides of the block are obtained. Vertex coordinates of each block are encoded in turn to generate a binary bitstream.

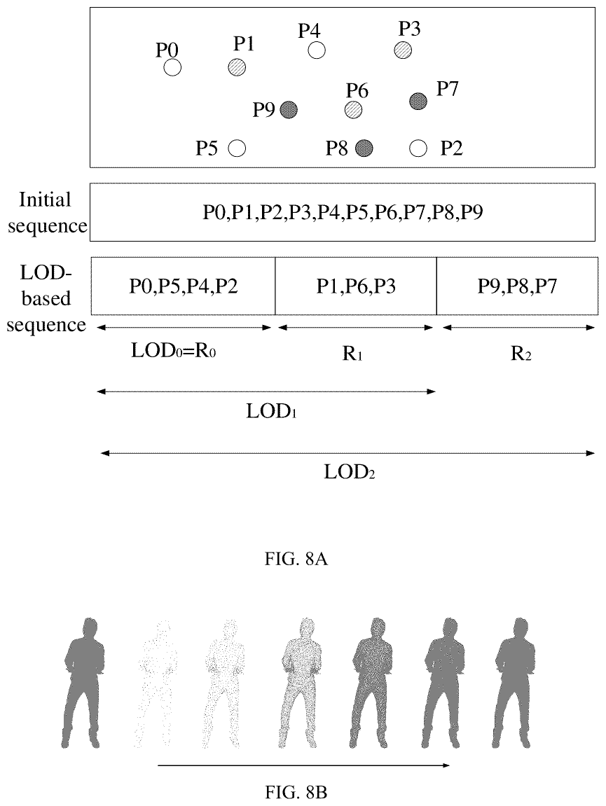

For trisoup-based point cloud geometric information reconstruction, in a case where performing the point cloud geometric information reconstruction, the decoding side first decodes the vertex coordinates to complete triangle soup reconstruction, a process of which is illustrated in FIG. 7A to FIG. 7C. There are three vertices (v1, v2, v3) in a block illustrated in FIG. 7A, and the triangle soup, i.e., trisoup, formed by these three vertices in a certain order is illustrated in FIG. 7B. Afterwards, sampling is performed on the triangle soup to obtain sampling points, which will serve as a reconstructed point cloud within the block, as illustrated in FIG. 7C.

The prediction tree-based geometric encoding includes steps as follows. Firstly, an input point cloud is sorted, and the sorting methods currently used include unordered, Morton order, azimuth order, and radial distance order. An encoding side establishes a prediction tree structure by using two different manners including a high-latency slow mode (KD-Tree), and a low-latency fast mode in which each point is assigned to a different laser by using laser radar calibration information, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream.

For the prediction tree-based on the geometric decoding, the decoding side reconstructs the prediction tree structure by continuously parsing the bitstream, and then obtains the prediction residual information of the geometric position and a quantization parameter of each prediction node through parsing, and performs inverse quantization on the prediction residual for recovering, so as to obtain the reconstructed geometric position information of each node, and finally completes the geometric reconstruction on the decoding side.

The geometric information is reconstructed after the geometric encoding is completed. Currently, attribute encoding is mainly performed on color information. Firstly, the color information is transformed from an RGB color space to a YUV color space. The point cloud is then recolored by using the reconstructed geometric information, to enable unencoded attribute information to correspond to the reconstructed geometric information. In color information encoding, there are two main transform manners: one is distance-based lifting transform that relies on LOD (level of detail) partitioning, and the other is that RAHT (Region Adaptive Hierarchal Transform) transform is performed directly. Both manners can transform the color information from a spatial domain to a frequency domain, high frequency coefficients and a low frequency coefficient are obtained through the transform, and finally the coefficients are quantized and encoded to generate a binary bitstream.

When the attribute information is predicted by using the geometric information, Morton code may be used for performing nearest neighbor search, where the Morton code corresponding to each point in the point cloud may be obtained from geometric coordinates of this point. A method for calculating the Morton code is described below. For a three-dimensional coordinate with each component represented by a d-bit binary value, its three components may be represented as formula (8):

$$x = {Σ}_{ℓ = 1}^{d} {2}^{d - ℓ} {x}_{ℓ} , y = {Σ}_{ℓ = 1}^{d} {2}^{d - ℓ} {y}_{ℓ} , z = {Σ}_{ℓ = 1}^{d} {2}^{d - ℓ} {z}_{ℓ} , \qquad ( 8 ) ;$$

where [symbol] ∈{0,1} are binary values corresponding to bits, from the highest ( [symbol] =1) to the lowest ( [symbol] =d), of x, y, z, respectively. For x, y, z, starting from the highest bit, [symbol] are crosswise arrange m e-quaintance by using the Morton code M up to the lowest bit. Calculation formula of M is shown in formula (9):

$$M = {Σ}_{ℓ = 1}^{d} {2}^{3 ( d - ℓ )} ( 4 {x}_{ℓ} + 2 {y}_{ℓ} + {z}_{ℓ} ) = {Σ}_{{ℓ}^{′} = 1}^{3 d} {2}^{3 d - {ℓ}^{′}} {m}_{{ℓ}^{′}} ; \qquad ( 9 )$$

where [symbol] ∈{0, 1} are values of M from the highest bit ( [symbol] ′=1) to the lowest bit ( [symbol] ′=3d), respectively. After the Morton code M of each point in the point cloud is obtained, the points in the point cloud are arranged in order of Morton code in an ascending order, and a weighting factor w of each point is set to 1.

There are 4 general test conditions for GPCC:
condition 1: the geometric position with limited loss, and attributes with loss;
condition 2: the geometric position lossless, and attributes with loss;
condition 3: the geometric position lossless, and attributes with limited loss; and
condition 4: the geometric position lossless, and attributes lossless.

The general test sequence includes four categories: Cat1A, Cat1B, Cat3-fused, and Cat3-frame. Cat3-frame point cloud includes only reflectance attribute information, Cat1A point cloud and Cat1B point cloud include only color attribute information, and Cat3-fused point cloud includes both the color attribute information and the reflectance attribute information.

There are two technical routes for GPCC, which are distinguished by an algorithm used for geometric compression, and classified into an octree coding branch and a prediction tree coding branch.

In the octree coding branch, at the encoding side, a bounding box is continuously partitioned into sub-cubes; and partitioning is continued for non-empty sub-cubes (including points in the point cloud) until leaf nodes obtained by partitioning are unit cubes of 1×1×1. In a case of geometric lossless encoding, the number of points included in the leaf node needs to be encoded to finally complete the encoding of the geometric octree and generate the binary bitstream. At the decoding side, the decoding side obtains, in the order of breadth-first traversal, an occupancy code of each node by continuous parsing, and the partitioning is continued for the nodes in turn until unit cubes of 1×1×1 are obtained. In the case of the geometric lossless decoding, the number of points included in each leaf node needs to be parsed, and the geometric reconstruction point cloud information is restored finally.

In the prediction tree encoding branch, at the encoding side, a prediction tree structure is established by using two different manners including a high-latency slow mode (KD-Tree), and a low-latency fast mode in which each point is assigned into a different laser by using laser radar calibration information, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream. At the decoding side, the decoding side reconstructs the prediction tree structure by continuously parsing the bitstream, and then obtains the prediction residual information of the geometric position and a quantization parameter of each prediction node through parsing, and performs inverse quantization on the prediction residual for recovering, so as to obtain the reconstructed geometric position information of each node, and finally completes the geometric reconstruction on the decoding side.

The geometric encoding and decoding under the G-PCC coding framework are introduced above. The attribute encoding and decoding under the G-PCC coding framework will be introduced below.

As illustrated in FIG. 4A, the current G-PCC coding framework includes three attribute encoding methods: predicting transform (PT), lifting transform (LT), and region adaptive hierarchical transform (RAHT). The first two methods perform predictive encoding on point clouds based on the generation order of LODs, and the RAHT adaptively transforms attribute information from bottom to top based on the construction hierarchy of the octree. These three point cloud attribute encoding methods will be explained separately below.

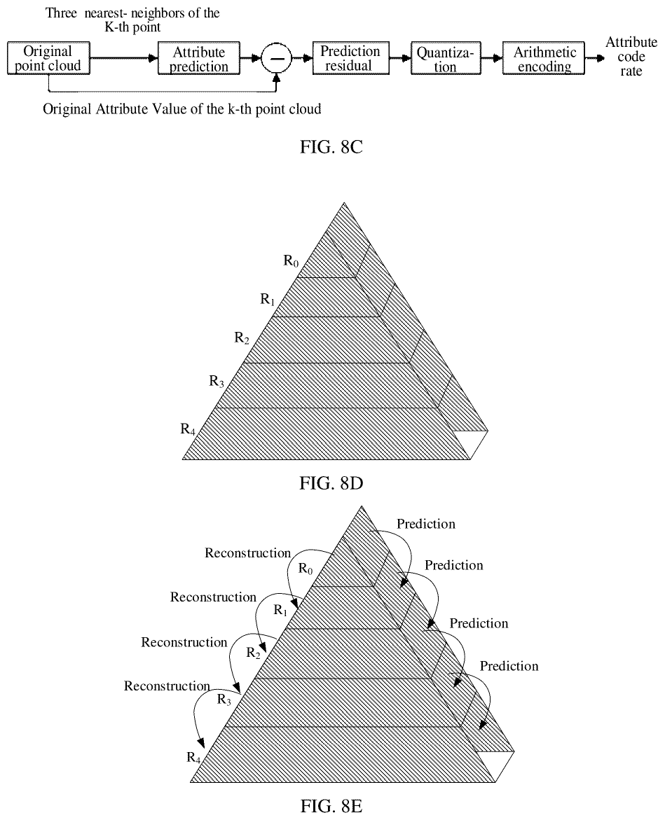

The current attribute prediction module of G-PCC uses a nearest neighbor attribute prediction encoding scheme based on a level-of-details (LoDs) structure. The LOD construction methods include a distance-based LOD construction scheme, a fixed sampling rate-based LOD construction scheme, and an octree-based LOD construction scheme. In the LOD construction scheme based on a distance threshold, the point cloud is first Morton sorted before constructing LOD to ensure that there is a strong attribute correlation between neighboring points. As illustrated in FIG. 8A, an example of a distance-based LOD construction process is given, in which the point clouds are partitioned into L different point cloud levels of detail (Rl) 1=0,1, . . . L−1 based on L Manhattan distances (dl) 1=0, 1, . . . L−1 preset by the user, where (dl)1=0, 1, . . . L−1 meets dl less than dl−1. The construction process of LOD is as follows. (1) Firstly, all points in the point cloud are marked as unvisited, and a set V is established to store the visited point set; (2) For each iteration 1, by traversing the points in the point cloud, if the current point has been visited, the current point is skipped, otherwise the minimum distance D from the current point to the point set V is calculated, if D less than dl, the point is skipped; otherwise, the current point is marked as visited and the current point is added to the levels of detail Rl and the point set V; (3) The points in the level of detail LOD1 are composed of the points in the levels of detail R0, R1, R2 . . . Rl; (4) The above steps are repeated until all points have been marked as visited.

Based on the LOD structure, the attribute value of each point is linearly weighted predicted by using the reconstructed attribute value of the point in the same or higher LOD level, where the maximum number of reference prediction neighbors is determined based on the encoder high-level syntax elements. For the attribute of each point, the rate-distortion optimization algorithm is used at the encoding side to select weighted prediction by using the attributes of the N nearest neighbors that are searched out or selecting the attribute of a single nearest neighbor for prediction, and finally the selected prediction mode and prediction residual are encoded.

Exemplarily, the attribute prediction value is determined based on the following formula (10):

$${Attr}_{i}^{′} = Round ( \frac{1}{N} {\sum }_{m ∈ {p}_{i}} \frac{\frac{1}{{D}_{m}^{2}}}{{Σ}_{m ∈ {p}_{i}} \frac{1}{{D}_{m}^{2}}} A t t {r}_{m} ) ; \qquad ( 10 )$$

where N represents the number of prediction points in the nearest neighbor set of a point i, pᵢ represents a sum of the N nearest neighbors of the point i, Dₘ represents a spatial geometric distance from the nearest neighbor m to the current point i, Attrₘ represents the attribute value of the nearest neighbor m after reconstruction, Attrᵢ′ represents the attribute prediction value of the current point i, and the number of points N is a preset value.

In order to balance the efficiency of attribute encoding and parallel processing between different LODs, a switch is introduced in the encoder high-level syntax element to control whether to introduce intra-LOD prediction. If the switch is turned on, intra-LOD level prediction is started, and points in the same LOD may be used for prediction. It should be noted that in a case where the number of LODs is 1, intra-LOD prediction is always used.

In an example, FIG. 8B illustrates a visualization result of LOD. The points at the first level represent outer contours of the point cloud. As the number of LODs increases, the detail description of the point cloud becomes clearer.

In an example, FIG. 8C is a flowchart of G-PCC attribute prediction. That is, for the k-th point in the point cloud, three neighbors of the k-th point are first determined, and an attribute prediction value of the k-th point is determined based on the attribute reconstructed information of the three neighbors. Next, an attribute prediction residual of the k-th point is obtained based on an original attribute value and the attribute prediction value of the k-th point, and after the attribute prediction residual is quantized, arithmetic encoding is performed to obtain an attribute bitstream.

In some embodiments, after the LOD is constructed, the three nearest neighbors of the current point to be encoded are first found from the encoded data points based on the generation order of the LOD. The attribute reconstructed values of the three nearest neighbors are used as candidate prediction values of the current point to be encoded; then, the optimal prediction value is selected from the attribute reconstructed values of the three nearest neighbors according to the rate-distortion optimization (RDO). For example, when encoding the attribute value of point P2 in FIG. 8A, the predictor variable index of the attribute value of the nearest neighbor P4 is set to 1; the attribute predictor variable indexes of the second nearest neighbor P5 and the third nearest neighbor P0 are set to 2 and 3 respectively; and the predictor variable index of the weighted average of points P0, P5 and P4 is set to 0, as shown in Table 2:

TABLE 2
Samples of candidate prediction items for attribute encoding

| Prediction | |
|---|---|
| mode | Prediction value |
| 0 | Weighted average of attributes of three nearest neighbors |
| 1 | P4 (an attribute value of the nearest neighbor) |
| 2 | P5 (an attribute value of the second nearest neighbor) |
| 3 | P0 (an attribute value of the third nearest neighbor) |

Finally, the optimal predictor variable is selected using RDO. The formula of weighted average is shown in formula (11):

$${\hat{a}}_{i} = Round ( {\sum }_{j = 0}^{2} \frac{{\tilde{w}}_{i j}}{{Σ}_{j = 0}^{2} {\tilde{w}}_{i j}} {ã}_{j} ) \qquad ( 11 )$$

In Formula (11), \tilde{w}ᵢⱼ represents the spatial geometric weight from the neighbor j to the current point i, and the calculation formula is shown in formula (12):

$${\tilde{w}}_{i j} = \frac{1}{{( {x}_{i} - {x}_{i j} )}^{2} + {( {y}_{i} - {y}_{i j} )}^{2} + {( {z}_{i} - {z}_{i j} )}^{2}} ; \qquad ( 12 )$$

where âᵢ represents the attribute prediction value of the current point i, j represents the indexes of the three neighbors, ãⱼ represents the attribute value of the neighbor after reconstruction, xᵢ, yᵢ, zᵢ are the geometric position coordinates of the current point i, and xᵢⱼ, yᵢⱼ, zᵢⱼ are the geometric coordinates of the neighbor j.

The attribute prediction residual and quantification will be introduced below.

Through the above prediction, the attribute prediction value (âᵢ)_{i∈0 . . . k-1} (where k represents a total number of points in the point cloud) of the current point i is obtained. Let (aᵢ)_{i∈0 . . . k-1} be the original attribute value of the current point, then as shown in formula (13), the attribute residual (rᵢ)_{i∈0 . . . k-1} is denoted as:

$${r}_{i} = {a}_{i} - {\hat{a}}_{i} \qquad ( 13 )$$

Furthermore, the prediction residual is quantified based on the following formula (14):

$${Q}_{i} = \frac{{r}_{i}}{Q s} \qquad ( 14 )$$

In formula (14), Qᵢ represents the quantized attribute residual of the current point i, and Qs represents the quantization step, which may be calculated by the quantization parameter (QP) specified by CTC.

Reconstruction of the attribute value at the encoding side

The purpose of reconstruction at the encoding side is to predict subsequent points. Before the reconstruction of the attribute value, the residual needs to undergo inverse quantization, as shown in formula (15), \hat{r}ᵢ is denoted as the residual after inverse quantization:

$${\hat{r}}_{i} = {Q}_{i} \times Q s \qquad ( 15 )$$

Then, based on the following formula (16), the reconstructed value ãᵢ of the point i is obtained by adding \hat{r}ᵢ to the prediction value âᵢ:

$${ã}_{i} = {\hat{r}}_{i} + {\hat{a}}_{i} \qquad ( 16 )$$

When performing attribute nearest neighbor search based on LOD partition, there are currently two major types of algorithms: intra nearest neighbor search and inter nearest neighbor search. The intra nearest neighbor search is divided into two algorithms: inter-level nearest neighbor search and intra-level nearest neighbor search.

### Intra Nearest Neighbor Search:

The intra nearest neighbor search is divided into two algorithms: inter-level nearest neighbor search and intra-level nearest neighbor search. After LOD partition, a pyramid structure similar to that illustrated in FIG. 8D is obtained.

### 1. Inter-Level Nearest Neighbor Search

As illustrated in FIG. 8E and FIG. 8A, different LODs, namely LOD0, LOD1 and LOD2, are obtained based on the geometric information partition, and points in LOD0 are used to predict attributes of points in a next LOD during the process of the inter-level nearest neighbor search.

The process of the intra nearest neighbor search will be described in detail below.

In the process of LOD partition, there are three sets O(k), L(k) and I(k), where k is the index of the LOD during LOD partition, and I(k) is the input point set during the current LOD partition. After LOD partition, O(k) and L(k) sets are obtained. The O(k) set stores the sampling point set, and L(k) is the point set in the current LOD. That is, the process of LOD partition is as follows.
(1) Initialization

$$if k = 0 , ( k ) ← \{ \} . Otherwise ( k ) ← L ( k - 1 )$$

$$O ( k ) ← \{ \}$$

(2) Based on the LOD partition algorithm, the sampling points are stored in (k), and the remaining points are partitioned into (k).
(3) In a case of performing the next iteration, I←(k).

It should be noted here that since the process of LOD partition is based on the Morton code, O(k), L(k) and I(k) store the Morton code index corresponding to the point.

When performing inter-level nearest neighbor search, that is, the points in the L(k) set perform nearest neighbor search in the O(k) set. The specific search algorithm is as follows.

### Nearest Neighbor Search Based on Spatial Relationships

When predicting the current point P, neighbor search is performed by using the parent block (Block B) corresponding to the point P, as illustrated in FIG. 8F, to search for points in neighbor blocks that are co-planar or co-edge with the current parent block to perform attribute prediction.

Exemplarily, the spatial relationship of co-planar, co-edge and co-vertex is illustrated in FIG. 8G.

Firstly, the coordinates of the current point are used to obtain a corresponding spatial block. Secondly, the nearest neighbor search is performed in the previously encoded LOD to find spatial blocks that are co-planar, co-edge, and co-vertex with the current block to obtain the N neighbors of the current point.

If the N neighbors of the current point are still not obtained after performing co-planar, co-edge and co-vertex nearest neighbor searches, the N neighbors of the current point will be obtained based on a fast search algorithm, and the specific algorithm is illustrated in FIG. 8H. When performing inter-attribute level prediction, the Morton code corresponding to the current point is first obtained using the geometric coordinates of the current point to be encoded. Secondly, based on the Morton code of the current point, the first reference point (j) whose Morton code is greater than the current point is found in the reference picture. Then, the nearest neighbor search is performed in the range of [j−searchRange, j+searchRange].

The rest of the specific algorithms for updating the nearest neighbor are the same as the inter nearest neighbor search algorithm, which will not be repeated here. The specific algorithms will be mentioned in the inter nearest neighbor search algorithm.

### 2. Inter-Level Nearest Neighbor Search

As illustrated in FIG. 8I, when the intra-level prediction algorithm is turned on, a nearest neighbor search is performed in the same LOD and the set of encoded points in the same level to obtain the N neighbors of the current point (inter-level nearest neighbor search is also performed).

When performing attribute inter-level prediction, the nearest neighbor search is performed based on the fast search algorithm. The specific algorithm is illustrated in FIG. 8J. Assuming that the Morton code index of the current point is i, the nearest neighbor search will be performed in [i+1, i+searchRange]. The specific nearest neighbor search algorithm is consistent with the block-based inter fast search algorithm, which will not be described here and will be discussed in detail later.

The intra nearest neighbor search is introduced above. The inter nearest neighbor search will be introduced below.

### Inter Nearest Neighbor Search

As illustrated in FIG. 8H, when performing attribute inter prediction, the Morton code corresponding to the current point are first obtained using the geometric coordinates of the current point to be encoded. Secondly, based on the Morton code of the current point, the first reference point j) that is larger than the Morton code of the current point is found in the reference picture. Then, the nearest neighbor search is performed in the range of [j−searchRange, j+searchRange].

Currently, when performing intra nearest neighbor search and inter nearest neighbor search, the neighborhood search is performed based on blocks, as illustrated in FIG. 8K. When searching for the neighborhood of the current point (Morton code index is i), the points in the reference picture are first partitioned into N (N is equal to 3) levels according to the Morton code. The specific partition algorithm is as follows.

First level: it is assumed that the reference picture contains numPoints points, the points in the reference picture are first partitioned into a block every M (M=2⁵=32) points.

Second level: on the basis of the first level, the blocks of the first level are partitioned into one block every M (M=2⁵=32) blocks according to the order of Morton code.

Third level: on the basis of the second level, the blocks of the first level are partitioned into one block every M (M=2⁵=32) blocks according to the order of Morton code.

Finally, the prediction structure illustrated in FIG. 8K is obtained.

When performing attribute prediction based on the prediction structure illustrated in FIG. 8K, assuming that the Morton code index of the current point to be encoded is i, the first point in the reference picture whose Morton code is greater than or equal to the Morton code of the current point is first obtained, with an index of j. Secondly, the block index of the reference point is calculated based on j. The specific calculation method is as follows.

$$First level : BucketSize\_ 0 = {2}^{5} = 32.$$

$$Second level : BucketSize\_ 1 = {2}^{5} = 32 \times BucketSize\_ 0 = 1024.$$

$$Third level : BucketSize\_ 2 = {2}^{5} = 32 \times BucketSize\_ 1 = 32768 .$$

Assuming that the reference range in the prediction picture of the current point is [j−searchRange, j+searchRange], the starting index of the third level is calculated using j−searchRange, and the ending index of the third level is calculated using j+searchRange. Next, it is determined whether some blocks of the second level need to undergo nearest neighbor search in the blocks of the third level; then, moving to the second level, it is determined whether a search is needed for each block of the first level; if some blocks of the first level need to undergo nearest neighbor search, some points of the blocks of the first level will be determined point by point to update the nearest neighbor.

The index-based calculation block algorithm will be introduced below. Assuming that the Morton code index corresponding to the current point is “index”, the index of the corresponding third level block is as shown in formula (17):

$$idx\_ 2 = index / BucketSize\_ 2 \qquad ( 17 )$$

After the index idx_2 of the third level block is obtained, the starting index and the ending index of the block of the second level corresponding to the current block may be obtained using idx_2, as shown in formula (18):

$$startIdx 1 = idx\_ 2 \times BucketSize\_ 1 \qquad ( 18 )$$

$$endIdx = idx\_ 2 \times BucketSize\_ 1 + BucketSize\_ 1 - 1$$

Based on the same algorithm, the index of the first level block is obtained based on the index of the second level block.

When performing nearest neighbor search based on blocks, it is first determined whether the current block needs to undergo nearest neighbor search, that is, filter the nearest neighbor search of the block. Each spatial block may be obtained based on two variables minPos and maxPos, where minPos represents the minimum value of the block and maxPos represents the maximum value of the block.

Assuming that the distance of the farthest point among the N neighbors of the current point is Dist, the coordinates of the point to be encoded are (x, y, z), and the current block is represented by (minPos, maxPos), where minPos is the minimum value of the bounding box in three dimensions, and maxPos is the maximum value of the bounding box in three dimensions, then the distance D between the current point and the bounding box is calculated as shown in formula (19):

$$int dx = int ( std \text{::} max ( std \text{::} max ( min Pos [ 0 ] - point [ 0 ] , 0 ) , point [ 0 ] - max Pos [ 0 ] ) ) ; int dy = int ( std \text{::} max ( std \text{::} max ( min Pos [ 1 ] - point [ 1 ] , 0 ) , point [ 1 ] - max Pos [ 1 ] ) ) ; int dz = int ( std \text{::} max ( std \text{::} max ( min Pos [ 2 ] - point [ 2 ] , 0 ) , point [ 2 ] - max Pos [ 2 ] ) ) ; D = dx + dy + dz \qquad ( 19 )$$

When D is less than or equal to Dist, the points in the current block will be traversed.

The lifting transform encoding of the attribute information of the point cloud will be introduced below.

FIG. 8L illustrates an encoding process of the lifting transform. The lifting transform also performs predictive encoding on the attributes of the point cloud based on LODs. The difference from the predicting transform is that the lifting transform first partitions the LODs into high and low levels, performs prediction in the reversed order of the LOD level generation, and introduces an update operator in the prediction process to update the quantization weights of the points in the lower LOD level to improve the accuracy of the prediction. This is because the attribute values of points in the lower LOD level are frequently used to predict the attribute values of points in the higher LOD level, and points in the lower LOD level should have greater influence.

### Step 1: Partition Process

The partition process is to partition the complete LOD into the lower LOD level L(N) and the higher LOD level H(N). If a point cloud has three levels of LOD, i.e., (LODₗ)_{l=0, 1, 2}, after partition, LOD₂ is the higher LOD level, denoted as H(N), and (LODₗ)_{l=0, 1} is the lower LOD level, denoted as L(N).

### Step 2: Prediction Process

The point in the higher LOD level selects the attribute information of the nearest neighbor from the lower LOD level as the attribute prediction value P(N) of the current point to be encoded. The prediction residual D(N) of the current point to be encoded is shown in formula (20):

$$D ( N ) = H ( N ) - P ( N ) \qquad ( 20 )$$

### Step 3: Update Process

The attribute prediction residual D(N) in the higher LOD level is updated to obtain U(N), and the attribute values of the points in the lower LOD level are lifted using U(N), as shown in formula (21):

$${L}^{′} ( N ) = L ( N ) + U ( N ) \qquad ( 21 )$$

The above process will iterate continuously until the lowest LOD level according to the order of LOD from high to low.

Since the LOD-based prediction scheme makes the points in the lower LOD level have greater influence, the transform scheme based on lifting wavelet transform introduces quantization weights and updates the prediction residual according to the prediction residual D(N) and the distance between the prediction point and the neighboring points. Finally, adaptive quantization is performed on the prediction residual using the quantization weights in the transform process. It should be noted that the quantization weight value of each point may be determined by geometric reconstruction at the decoding side, so the quantization weight do not need to be encoded.

The region adaptive hierarchical transform will be introduced below.

The region adaptive hierarchical transform (RAHT) is a Haar wavelet transform that may transform the attribute information of the point cloud from the spatial domain to the frequency domain and further reduce the correlation between the attributes of the point cloud. The main idea is to transform the nodes in each level from the three dimensions of x, y, and z (as illustrated in FIG. 8M) in a bottom-up manner according to the octree structure, and to perform iteration until reaching the root node of the octree. As illustrated in FIG. 8N, the basic idea is to perform wavelet transform based on the hierarchical structure of the octree, associate the attribute information with the nodes of the octree, and recursively transform the attributes of the occupied nodes in the same parent node in a bottom-up manner. The nodes in each level are transformed from the three dimensions of x, y, and z until reaching the root node of the octree. In the process of hierarchical transform, the low-pass (DC) coefficients obtained after transforming the nodes in the same level are passed to the nodes in the next level for further transform, while all high-pass (AC) coefficients are encoded by the arithmetic encoder.

During the transform process, the DC coefficient (direct current component) of the nodes in the same level after transform will be passed to the previous level for further transform, and the AC coefficient (alternating current component) after transform of each level will be quantized and encoded. The main transform process will be introduced below.

FIG. 8O illustrates the corresponding transform and inverse transform process. Assuming that

$${g}_{L , 2 x , y , z}^{′} and {g}_{L , 2 x + 1 , y , z}^{′}$$

are two attributes DC coefficients that are neighbors in the L level. After the linear transform, the information of the L−1 level is the AC coefficient

$${f}_{L - 1 , x , y , z}^{′}$$

and the DC coefficient

$${g}_{L - 1 , x , y , z}^{′} ;$$

then, no more transform will be performed on

$${f}_{L - 1 , x , y , z}^{′} ,$$

and quantization encoding will be performed on

$${f}_{L - 1 , x , y , z}^{′}$$

directly;

$${g}_{L - 1 , x , y , z}^{′}$$

will continue to search neighbors for transform, and it will be passed directly to the L-2 level if none are found. That is, the RAHT transform is only valid for nodes with neighbors, and nodes without neighbors will be passed directly to the previous level. In the above transform process, the weights corresponding to

$${g}_{L , 2 x , y , z}^{′} and {g}_{L , 2 x + 2 , y , z}^{′}$$

(the number of non-empty child nodes in a node) are

$${w}_{L , 2 x , y , z}^{′} and {w}_{L , 2 x + 1 , y , z}^{′}$$

(abbreviated as

$${w}_{0}^{′} and {w}_{1}^{′} ) ,$$

and the weight of

$${g}_{L - 1 , x , y , z}^{′}$$

is

$${w}_{L - 1 , x , y , z}^{′} ,$$

then the general transform formula (22) is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 22 )$$

Exemplarily, T_{w0,w1} in the formula is a transform matrix determined according to the following formula (23):

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 23 )$$

The transform matrix will be updated as the weights corresponding to each point change adaptively. The above process will be continuously iterated and updated based on the partition structure of the octree until reaching the root node of the octree.

Region adaptive hierarchical predicting transform encoding will be introduced below.

Region adaptive hierarchical predicting transform encoding is based on RAHT transform encoding for prediction. As illustrated in FIG. 8N, the RAHT attribute transform is based on the order of the hierarchical order of the octree, and the transform is continuously performed from the voxel level until the root node is obtained, thereby completing the hierarchical transform encoding of the entire attribute. In predicting transform encoding, attribute predicting transform encoding is also performed based on the hierarchical order of the octree, but the transform is performed continuously from the root node to the voxel level.

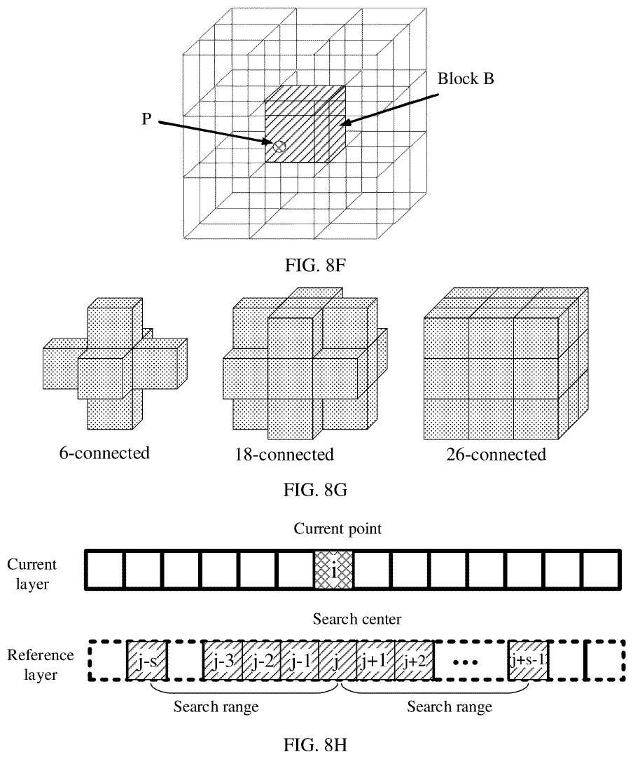

In each RAHT attribute transform process, attribute predicting transform encoding is performed based on a 2×2×2 block. As illustrated in FIG. 9A, a dark gray block is a current block to be encoded (or a current node to be encoded), and light gray blocks are some neighborhood blocks (i.e., neighborhood nodes) that are co-planar and co-edge with the current block to be encoded.

FIG. 9B is a schematic diagram of a process of region adaptive hierarchical predicting transform encoding involved in the embodiments of the present disclosure. As illustrated in FIG. 9B, firstly, N neighborhood blocks of the current block are determined.

Next, normalization is performed.

Exemplarily, attributes of the current block and the neighborhood blocks are normalized by the following methods shown in formulas (24) to (26):

$${A}_{node} = {\sum }_{p ∈ node} attribute ( p ) \qquad ( 24 )$$

$${w}_{node} = {\sum }_{p ϵ node} 1 = \# \{ p ∈ node \} \qquad ( 25 )$$

$${a}_{node} = {A}_{node} / {w}_{node} \qquad ( 26 )$$

In some implementations, firstly, the attribute of the current block is obtained by attributes of points contained in the current block, that is, the attribute of the current block A_{node} is obtained by simply adding the attributes of the points contained in the current block. Secondly, the attribute of the current block and the number of points in the current block are normalized to obtain the average of the attribute of the current block a_{node}.

Then, up-sampling is performed on the current block to obtain child nodes included in the current block, as illustrated in (c) in FIG. 9B.

Next, prediction and de-normalization are performed by using the average of the attributes of the current block and the neighborhood blocks. For example, linear weighted fitting is performed by using the attributes of the current block and the neighborhood blocks and then de-normalization is performed to obtain attribute information of a prediction block of the current block.

Exemplarily, figure (d) in FIG. 9B is the attribute information of the current block, and figure (e) in FIG. 9B is the attribute information of the prediction block of the current block.

Finally, attribute transform is performed the attribute information of the current block and the attribute information of the prediction block of the current block respectively to obtain DC and AC coefficients corresponding to the current block and DC and AC coefficients corresponding to the prediction block. The AC coefficients of the current block are subtracted from the AC coefficients of the prediction block to obtain residuals of the AC coefficients, and the residuals of the AC coefficients are encoded.

As can be seen from the above, in the region adaptive hierarchical predicting transform encoding, it is first necessary to search for N neighborhood nodes of the current node, and then prediction encoding and decoding is performed on the attribute information of the current node based on the attribute information of the N neighborhood nodes. However, currently, in a case of searching for neighborhood nodes of the current node, a full search is usually performed, for example, all nodes in a level where the current node is located are searched. For example, if the current level where the current node is located includes 10,000 nodes, all 10,000 nodes are searched to determine the N neighborhood nodes of the current node. When searching, the codec device usually loads the 10,000 nodes into a memory for searching, which takes up a large amount of memory, thereby reducing the encoding and decoding performance of the codec device.

In order to solve the above technical problems, in the embodiments of the present disclosure, when performing encoding and decoding on attribute information of a current point, a first parameter is determined. The first parameter is used to indicate a neighborhood search range. Then, based on the neighborhood search range, N neighborhood nodes of the current node are determined. Then, based on attribute information of the N neighborhood nodes, the attribute information of the current node is predicted and decoded to obtain an attribute reconstructed value of the current node. That is, in the embodiments of the present disclosure, the first parameter is used to indicate the neighborhood search range, so that a size of the neighborhood search range is fixed, reducing a occupied proportion of device memory when searching for neighborhood nodes, and thereby improving the decoding performance of attribute of the point cloud.

The point cloud encoding and decoding methods involved in the embodiments of the present disclosure will be introduced below in conjunction with specific embodiments.

Firstly, taking a decoding side as an example, the point cloud decoding method provided in the embodiments of the present disclosure will be introduced.

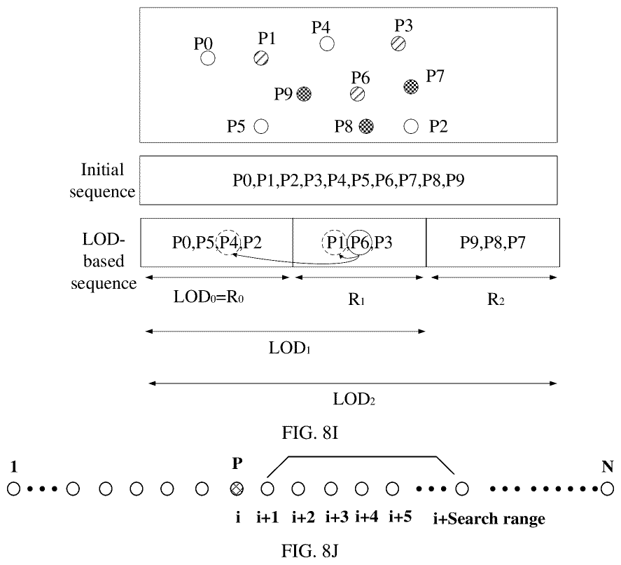

FIG. 10 is a schematic flowchart of a point cloud decoding method provided in an embodiment of the present disclosure. The point cloud decoding method of the embodiment of the present disclosure may be implemented by a point cloud decoding device or a point cloud decoder illustrated in FIG. 3 or FIG. 4B as mentioned above.

As illustrated in FIG. 10, the point cloud decoding method of the embodiment of the present disclosure includes the following steps.

In S101, a first parameter is determined.

The first parameter is used to indicate a neighborhood search range.

As can be seen from the above, a point cloud includes geometric information and attribute information, and decoding of the point cloud includes geometric decoding and attribute decoding. The embodiments of the present disclosure relate to the attribute decoding of the point cloud.

The attribute decoding of the point cloud in the embodiments of the present disclosure is performed after the geometry decoding of the point cloud. That is, in the embodiments of the present disclosure, the geometric information of the point cloud is first decoded to obtain the point cloud after the geometric information is decoded. Next, based on the point cloud after the geometric information is decoded, the attribute information of the point cloud is decoded.

In some embodiments, when decoding the attribute information of the point cloud, tree partition is performed on the point cloud based on the geometric information of the point cloud, for example, octree partitioning is performed, and attribute prediction decoding is performed on each node in the octree.

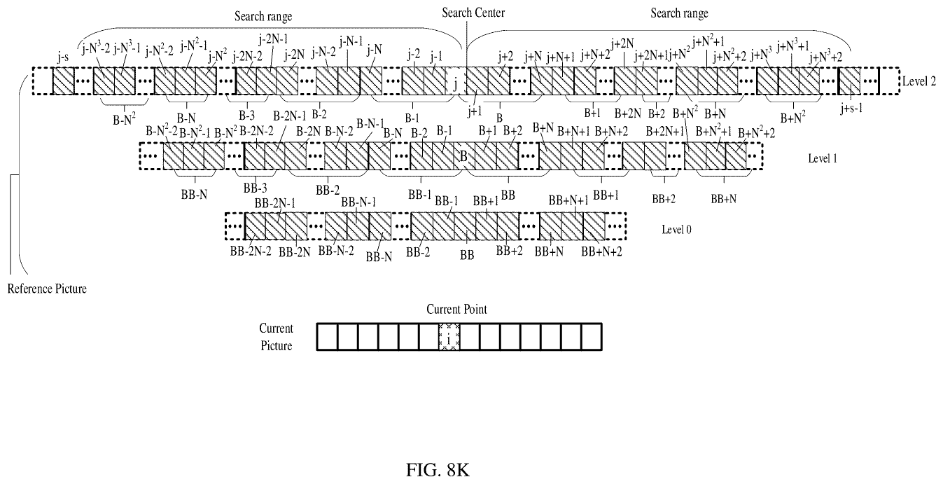

Taking the octree partitioning of the point cloud as an example, before the attribute decoding, the decoding side has decoded the geometric information of the point cloud. Therefore, in some embodiments, when decoding the attribute information of the point cloud, an octree structure of the point cloud is first constructed based on the decoded geometric information of the point cloud. As illustrated in FIG. 11, the point cloud is enclosed by a smallest rectangular block, and octree partitioning is performed on the bounding box to obtain 8 nodes. The octree partitioning is continued performed on occupied nodes in these 8 nodes, i.e., the octree partitioning is continued performed on the nodes including points, and so on, until the partitioning reaches a voxel level, for example, until there exists cubes of 1×1×1. An octree structure of the point cloud obtained by such a partitioning manner is composed of multiple levels of nodes, such as N levels. Attribute information of each level is decoded level by level when performing attribute decoding until leaf nodes at the voxel level in the last level are decoded.

In the embodiments of the present disclosure, for any node whose attribute information is to be decoded in the octree, the decoding process of its attribute information is basically the same. For the sake of convenience of description, the decoding process of attribute information of a node in the octree is taken as an example for illustration. In the subsequent description, the node whose attribute information is to be decoded is referred to as a current node. That is, the current node in the embodiments of the present disclosure may be understood as any node whose attribute information is to be decoded in the point cloud partition tree (e.g., an octree).

In some embodiments, when decoding the attribute information of the current node, it is necessary to determine N neighborhood nodes of the current node. For example, among the nodes whose attribute information has been decoded, neighborhood nodes that are co-planar, co-edge, or co-vertex with the current node are searched for, and then prediction decoding of the attribute information of the current node is performed based on the attribute information of the N neighborhood nodes.

Currently, when determining the N neighborhood nodes of the current node, a full search is typically performed, for example, by searching among all attribute-decoded nodes or among nodes in a current level where the current node is located. In some cases, when searching for the N neighborhood nodes of the current node, the decoding device first loads all nodes within the search range into a memory, for example, into a neighborhood reference buffer in the memory. A neighborhood node search is performed in the current level where the current node is located. Assuming that the current level includes a large number of nodes, for example, tens of thousands of nodes, or more nodes, the search range is not limited in the relevant technology, but the tens of thousands of nodes are loaded into the memory, and then search is performed in the memory to obtain N neighborhood nodes of the current node. This will take up a large amount of memory, and the memory of the decoding device is limited, which will reduce the decoding performance of the decoding device.

In order to solve the above technical problems, in the embodiments of the present disclosure, the neighborhood search range is limited by the first parameter, so that when the decoding device determines the neighborhood nodes of the current node, search is performed within the neighborhood search range indicated by the first parameter, thereby reducing an occupied proportion of device memory during the neighborhood node search, and thereby improving the attribute decoding performance of the point cloud of the decoding device.

In some embodiments, the neighborhood search range may be understood as a search range for searching neighborhood nodes.

In some embodiments, the neighborhood search range may be understood as a search radius of neighborhood nodes.

The specific expression form of the neighborhood search range is not limited in the embodiments of the present disclosure.

In a possible implementation, the neighborhood search range may refer to the preset number of nodes, for example, the neighborhood search range is P nodes. Exemplarily, the decoding side performs neighborhood node search among the P nodes near the current node.

In a possible implementation, the neighborhood search range refers to a preset distance, for example, the neighborhood search range is a distance “s”. Exemplarily, the decoding side performs neighborhood node search among nodes within a distance m from the current node.

The process of determining the first parameter at the decoding side will be introduced below.

In some embodiments, the first parameter may be a preset value or a default value. That is, the encoding side and the decoding side determine the preset value or the default value as the neighborhood search range.

In some embodiments, the encoding side determines a first parameter and signals the first parameter into a bitstream. In this way, the decoding side obtains the first parameter by decoding the bitstream, and then obtains the neighborhood search range of the current node based on the first parameter.

The specific expression form of the first parameter is not limited in the embodiments of the present disclosure.

Exemplarily, a field raht_prediction_search_range may be used to represent the first parameter.

The specific position of the first parameter in the bitstream is not limited in the embodiments of the present disclosure.

In some embodiments, the bitstream includes an attribute parameter set (APS), and the first parameter may be included in the APS.

The specific position and specific expression form of the first parameter in the ASP is not limited in the embodiments of the present disclosure.

In an example, the syntax of the attribute parameter set data unit is shown in Table 3:

TABLE 3

| | Descriptor |
|---|---|
| attribute_parameter_set( ) { | |
| aps_attr_parameter_set_id | u(4) |
| aps_seq_parameter_set_id | u(4) |
| attr_coding_type | ue(v) |
| attr_primary_qp_minus4 | ue(v) |
| attr_secondary_qp_offset | se(v) |
| attr_qp_offsets_present | u(1) |
| if(attr_coding_type == 0) { | |
| raht_prediction_enabled | u(1) |
| If(raht_prediction_enabled) | |
| raht_prediction_search_range | ue(v) |
| if(raht_prediction_enabled) { | |
| raht_prediction_subtree_min | ue(v) |
| raht_prediction_samples_min | ue(v) |
| } | |
| } else if(attr_coding_type ≤ 2) { | |
| pred_set_size_minus1 | ue(v) |
| pred_inter_lod_search_range | ue(v) |
| for(k = 0; k < 3; k++) | |
| pred_dist_bias_minus1_xyz[k] | ue(v) |
| if (attr_coding_type == 2) | |
| last_comp_pred_enabled | u(1) |
| lod_scalability_enabled | u(1) |
| if(lod_scalability_enabled) | |
| pred_max_range_minus1 | ue(v) |
| else { | |
| lod_max_levels_minus1 | ue(v) |
| if(¬lod_max_levels_minus1) | |
| attr_canonical_order_enabled | u(1) |
| else { | |
| lod_decimation_mode | ue(v) |
| if(lod_decimation_mode > 0) | |
| for(lvl = 0; lvl < lod_max_levels_minus1; | |
| lvl++) | |
| lod_sampling_period_minus2[lvl] | ue(v) |
| lod_initial_dist_log2 | ue(v) |
| lod_dist_log2_offset_present | u(1) |
| } | |
| } | |
| if(attr_coding_type == 1) { | |
| pred_direct_max_idx_plus1 | ue(v) |
| if(pred_direct_max_idx_plus1) { | |
| pred_direct_threshold | u(8) |
| pred_direct_avg_disabled | u(1) |
| } | |
| pred_intra_lod_search_range | ue(v) |
| if(pred_intra_lod_search_range) | |
| pred_intra_min_lod | ue(v) |
| inter_comp_pred_enabled | u(1) |
| pred_blending_enabled | u(1) |
| } | |
| } else if(attr_coding_type == 3) | |
| raw_attr_width_present | u(1) |
| if(¬lod_scalability_enabled) | |
| attr_coord_conv_enabled | u(1) |
| if(attr_coord_conv_enabled) | |
| for(k = 0; k < 3; k++) { | |
| attr_coord_conv_scale_bits_minus1[k] | u(5) |
| attr_coord_conv_scale[k] | u(v) |
| } | |
| aps_extension_present | u(1) |
| if(aps_extension_present) | |
| while(more_data_in_data_unit( )) | |
| aps_extension_data | u(1) |
| byte_alignment( ) | |
| } | |

As shown in Table 3, the field raht_prediction_search_range represents the first parameter.

In this example, the decoding side obtains the first parameter raht_prediction_search_range by decoding the syntax elements shown in Table 3, and then obtains a value of the neighborhood search range or a search radius of the neighborhood node according to the first parameter raht_prediction_search_range.

In some embodiments, the encoding side may further signal the first parameter into other locations in the bitstream except the APS. Correspondingly, the decoding side obtains the first parameter by decoding from other locations, which is not limited in the embodiments of the present disclosure.

After the decoding side determines the first parameter based on the above steps, the decoding side performs the following step S102.

In S102, N neighborhood nodes of a current node are determined based on the neighborhood search range.

After the decoding side determines the first parameter based on the above steps, the decoding side may determine a neighborhood search range, and then determine N neighborhood nodes of the current node based on the neighborhood search range. That is, in the embodiments of the present disclosure, the decoding side searches for the neighborhood nodes of the current node within the neighborhood search range indicated by the first parameter, thereby controlling the neighborhood search range and avoiding large-scale occupation of device memory during the neighborhood node search, thereby improving the attribute decoding performance of the point cloud.

The method of determining the N neighborhood nodes of the current node based on the neighborhood search range is not limited in the embodiments of the present disclosure.

In some embodiments, when decoding the attribute information of the current node, attribute information of some nodes in the point cloud has been decoded. Therefore, based on the neighborhood search range, a part of the nodes whose attribute information has been decoded are first selected to perform neighborhood node search. If no neighborhood node is searched out, or the number of neighborhood nodes searched out does not reach the expected value, another part of the nodes will be selected based on the neighborhood search range to perform neighborhood node search, and so on, until the neighborhood node that meets the preset requirement is searched out.

For example, assuming that there are 1000 attribute-decoded nodes currently, and assuming that the neighborhood search range indicated by the first parameter is 50, 50 nodes are first selected from the 1000 nodes whose attribute information has been decoded, and a search for neighborhood nodes of the current node is performed among the 50 nodes. If no neighborhood node is searched out, or the number of neighborhood nodes searched out does not meet the requirement, another 50 nodes are selected from the remaining 950 nodes, and the neighborhood nodes of the current node are searched among the 50 new nodes, and so on, until neighborhood nodes that meet the preset requirement are searched out.

In some embodiments, since it can be seen from the octree partitioning that attributes of nodes in the same level are highly correlated, when searching for neighborhood nodes of the current node, the search is performed among the nodes in the current level where the current node is located. Based on this, the decoding side may select, based on the neighborhood search range, a part of nodes among the nodes included in the current level to perform neighborhood node search. If no neighborhood node is searched out, or the number of neighborhood nodes searched out does not reach the expected value, then the decoding side may select, based on the neighborhood search range, another part of the nodes included in the current level to perform neighborhood node search, and so on, until neighborhood nodes that meet the preset requirement are searched out.

For example, assuming that the current level includes 200 nodes, and assuming that the neighborhood search range indicated by the first parameter is 50, 50 nodes are first selected from the 200 nodes included in the current level, and a search for neighborhood nodes of the current node is performed among the 50 nodes. If no neighborhood node is searched out, or the number of neighborhood nodes searched out does not meet the requirement, 50 nodes are selected from the remaining 150 nodes in the current level, and the neighborhood nodes of the current node are searched among the 50 new nodes, and so on, until neighborhood nodes that meet the preset requirement are searched out.

In some embodiments, the S102 includes the following steps S102-A and S102-B.

In S102-A, M nodes to be searched of the current node are determined based on the neighborhood search range, where M is a positive integer.

In S102-B, N neighborhood nodes of the current node are determined based on the M nodes to be searched.

In this embodiment, the decoding side first determines M nodes to be searched of the current node based on the neighborhood search range indicated by the first parameter, and then determines N neighborhood nodes of the current node based on the M nodes to be searched. For example, the decoding side first determines in which nodes to perform neighborhood node search based on the neighborhood search range, for example, the decoding side determines to perform neighborhood node search among M nodes to be searched. In this embodiment, the decoding side determines M nodes to be searched at one time based on the neighborhood search range indicated by the first parameter, without frequently changing the nodes to be searched, thereby further improving the efficiency of searching the neighborhood nodes.

The process of the decoding side determining the M nodes to be searched of the current node based on the neighborhood search range is not limited in the embodiments of the present disclosure.

In some embodiments, determining M nodes to be searched from the current level where the current node is located is taken as an example for explanation. The decoding side determines, based on the neighborhood search range indicated by the first parameter, M nodes to be searched among the nodes whose attribute information has been decoded and included in the current level. For example, according to the attribute decoding order of the nodes in the current level, based on the neighborhood search range, M nodes to be searched are selected from the attribute-decoded nodes in the current level.

In an example, if the neighborhood search range is P nodes, the decoding side selects P nodes from the attribute-decoded nodes according to the attribute decoding order of the nodes in the current level as the M nodes to be searched of the current node. In this case, M equals P.

In another example, if the neighborhood search range is a distance “s”, the decoding side selects, starting from the first attribute-decoded node, according to the attribute decoding order of the nodes in the current level, several attribute-decoded nodes within the distance “s” as the M nodes to be searched of the current node.

In some embodiments, the M nodes to be searched include the current node. That is, the decoding side determines, based on the neighborhood search range, M nodes to be searched of the current node from the attribute-decoded nodes near the current node.

In some embodiments, the decoding side determines M nodes to be searched of the current node through the following step S102-A1.

In S102-A1, the M nodes to be searched among the nodes included in the current level are determined based on the neighborhood search range and the current node.

In this embodiment, in order to further improve the accuracy of determining the nodes to be searched, the decoding side determines the M nodes to be searched among the nodes included in the current level based on the neighborhood search range indicated by the first parameter of the current node.

In the embodiments of the present disclosure, manners for the decoding side to determine the M nodes to be searched from the nodes included in the current level based on the neighborhood search range and the current node include but are not limited to the following contents.

In a manner 1, the decoding side determines nodes before the current node in the current level and within the neighborhood search range as the M nodes to be searched of the current node.

In an example, assuming that the neighborhood search range is P nodes, the decoding side determines P nodes whose attribute information has been decoded and that are located before the current node in the current level as the M nodes to be searched of the current node.

Optionally, if the number Q of nodes whose attribute information has been decoded and that are located before the current node in the current level is less than P, the Q nodes whose attribute information has been decoded and that are located before the current node in the current level are used as the M nodes to be searched of the current node, in this case, M equals Q.

In another example, if the neighborhood search range is a distance “s”, the decoding side uses nodes whose attribute information has been decoded and that are located within the distance “s” before the current node in the current level as the M nodes to be searched of the current node.

In a manner 2, the decoding side determines nodes after the current node in the current level and within the neighborhood search range as the M nodes to be searched of the current node.

In an example, assuming that the neighborhood search range is P nodes, the decoding side determines P nodes whose attribute information has been decoded and that are located after the current node in the current level as the M nodes to be searched of the current node.

Optionally, if the number Q of nodes whose attribute information has been decoded and that are located after the current node in the current level is less than P, the Q nodes whose attribute information has been decoded and that are located after the current node in the current level are used as the M nodes to be searched of the current node, in this case, M equals Q.

In another example, if the neighborhood search range is a distance “s”, the decoding side uses the nodes whose attribute information has been decoded and that are located within the distance “s” after the current node in the current level as the M nodes to be searched of the current node.

In a manner 3, the decoding side determines, among the nodes included in the current level, M nodes to be searched of the current node by taking the current node as a search center and taking half of the neighborhood search range as a search radius.

In an example, assuming that the neighborhood search range is P nodes, the decoding side determines P/2 nodes whose attribute information has been decoded and that are located before the current node in the current level, and P/2 nodes whose attribute information has been decoded and that are located after the current node in the current level, as the M nodes to be searched of the current node.

Optionally, if the number of nodes whose attribute information has been decoded and that are located before the current node in the current level is less than P/2, then each node whose attribute information has been decoded and that is located before the current node in the current level is used as part of the M nodes to be searched of the current node.

Optionally, if the number of nodes whose attribute information has been decoded and that are located after the current node in the current level is less than P/2, then each node whose attribute information has been decoded and that is located after the current node in the current level is used as part of the M nodes to be searched of the current node.

In another example, if the neighborhood search range is a distance “s”, the decoding side uses nodes whose attribute information has been decoded and that are located within a distance “s/2” before the current node in the current level, and the nodes whose attribute information has been decoded and that are located within a distance “s/2” after the current node in the current level, as the M nodes to be searched of the current node.

In a manner 4, the decoding side determines, among the nodes included in the current level, M nodes to be searched by taking the current node as a search center and taking the neighborhood search range as a search radius.

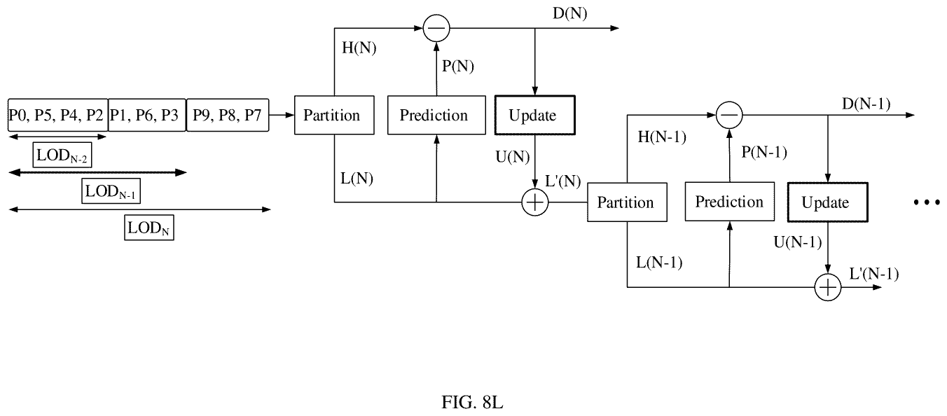

Exemplarily, as illustrated in FIG. 12, i is the current node, M nodes to be searched of the current node are determined among the nodes included in the current level by taking the current node i as the search center, and taking the neighborhood search range as the search radius. Since all of the M nodes to be searched are nodes whose attribute information has been decoded, the decoding side may determine the M nodes to be searched of the current node among the nodes included in the current level by taking the current node i as the search center, and the decoding side determines the nodes whose attribute information has been decoded and that are located within the neighborhood search range to the left of the current node in the current level, and the nodes whose attribute information has been decoded and that are located within the neighborhood search range to the right of the current node in the current level, as the M nodes to be searched of the current node.

Based on different expression forms of the neighborhood search range, in the manner 4, the manner in which the decoding side determines the M nodes to be searched includes the following examples.

In an example, assuming that the neighborhood search range is P nodes, the decoding side determines P nodes whose attribute information has been decoded and that are located before the current node in the current level, and P nodes whose attribute information has been decoded and that are located after the current node in the current level, as the M nodes to be searched of the current node.

Optionally, if the number of nodes whose attribute information has been decoded and that are located before the current node in the current level is less than P, then each node whose attribute information has been decoded and that is located before the current node in the current level is used as part of the M nodes to be searched of the current node.

Optionally, if the number of nodes whose attribute information has been decoded and that are located after the current node in the current level is less than P, then each node whose attribute information has been decoded and that is located after the current node in the current level is used as part of the M nodes to be searched of the current node.

In another example, if the neighborhood search range is a distance “s”, the decoding side uses nodes whose attribute information has been decoded and that are located within the distance “s” before the current node in the current level, and nodes whose attribute information has been decoded and that are located within the distance “s” after the current node in the current level, as the M nodes to be searched of the current node.

As can be seen from the above, in the embodiments of the present disclosure, the decoding side determines the M nodes to be searched based on the neighborhood search range indicated by the first parameter, and then searches for the N neighborhood nodes of the current node among the M nodes to be searched, rather than searching for neighborhood nodes in the entire current level, thereby reducing the search range of neighborhood nodes, saving memory, improving search efficiency, and thus improving the efficiency of attribute decoding of the point cloud.

Based on the above steps, after the decoding side determines the M nodes to be searched of the current node, the step S102-B is performed.

In the embodiments of the present disclosure, in the above S102-B, the manners for determining the N neighborhood nodes of the current node based on the M nodes to be searched include but are not limited to the following contents.

In a manner 1, the decoding side determines N neighborhood nodes of the current node among the M nodes to be searched based on geometric information. In this case, the S102-B includes the following step S102-B1.

In S102-B1, the N neighborhood nodes are obtained by searching among the M nodes to be searched based on geometric information of the current node and geometric information of the M nodes to be searched.

In the manner 1, as can be seen from the above, the geometric information of the point cloud has been decoded, so the decoding side may determine the N neighborhood nodes of the current node among the M nodes to be searched according to the geometric information of the current node and the geometric information of the M nodes to be searched.

In some embodiments, the N neighborhood nodes include at least one of: at least one node co-planar with the current node, at least one node co-edge with the current node, or at least one node co-vertex with the current node.

In an example, if the N neighborhood nodes include at least one node co-planar with the current node, the decoding side determines, among the M nodes to be searched, at least one node to be searched that is co-planar with the current node based on the geometric information of the current node and the geometric information of the M nodes to be searched, and determines the at least one node to be searched as at least one co-planar node among the N neighborhood nodes of the current node.

In an example, if the N neighborhood nodes include at least one node co-edge with the current node, the decoding side determines, among the M nodes to be searched, at least one node to be searched that is co-edge with the current node based on the geometric information of the current node and the geometric information of the M nodes to be searched, and determines the at least one node to be searched as at least one co-edge node among the N neighborhood nodes of the current node.

In an example, if the N neighborhood nodes include at least one node co-vertex with the current node, the decoding side determines, among the M nodes to be searched, at least one node to be searched that is co-vertex with the current node based on the geometric information of the current node and the geometric information of the M nodes to be searched, and determines the at least one node to be searched as at least one co-vertex node among the N neighborhood nodes of the current node.

In a manner 2, N neighborhood nodes of the current node are determined among M nodes to be searched based on Morton code or Hilbert code.

As can be seen from the above, the geometric information of the point cloud has been decoded, so respective geometric information of each node in the octree is known. Based on this, the decoding side may determine the Morton code or Hilbert code of the current node and the M nodes to be searched according to the geometric information of the current node and the geometric information of the M nodes to be searched. Since the attribute information of nodes with similar Morton codes or Hilbert codes is relatively similar, the current node and the M nodes to be searched are sorted based on Morton codes or Hilbert codes of the current node and the M nodes to be searched. From the sorted current node and the M nodes to be searched, the N nodes to be searched that are closest to the current node are selected as the N neighborhood nodes of the current node.

In some embodiments, the decoding side may also search for N neighborhood nodes of the current node among the M nodes to be searched in other manners.

In some embodiments, the N neighborhood nodes of the current node may include, in addition to at least one node co-planar with the current node, and/or at least one node co-edge with the current node, and/or at least one node co-vertex with the current node, nodes within a preset range, such as a node that is one node away from the current node.

In some embodiments, the above N is a fixed value, for example, the above N equals 3. When the decoding side searches out, among M nodes to be searched, 3 nodes co-planar with the current node, 5 nodes co-edge with the current node, and 3 nodes co-vertex with the current node based on the above steps, 3 nodes are selected from these 11 nodes as neighborhood nodes of the current node. For example, 3 nodes co-planar with the current node are selected as 3 neighborhood nodes of the current node. In an example, if the decoding side determines, among M nodes to be searched, one neighborhood node that meets the requirement based on the above steps, the decoding side may use at least one neighborhood node of the co-located node as a neighborhood node of the current node, or expand the neighborhood search range indicated by the first parameter to search for more neighborhood nodes of the current node within a larger search range.

In some embodiments, the N is a changing value. For example, if the decoding side searches out, among M nodes to be searched, 3 nodes co-planar with the current node, 5 nodes co-edge with the current node, and 3 nodes co-vertex with the current node based on the above steps, then these 11 nodes are determined as the N neighborhood nodes of the current node. For another example, if the decoding side searches out, among M nodes to be searched, 3 nodes co-planar with the current node and 5 nodes co-edge with the current node based on the above steps, then these 8 nodes are determined as the N neighborhood nodes of the current node.

In some embodiments, the memory of the decoding device includes a neighborhood reference buffer. In this case, decoding side performs the step S102-A, that is, after the M nodes to be searched of the current node are determined based on the neighborhood search range indicated by the first parameter, the M neighborhood nodes are stored in the neighborhood reference buffer. In this way, the decoding side determines the N neighborhood nodes of the current node based on the nodes included in the neighborhood reference buffer. That is, in the embodiments of the present disclosure, the decoding side stores the M nodes to be searched in the neighborhood reference buffer instead of storing all nodes in the current level in the neighborhood reference buffer, which may reduce the proportion of memory occupied by the neighborhood reference buffer, so that the decoding device may use more memory for other attribute decoding operations, thereby improving the efficiency of attribute decoding of the point cloud.

The manner in which the decoding side stores the M nodes to be searched in the neighborhood reference buffer is not limited in the embodiments of the present disclosure.

In a possible implementation, all nodes in the neighborhood reference buffer are deleted, and the M nodes to be searched are stored in the neighborhood reference buffer. That is, in this implementation, when the decoding side performs attribute prediction on different nodes, before storing the M nodes to be searched of the current node into the neighborhood reference buffer, all buffered nodes in the neighborhood reference buffer are deleted to obtain an idle neighborhood reference buffer, and then stores the M nodes to be searched of the current node in the idle neighborhood reference buffer. In this implementation, the operation at the decoding side is relatively simple, which may reduce the complexity of attribute decoding.

In another possible implementation, nodes in the neighborhood reference buffer that are different from the M nodes to be searched are deleted to obtain a neighborhood reference buffer after the nodes are deleted; and nodes among the M nodes to be searched that are different from nodes in the neighborhood reference buffer are stored in the neighborhood reference buffer after the nodes are deleted. That is, in this implementation, the nodes in the current neighborhood reference buffer that are different from the M nodes to be searched of the current node are deleted, and the nodes that are the same as the M nodes to be searched of the current node are retained, and the nodes among the M nodes to be searched that are not included in the current neighborhood reference buffer are stored in the neighborhood reference buffer to reduce the number of node updates.

After the decoding side determines the N neighborhood nodes of the current node based on the above steps, the decoding side performs the following step S103.

In S103, attribute prediction decoding is performed on the current node based on attribute information of the N neighborhood nodes.

The decoding side determines N neighborhood nodes of the current node from the attribute-decoded nodes based on the first parameter, and then performs attribute prediction decoding on the current node based on the attribute information of the N neighborhood nodes.

The manner in which the decoding side performs attribute prediction decoding on the current node based on the attribute information of the N neighborhood nodes is not limited in the embodiments of the present disclosure.

In some embodiments, the decoding side may perform weighting on the attribute information of the N neighborhood nodes to obtain an attribute prediction value of the current node, decode a bitstream to obtain an attribute residual of the current node, and then add the attribute residual and the attribute prediction value to obtain an attribute reconstructed value of the current node.

In some embodiments, the S103 includes the following steps S103-A and S103-B.

In S103-A, attribute prediction values of child nodes of the current node are determined based on the attribute information of the N neighborhood nodes.

In S103-B, attribute reconstructed values of the child nodes of the current node are obtained based on the attribute prediction values of the child nodes of the current node.

In this embodiment, performing attribute prediction decoding on the current node includes performing prediction decoding on the attribute information of the child nodes of the current node. That is, the decoding side performs prediction decoding on the attribute information of the child nodes of the current node based on the attribute information of the N neighborhood nodes of the current node.

As can be seen from FIG. 9B, the decoding side determines the N neighborhood nodes of the current node based on the above steps, then performs up-sampling on the current node to obtain the child nodes of the current node, and then predicts a respective attribute prediction value of each child node of the current node based on the attribute information of the N neighborhood nodes. The attribute prediction values of the child nodes of the current node constitute prediction nodes of the current node.

The process in which the decoding side determines the attribute prediction values of the child nodes of the current node based on the attribute information of N neighborhood nodes will be introduced below.

In the embodiments of the present disclosure, the process of determining a respective attribute prediction value of each child node of the current node based on the attribute information of N neighborhood nodes is consistent. For the sake of convenience of description, the process of determining an attribute prediction value of an i-th child node of the current node is used as an example to illustrate.

In the embodiments of the present disclosure, the manners in which the decoding side determines the attribute prediction value of the i-th child node of the current node based on the attribute information of the N neighborhood nodes include but are not limited to the following contents.

In a manner 1, one or several nearest neighborhood nodes to the i-th child node are selected from the N neighboring nodes, and the attribute prediction value of the i-th child node is determined based on the attribute information of the one or several neighborhood nodes. For example, an average value of the attribute information of one or several neighborhood nodes is determined as the attribute prediction value of the i-th child node.

In a manner 2, the S103-A includes the following steps.

In S103-A1, for an i-th child node of the current node, weighted weights between the i-th child node and the N neighborhood nodes are determined based on distances between the i-th child node and the N neighborhood nodes, where i is a positive integer.

In S103-A2, weighting is performed on the attribute information of the N neighborhood nodes to obtain an attribute prediction value of the i-th child node based on the weighted weights between the i-th child node and the N neighborhood nodes.

In the manner 2, the decoding side determines the weighted weights between the i-th child node and the N neighborhood nodes based on the distance between the i-th child node and the N neighborhood nodes, and then performs, based on the weighted weights between the i-th child node and the N neighborhood nodes, weighting on the attribute information of the N neighborhood nodes to obtain the attribute prediction value of the i-th child node.

In some embodiments, the N neighborhood nodes include the current node itself.

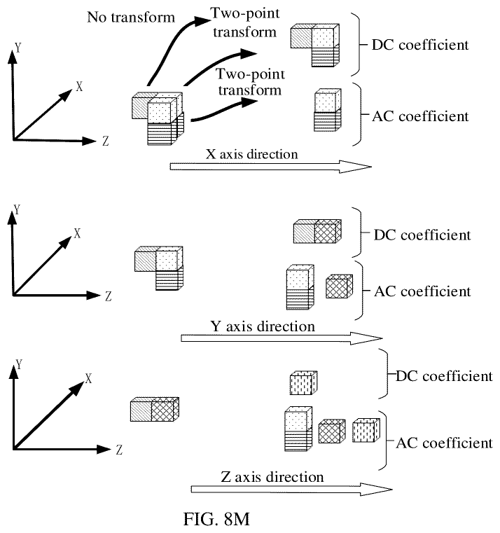

Exemplarily, as illustrated in FIG. 13, the current node includes four neighborhood nodes, including the current node itself, aᵤₚ is an i-th child node in the current node, aₖ is a geometric center of the k-th neighborhood node among the four neighborhood nodes, and dₖ is a geometric distance between the i-th child node and the k-th neighborhood node.

Exemplarily, the decoding side determines the attribute prediction value of the i-th child node based on the following formula (27):

$${\hat{a}}_{i} = Round ( {\sum }_{j = 0}^{N - 1} \frac{{\tilde{w}}_{ij}}{{\sum }_{j = 0}^{N - 1} {\tilde{w}}_{ij}} {\hat{a}}_{j} ) ; \qquad ( 27 )$$

where âᵢ represents the attribute prediction value of the i-th child node, j represents an index of the j-th neighborhood node among the N neighborhood nodes, ãⱼ represents attribute information (i.e., the attribute reconstructed value) of the j-th neighborhood node, and \tilde{w}ᵢⱼ represents a weighted weight between the j-th neighborhood node and the i-th child node.

Exemplarily, the weighted weight between the j-th neighborhood node and the i-th child node may be determined by the following formula (28):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} ; \qquad ( 28 )$$

where (xᵢ, yᵢ, zᵢ) is a geometric coordinate of the i-th child node, and (xᵢⱼ, yᵢⱼ, zᵢⱼ) is a geometric coordinate of the j-th neighborhood node.

The above example takes determining the attribute prediction value of the i-th child node in the current node as an example. Other nodes in the current node may also use the above steps to determine attribute prediction values.

After the decoding side determines the respective attribute prediction value of each child node in the current node based on the above steps, the decoding side performs the step S103-B to obtain attribute reconstructed values of the child nodes of the current node based on the attribute prediction values of the child nodes of the current node.

The manner in which the decoding side obtains the attribute reconstructed values of the child nodes of the current node based on the attribute prediction values of the child nodes of the current node is not limited in the embodiments of the present disclosure.

In some embodiments, the decoding side decodes the bitstream to obtain the respective attribute residual of each child node in the current node, and then adds the respective attribute residual of each child node to the respective attribute prediction value of each child node to obtain the respective attribute reconstructed value of each child node in the current node.

In some embodiments, the S103-B includes the following steps S103-B1 to S103-B4.

In S103-B1, the bitstream is decoded to obtain residuals of transform coefficients of the child nodes of the current node.

In S103-B2, transform is performed on the attribute prediction values of the child nodes of the current node to obtain prediction values of the transform coefficients of the child nodes of the current node.

In S103-B3, reconstructed values of the transform coefficients of the child nodes of the current node are obtained based on the residuals of transform coefficients and the prediction values of the transform coefficients of the child nodes of the current node.

In S103-B4, inverse transform is performed on the reconstructed values of the transform coefficients of the child nodes of the current node to obtain the attribute reconstructed values of the child nodes of the current node.

In this embodiment, the decoding side uses a transform prediction method to determine the respective attribute reconstructed value of each child node of the current node.

In some implementations, the encoding side determines the respective transform coefficient residual of each child node of the current node, and then signals the respective transform coefficient residual of each child node into the bitstream. For example, the encoding side performs quantization on the respective transform coefficient residual of each child node and signals the quantized transform coefficient residual into the bitstream.

In this way, the decoding side decodes the bitstream to obtain the respective transform coefficient residual of each child node in the current node. For example, the bitstream is decoded to obtain the respective quantized transform coefficient residual of each child node, and inverse quantization is performed on the quantized transform coefficient residual to obtain the respective transform coefficient residual of each child node in the current node.

Next, transform is performed on the attribute prediction values of the child nodes of the current node determined to obtain prediction values of the transform coefficients of the child nodes of the current node.

Then, based on the residuals of transform coefficients and the prediction values of the transform coefficients of the child nodes of the current node, the reconstructed values of the transform coefficients of the child nodes of the current node are obtained. For example, the respective transform coefficient residual and the respective transform coefficient prediction value of each child node of the current node are added together to obtain the respective transform coefficient reconstructed value of each child node.

Finally, inverse transform is performed on the reconstructed values of the transform coefficients of the child nodes of the current node to obtain the attribute reconstructed values of the child nodes of the current node.

The transform manner in which the decoding side performs transform on the attribute prediction values of the child nodes of the current node to obtain the prediction values of the transform coefficients of the child nodes of the current node is not limited in the embodiments of the present disclosure.

In some embodiments, the decoding side uses region adaptive hierarchical transform (i.e., RAHT transform) to perform prediction transform on the child nodes of the current node. In this case, the transform coefficients include high frequency coefficients (i.e., AC coefficients). In this case, the above steps S103-B1 to S103-B4 may be replaced by the following steps.

In Step 1, the bitstream is decoded to obtain residuals of high frequency coefficients of the child nodes of the current node.

In Step 2, region adaptive hierarchical transform is performed on the attribute prediction values of the child nodes of the current node to obtain prediction values of high frequency coefficients of the child nodes of the current node.

In Step 3, reconstructed values of high frequency coefficients of the child nodes of the current node are obtained based on the residuals of high frequency coefficients and the prediction values of high frequency coefficients of the child nodes of the current node.

In Step 4, inverse region adaptive hierarchical transform is performed based on the reconstructed values of high frequency coefficients of the child nodes of the current node, to obtain the attribute reconstructed values of the child nodes of the current node.

In this embodiment, if the decoding side uses RAHT transform prediction, the decoding side decodes the bitstream to obtain the respective AC coefficient residual of each child node in the current node. In an example, if the encoding side performs quantization on the AC coefficient residual and signals the quantized AC coefficient residual into the bitstream, the decoding side decodes the bitstream to obtain the respective quantized AC coefficient residual of each child node, and performs inverse quantization on the quantized AC coefficient residual to obtain the respective AC coefficient residual of each child node.

Next, the decoding side performs RAHT transform on the attribute prediction values of the child nodes of the current node to obtain the prediction values of AC coefficients of the child nodes of the current node.

Exemplarily, the decoding side performs RAHT transform on the attribute prediction values of the child nodes of the current node by the method shown in the following formula (29) to obtain the prediction values of AC coefficients of the child nodes of the current node:

$$[ \begin{matrix}* \\ {AC}_{1 , up} \\ ⋮ \\ {AC}_{k - 1 , up}\end{matrix} ] = {T}_{node 1} [ \begin{matrix}{A}_{1 , up} / \sqrt{{w}_{1}} \\ ⋮ \\ {A}_{k , up} / \sqrt{{w}_{k}}\end{matrix} ] ; \qquad ( 29 )$$

where the current node includes k child nodes, A_{1,up} is a prediction value of the first child node of the current node, A_{k,up} is a prediction value of the k-th child node of the current node, AC_{1,up} to AC_{k-1,up} are k−1 prediction values of AC coefficients corresponding to k child nodes. “*” represents one DC coefficient corresponding to k child nodes. T_{node1} is a transform matrix corresponding to the prediction node of the current node, which is determined by the respective number of points included in each child node. w₁ is weight corresponding to the first child node, and wₖ is weight corresponding to the k-th child node.

Then, the decoding side adds the residuals of AC coefficients and the prediction values of AC coefficients of the child nodes of the current node to obtain the reconstructed values of AC coefficients of the child nodes of the current node.

Exemplarily, the decoding side obtains the reconstructed values of AC coefficients of the child nodes of the current node by the following formula (30):

$$[ \begin{matrix}0 \\ {AC}_{1 , rec} \\ ⋮ \\ {AC}_{k - 1 , rec}\end{matrix} ] = [ \begin{matrix}0 \\ {AC}_{1 , res} \\ ⋮ \\ {AC}_{k - 1 , res}\end{matrix} ] + [ \begin{matrix}0 \\ {AC}_{1 , up} \\ ⋮ \\ {AC}_{k - 1 , up}\end{matrix} ] ; \qquad ( 30 )$$

where AC_{1,res} to AC_{k-1,res} are the k−1 residuals of AC coefficients corresponding to the k child nodes included in the current node, and AC_{1,rec} to AC_{k-1,rec} are the k−1 reconstructed values of AC coefficients corresponding to the k child nodes of the current node.

Finally, the RAHT inverse transform is performed based on the reconstructed values of AC coefficients of the child nodes of the current node to obtain the attribute reconstructed values of the child nodes of the current node.

Exemplarily, the decoding side obtains the attribute reconstructed value of the child node of the current node by the following formula (31):

$$[ \begin{matrix}* \\ {AC}_{1 , rec} \\ ⋮ \\ {AC}_{k - 1 , rec}\end{matrix} ] = {T}_{node 2} [ \begin{matrix}{A}_{1 , rec} / \sqrt{{w}_{1}} \\ ⋮ \\ {A}_{k , rec} / \sqrt{{w}_{k}}\end{matrix} ] ; \qquad ( 31 )$$

where T_{node2} is a transform matrix corresponding to the current node, which is related to the number of points included in the current node, A_{1,rec} is an attribute reconstructed value of the first child node in the current node, and A_{k,rec} is an attribute reconstructed value of the k-th child node in the current node.

In some embodiments, the decoding side performs RAHT inverse transform based on a low frequency coefficient (i.e., DC coefficient) of the current node and the reconstructed values of AC coefficients of the child nodes of the current node to obtain attribute reconstructed values of the child nodes of the current node.

Exemplarily, the decoding side obtains the attribute reconstructed values of the child nodes of the current node by the following formula (32):

$$[ \begin{matrix}DC \\ {AC}_{1 , rec} \\ ⋮ \\ {AC}_{k - 1 , rec}\end{matrix} ] = {T}_{node 2} [ \begin{matrix}{A}_{1} , rec / \sqrt{{w}_{1}} \\ ⋮ \\ {A}_{k} , rec / \sqrt{{w}_{k}}\end{matrix} ] ; \qquad ( 32 )$$

where DC is a DC coefficient of the current node.

In the embodiments of the present disclosure, the decoding side may determine the respective attribute reconstructed value of each child node in the current node based on the formula (31) or (32), and realize the attribute prediction decoding of the child nodes of the current node.

As can be seen from the above, in the embodiments of the present disclosure, the neighborhood search range is controlled by the first parameter, and then based on the neighborhood search range indicated by the first parameter, N neighborhood nodes of the current node are searched out, and then based on the attribute information of the N neighborhood nodes, the attribute prediction decoding is performed on the current node. That is, in the embodiments ofthe present disclosure, the first parameter is used to indicate the size of the neighborhood search range, in the embodiments of the present disclosure, so that the neighborhood search range is relatively small, thereby saving memory resources of the decoding device, and improving the attribute decoding performance of the point cloud.

In order to further illustrate the decoding effect of the point cloud decoding method proposed in the embodiments of the present disclosure, the efficiency of attribute decoding under different values of the first parameter raht_prediction_search_range is shown below.

In an example, in a case where the first parameter raht_prediction_search_range is 128, the efficiency of attribute decoding is shown in Table 4 and Table 5.

TABLE 4

| | Lossy geometry, Lossless attributes (All-Intra) | | | |
|---|---|---|---|---|
| | Geometry BD-Rate [%] | | | |
| C1_ai | Luma | Chroma Cb | Chroma Cr | Reflectance |
| Solid Average | 5.8% | 4.9% | 5.6% | |
| Dense Average | 5.2%% | 4.6% | 4.9% | |
| Sparse Average | 2.1% | 2.6% | 2.5% | |
| Scant average | 2.7% | 3.1% | 3.0% | |
| Am-fusion average | 0.7% | 0.6% | 0.6% | 1.0% |
| Am-frame spinning | | | | 0.1% |
| average | | | | |
| Am-frame non-spinning | | | | 0.2% |
| average | | | | |
| Overall average | 3.6% | 3.5% | 3.7% | 0.3% |

| | |
|---|---|
| Average encoding time [%] | 95% |
| Average decoding time [%] | 95% |

TABLE 5

| | Lossy geometry, Lossless attributes (All-Intra) | | | |
|---|---|---|---|---|
| | Geometric BD bitrate [%] | | | |
| C2_ai | Luma | Chroma Cb | Chroma Cr | Reflectance |
| Solid Average | 3.4% | 3.1% | 3.9% | |
| Dense Average | 4.0%% | 3.8% | 4.3% | |
| Sparse Average | 2.0% | 2.6% | 2.6% | |
| Scant average | 2.7% | 3.2% | 3.1% | |
| Am-fusion average | 1.1% | 0.7% | 0.8% | 1.2% |
| Am-frame spinning | | | | 0.2% |
| average | | | | |
| Am-frame non-spinning | | | | 0.4% |
| average | | | | |
| Overall average | 3.6% | 3.5% | 3.7% | 0.5% |

| | |
|---|---|
| Average encoding time [%] | 100% |
| Average decoding time [%] | 95% |

It can be seen from Tables 4 and 5 that if the first parameter is 128, the solution of the embodiment of the present disclosure may bring about a 3.6% loss under conditions C1 and C2, but the time complexity is reduced by 5%.

In an example, in a case where the first parameter raht_prediction_search_range is 512, the efficiency of attribute decoding is shown in Table 6 and Table 7.

TABLE 6

| | Lossy geometry, Lossless attributes (All-Intra) | | | |
|---|---|---|---|---|
| | Geometry BD bitrate [%] | | | |
| C1_ai | Luma | Chroma Cb | Chroma Cr | Reflectance |
| Solid Average | 2.6% | 2.2% | 2.5% | |
| Dense Average | 2.3%% | 1.9% | 2.0% | |
| Sparse Average | 0.9% | 1.1% | 1.1 | |
| Scant average | 1.2% | 1.3% | 1.3% | |
| Am-fusion average | 0.3% | 0.3% | 0.3% | 0.4% |
| Am-frame spinning | | | | 0.0% |
| average | | | | |
| Am-frame non-spinning | | | | 0.0% |
| average | | | | |
| Overall average | 1.6% | 1.5% | 1.6% | 0.1% |

| | |
|---|---|
| Average encoding time [%] | 97% |
| Average decoding time [%] | 97% |

TABLE 7

| | Lossy geometry, Lossless attributes (All-Intra) | | | |
|---|---|---|---|---|
| | Geometric BD bitrate [%] | | | |
| C2_ai | Luma | Chroma Cb | Chroma Cr | Reflectance |
| Solid Average | 1.4% | 1.4% | 1.7% | |
| Dense Average | 1.7%% | 1.5% | 1.7% | |
| Sparse Average | 0.9% | 1.1% | 1.0% | |
| Scant average | 1.2% | 1.4% | 1.3% | |
| Am-fusion average | 0.5% | 0.3% | 0.3% | 0.5% |
| Am-frame spinning | | | | 0.0% |
| average | | | | |
| Am-frame non-spinning | | | | 0.2% |
| average | | | | |
| Overall average | 1.3% | 1.3% | 1.4% | 0.2% |

| | |
|---|---|
| Average encoding time [%] | 100% |
| Average decoding time [%] | 95% |

It can be seen from Tables 4 to 7 that the smaller the first parameter raht_prediction_search_range is set, the greater the impact on efficiency of attribute decoding.

In the point cloud decoding method provided in the embodiments of the present disclosure, when performing attribute decoding, a decoding side first determines a first parameter, which is used to indicate a neighborhood search range. Then, the decoding side searches for N neighborhood nodes of a current node based on the neighborhood search range indicated by the first parameter, and then, performs attribute prediction decoding on the current node based on attribute information of the N neighborhood nodes. That is, in the embodiments of the present disclosure, the first parameter is used to indicate the neighborhood search range, so that the neighborhood search range may be controlled, avoiding large-scale occupation of memory resources during the neighborhood search, thereby saving memory resources of the decoding device and improving attribute decoding performance of the point cloud.

The above description introduces the point cloud decoding method provided in the embodiments of the present disclosure in detail by taking the decoding side as an example. The following description will introduce the point cloud encoding method provided in the embodiments of the present disclosure by taking the encoding side as an example.

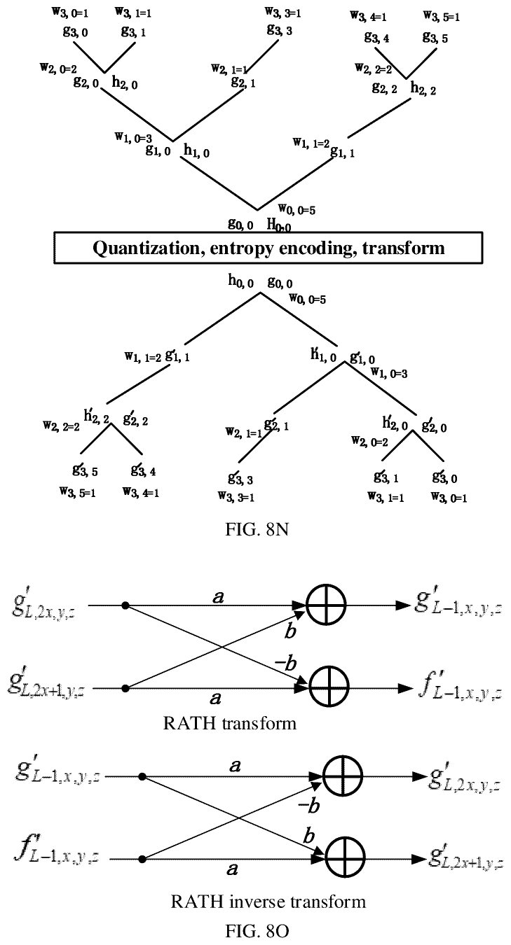

FIG. 14 is a schematic flowchart of a point cloud encoding method provided in an embodiment of the present disclosure. The point cloud encoding method of the embodiment of the present disclosure may be implemented by a point cloud encoding device illustrated in FIG. 3 or FIG. 4A as mentioned above.

As illustrated in FIG. 14, the point cloud encoding method of the embodiment of the present disclosure includes the following steps.

In S201, a first parameter is determined.

The first parameter is used to indicate a neighborhood search range.

As can be seen from the above, a point cloud includes geometric information and attribute information, and encoding of the point cloud includes geometric encoding and attribute encoding. The embodiments of the present disclosure relate to the attribute encoding of the point cloud.

The attribute encoding of the point cloud in the embodiments of the present disclosure is performed after the geometry encoding of the point cloud. That is, in the embodiments of the present disclosure, the geometric information of the point cloud is first encoded, and then the attribute information of the point cloud is encoded.

In some embodiments, when encoding the attribute information of the point cloud, tree partition is performed on the point cloud based on the geometric information of the point cloud, for example, octree partitioning is performed, and attribute prediction encoding is performed on each node in the octree.

Taking the octree partitioning of the point cloud as an example, in some embodiments, when encoding the attribute information of the point cloud, an octree structure of the point cloud is first constructed based on the geometric information of the point cloud. As illustrated in FIG. 11, the point cloud is enclosed by a smallest rectangular block, and octree partitioning is performed on the bounding box to obtain 8 nodes. The octree partitioning is continued performed on occupied nodes in these 8 nodes, i.e., the nodes including points, and so on, until the partitioning reaches a voxel level position, for example, until there exists cubes of 1×1×1. An octree structure of the point cloud obtained by such partitioning manner is composed of multiple levels of nodes, such as N levels. Attribute information of nodes in each level is encoded level by level in attribute encoding until leaf nodes at the voxel level in the last level are encoded.

In the embodiments of the present disclosure, for any node whose attribute information is to be encoded in the octree, the encoding process of the attribute information is basically the same. For the sake of convenience of description, the attribute information encoding process of a node in the octree is taken as an example for illustration. In the subsequent description, the node whose attribute information is to be encoded is referred to as a current node. That is, the current node in the embodiments of the present disclosure may be understood as any node whose attribute information is to be encoded in the point cloud partition tree (e.g., an octree).

In some embodiments, when encoding the attribute information of the current node, it is necessary to determine N neighborhood nodes of the current node. For example, among nodes whose attribute information has been encoded, neighborhood nodes that are co-planar, co-edge, or co-vertex with the current node are searched for, and then prediction encoding of the attribute information of the current node is performed based on the attribute information of the N neighborhood nodes.

Currently, when determining the N neighborhood nodes of the current node, a full search is typically performed, for example, by searching among all attribute-encoded nodes or among nodes in a current level where the current node is located. In some cases, when searching for the N neighborhood nodes of the current node, the encoding device first loads all nodes within the search range into a memory, for example, into a neighborhood reference buffer in the memory. A neighborhood node search is performed in the current level where the current node is located. Assuming that the current level includes a large number of nodes, for example, tens of thousands of nodes, or more nodes, the search range is not limited in the relevant technology, but the tens of thousands of nodes are loaded into the memory, and then search is performed in the memory to obtain N neighborhood nodes of the current node. This will take up a large amount of memory, and the memory of the encoding device is limited, which will reduce the encoding performance of the encoding device.

In order to solve the above technical problems, the neighborhood search range is limited by the first parameter in the embodiments of the present disclosure, so that when the encoding device determines the neighborhood nodes of the current node, search is performed within the neighborhood search range indicated by the first parameter, thereby reducing the occupied proportion of device memory during the neighborhood node search, and thereby improving the attribute encoding performance of the point cloud of the encoding device.

In some embodiments, the neighborhood search range may be understood as a search range for searching neighborhood nodes.

In some embodiments, the neighborhood search range may be understood as a search radius of neighborhood nodes.

The specific expression form of the neighborhood search range is not limited in the embodiments of the present disclosure.

In a possible implementation, the neighborhood search range may refer to a preset number of nodes, exemplarily, the neighborhood search range is P nodes. Exemplarily, the encoding side performs neighborhood node search among the P nodes near the current node.

In a possible implementation, the neighborhood search range refers to a preset distance, for example, the neighborhood search range is a distance “s”. Exemplarily, the encoding side performs neighborhood node search among nodes within a distance m from the current node.

The process of determining the first parameter at the encoding side will be introduced below.

In some embodiments, the first parameter may be a preset value or a default value. That is, the encoding side and the decoding side determine the preset value or the default value as the neighborhood search range.

In some embodiments, the first parameter is specified by upper-layer semantics.

In some embodiments, the encoding side determines a first parameter and signals the first parameter into a bitstream. In this way, the decoding side obtains the first parameter by decoding the bitstream, and then obtains the neighborhood search range of the current node based on the first parameter.

The specific expression form of the first parameter is not limited in the embodiments of the present disclosure.

Exemplarily, a field raht_prediction_search_range may be used to represent the first parameter.

The specific position of the first parameter in the bitstream is not limited in the embodiments of the present disclosure.

In some embodiments, the bitstream includes an attribute parameter set (APS), and the encoding side signals the first parameter into the APS.

The specific position and specific expression form of the first parameter in the ASP is not limited in the embodiments of the present disclosure.

In an example, the syntax of the attribute parameter set data unit is shown in Table 3.

In this example, the encoding side signals the first parameter raht_prediction_search_range into the ASP to obtain syntax elements shown in Table 3. In this way, the decoding side obtains the first parameter raht_prediction_search_range via the ASP shown in Table 3, and then obtains the value of the neighborhood search range or the search radius of the neighborhood node according to the first parameter.

In some embodiments, the encoding side may further signal the first parameter into other locations except the APS in the bitstream. Correspondingly, the decoding side obtains the first parameter by decoding from other locations in the bitstream, which is not limited in the embodiments of the present disclosure.

After the encoding side determines the first parameter based on the above steps, the encoding side performs the following step S202.

In S202, N neighborhood nodes of a current node are determined based on the neighborhood search range.

After the encoding side determines the first parameter based on the above steps, the encoding side may determine a neighborhood search range, and then determine N neighborhood nodes of the current node based on the neighborhood search range. That is, in the embodiments of the present disclosure, the encoding side searches for the neighborhood nodes of the current node within the neighborhood search range indicated by the first parameter, thereby controlling the neighborhood search range and avoiding large-scale occupation of device memory during the neighborhood node search, thereby improving the attribute encoding performance of the point cloud.

The method of determining the N neighborhood nodes of the current node based on the neighborhood search range is not limited in the embodiments of the present disclosure.

In some embodiments, when encoding the attribute information of the current node, attribute information of some nodes in the point cloud has been encoded. Therefore, based on the neighborhood search range, a part of the nodes whose attribute information has been encoded are first selected to perform neighborhood node search. If no neighborhood node is searched out, or the number of neighborhood nodes searched out does not reach the expected value, another part of the nodes will be selected based on the neighborhood search range to perform neighborhood node search, and so on, until the neighborhood node that meets the preset requirement is searched out.

For example, assuming that there are 1000 attribute-encoded nodes currently, and assuming that the neighborhood search range indicated by the first parameter is 50, 50 nodes are first selected from the 1000 nodes whose attribute information has been encoded, and a search for neighborhood nodes of the current node is performed among the 50 nodes. If no neighborhood node is searched out, or the number of neighborhood nodes searched out does not meet the requirement, another 50 nodes are selected from the remaining 950 nodes, and the neighborhood nodes of the current node are searched among the 50 new nodes, and so on, until neighborhood nodes that meet the preset requirement are searched out.

In some embodiments, since it can be seen from the octree partitioning that attributes of nodes in the same level are highly correlated, when searching for neighborhood nodes of the current node, the search is performed among the nodes in the current level where the current node is located. Based on this, the encoding side may select, based on the neighborhood search range, a part of nodes among the nodes included in the current level to perform neighborhood node search.

If no neighborhood node is searched out, or the number of neighborhood nodes searched out does not reach the expected value, the encoding side may select, based on the neighborhood search range, another part of the nodes included in the current level to perform neighborhood node search, and so on, until neighborhood nodes that meet the preset requirement are searched out.

For example, assuming that the current level includes 200 nodes, and assuming that the neighborhood search range indicated by the first parameter is 50, 50 nodes are first selected from the 200 nodes included in the current level, and a search for neighborhood nodes of the current node is performed among the 50 nodes. If no neighborhood node is searched out, or the number of neighborhood nodes searched out does not meet the requirement, 50 nodes are selected from the remaining 150 nodes in the current level, and the neighborhood nodes of the current node are searched among the 50 new nodes, and so on, until neighborhood nodes that meet the preset requirement are searched out.

In some embodiments, the S202 includes the following steps S202-A and S202-B.

In S202-A, M nodes to be searched of the current node are determined based on the neighborhood search range, where M is a positive integer.

In S202-B, N neighborhood nodes of the current node are determined based on the M nodes to be searched.

In this embodiment, the encoding side first determines M nodes to be searched of the current node based on the neighborhood search range indicated by the first parameter, and then determines N neighborhood nodes of the current node based on the M nodes to be searched. For example, the encoding side first determines in which nodes to perform neighborhood node search based on the neighborhood search range, for example, the encoding side determines to perform neighborhood node search among M nodes to be searched. In this embodiment, the encoding side determines M nodes to be searched at one time based on the neighborhood search range indicated by the first parameter, without frequently changing the nodes to be searched, thereby further improving the efficiency of searching the neighborhood nodes.

The process of the encoding side determining the M nodes to be searched of the current node based on the neighborhood search range is not limited in the embodiments of the present disclosure.

In some embodiments, determining M nodes to be searched from the current level where the current node is located is taken as an example for explanation. The encoding side determines, based on the neighborhood search range indicated by the first parameter, M nodes to be searched among the nodes whose attribute information has been encoded and included in the current level. For example, according to the attribute encoding order of the nodes in the current level, based on the neighborhood search range, M nodes to be searched are selected from the attribute-encoded nodes in the current level.

In an example, if the neighborhood search range is P nodes, the encoding side selects P nodes from the attribute-encoded nodes according to the attribute encoding order of the nodes in the current level as the M nodes to be searched of the current node. In this case, M equals P.

In another example, if the neighborhood search range is a distance “s”, the encoding side selects, starting from the first attribute-encoded node, according to the attribute encoding order of the nodes in the current level, several attribute-encoded nodes within the distance “s” as the M nodes to be searched of the current node.

In some embodiments, the M nodes to be searched include the current node. That is, the encoding side determines, based on the neighborhood search range, M nodes to be searched of the current node from the attribute-encoded nodes near the current node.

In some embodiments, the encoding side determines M nodes to be searched of the current node through the following step S202-A1.

In S202-A1, the M nodes to be searched among the nodes included in the current level are determined based on the neighborhood search range and the current node.

In this embodiment, in order to further improve the accuracy of determining the nodes to be searched, the encoding side determines the M nodes to be searched among the nodes included in the current level based on the neighborhood search range indicated by the first parameter of the current node.

In the embodiments of the present disclosure, manners for the encoding side to determine the M nodes to be searched from the nodes included in the current level based on the neighborhood search range and the current node include but are not limited to the following contents.

In a manner 1, the encoding side determines nodes before the current node in the current level and within the neighborhood search range as the M nodes to be searched of the current node.

In an example, assuming that the neighborhood search range is P nodes, the encoding side determines P nodes whose attribute information has been encoded and that are located before the current node in the current level as the M nodes to be searched of the current node.

Optionally, if the number Q of nodes whose attribute information has been encoded and that are located before the current node in the current level is less than P, the Q nodes whose attribute information has been encoded and that are located before the current node in the current level are used as the M nodes to be searched of the current node, in this case, M equals Q.

In another example, if the neighborhood search range is a distance “s”, the encoding side uses nodes whose attribute information has been encoded and that are located within the distance “s” before the current node in the current level as the M nodes to be searched of the current node.

In a manner 2, the encoding side determines nodes after the current node in the current level and within the neighborhood search range as the M nodes to be searched of the current node.

In an example, assuming that the neighborhood search range is P nodes, the encoding side determines P nodes whose attribute information has been encoded and that are located after the current node in the current level as the M nodes to be searched of the current node.

Optionally, if the number Q of nodes whose attribute information has been encoded and that are located after the current node in the current level is less than P, the Q nodes whose attribute information has been encoded and that are located after the current node in the current level are used as the M nodes to be searched of the current node, in this case, M equals Q.

In another example, if the neighborhood search range is a distance “s”, the encoding side uses the nodes whose attribute information has been encoded and that are located within the distance “s” after the current node in the current level as the M nodes to be searched of the current node.

In a manner 3, the encoding side determines, among the nodes included in the current level, M nodes to be searched of the current node by taking the current node as a search center and taking half of the neighborhood search range as a search radius.

In an example, assuming that the neighborhood search range is P nodes, the encoding side determines P/2 nodes whose attribute information has been encoded and that are located before the current node in the current level, and P/2 nodes whose attribute information has been encoded and that are located after the current node in the current level, as the M nodes to be searched of the current node.

Optionally, if the number of nodes whose attribute information has been encoded and that are located before the current node in the current level is less than P/2, then each node whose attribute information has been encoded and that is located before the current node in the current level is used as part of the M nodes to be searched of the current node.

Optionally, if the number of nodes whose attribute information has been encoded and that are located after the current node in the current level is less than P/2, then each node whose attribute information has been encoded and that is located after the current node in the current level is used as part of the M nodes to be searched of the current node.

In another example, if the neighborhood search range is a distance “s”, the encoding side uses nodes whose attribute information has been encoded and that are located within a distance “s/2” before the current node in the current level, and the nodes whose attribute information has been encoded and that are located within a distance “s/2” after the current node in the current level, as the M nodes to be searched of the current node.

In a manner 4, the encoding side determines, among the nodes included in the current level, M nodes to be searched by taking the current node as a search center and taking the neighborhood search range as a search radius.

Exemplarily, as illustrated in FIG. 12, i is the current node, M nodes to be searched of the current node are determined among the nodes included in the current level by taking the current node i as the search center, and taking the neighborhood search range as the search radius. Since all of the M nodes to be searched are nodes whose attribute information has been encoded, the encoding side may determine the M nodes to be searched of the current node among the nodes included in the current level by taking the current node i as the search center, and the encoding side determines the nodes whose attribute information has been encoded and that are located within the neighborhood search range to the left of the current node in the current level, and the nodes whose attribute information has been encoded and that are located within the neighborhood search range to the right of the current node in the current level, as the M nodes to be searched of the current node.

Based on different expression forms of the neighborhood search range, in the manner 4, the manner in which the encoding side determines the M nodes to be searched includes the following examples.

In an example, assuming that the neighborhood search range is P nodes, the encoding side determines P nodes whose attribute information has been encoded and that are located before the current node in the current level, and P nodes whose attribute information has been encoded and that are located after the current node in the current level, as the M nodes to be searched of the current node.

Optionally, if the number of nodes whose attribute information has been encoded and that are located before the current node in the current level is less than P, then each node whose attribute information has been encoded and that is located before the current node in the current level is used as part of the M nodes to be searched of the current node.

Optionally, if the number of nodes whose attribute information has been encoded and that are located after the current node in the current level is less than P, then each node whose attribute information has been encoded and that is located after the current node in the current level is used as part of the M nodes to be searched of the current node.

In another example, if the neighborhood search range is a distance “s”, the encoding side uses nodes whose attribute information has been encoded and that are located within the distance “s” before the current node in the current level, and nodes whose attribute information has been encoded and that are located within the distance “s” after the current node in the current level, as the M nodes to be searched of the current node.

As can be seen from the above, in the embodiments of the present disclosure, the encoding side determines the M nodes to be searched based on the neighborhood search range indicated by the first parameter, and then searches for the N neighborhood nodes of the current node among the M nodes to be searched, rather than searching for neighborhood nodes in the entire current level, thereby reducing the search range of neighborhood nodes, saving memory, improving search efficiency, and thus improving the efficiency of attribute encoding of the point cloud.

Based on the above steps, after the encoding side determines the M nodes to be searched of the current node, the step S202-B is performed.

In the embodiments of the present disclosure, in the above S202-B, the manners for determining the N neighborhood nodes of the current node based on the M nodes to be searched include but are not limited to the following contents.

In a manner 1, the encoding side determines N neighborhood nodes of the current node among the M nodes to be searched based on geometric information. In this case, the S202-B includes the following step S202-B1.

In S202-B1, the N neighborhood nodes are obtained by searching among the M nodes to be searched based on geometric information of the current node and geometric information of the M nodes to be searched.

In the manner 1, as can be seen from the above, the geometric information of the point cloud has been encoded, so the encoding side may determine the N neighborhood nodes of the current node among the M nodes to be searched according to the geometric information of the current node and the geometric information of the M nodes to be searched.

In some embodiments, the N neighborhood nodes include at least one of: at least one node co-planar with the current node, at least one node co-edge with the current node, or at least one node co-vertex with the current node.

In an example, if the N neighborhood nodes include at least one node co-planar with the current node, the encoding side determines, among the M nodes to be searched, at least one node to be searched that is co-planar with the current node based on the geometric information of the current node and the geometric information of the M nodes to be searched, and determines the at least one node to be searched as at least one co-planar node among the N neighborhood nodes of the current node.

In an example, if the N neighborhood nodes include at least one node co-edge with the current node, the encoding side determines, among the M nodes to be searched, at least one node to be searched that is co-edge with the current node based on the geometric information of the current node and the geometric information of the M nodes to be searched, and determines the at least one node to be searched as at least one co-edge node among the N neighborhood nodes of the current node.

In an example, if the N neighborhood nodes include at least one node co-vertex with the current node, the encoding side determines, among the M nodes to be searched, at least one node to be searched that is co-vertex with the current node based on the geometric information of the current node and the geometric information of the M nodes to be searched, and determines the at least one node to be searched as at least one co-vertex node among the N neighborhood nodes of the current node.

In a manner 2, N neighborhood nodes of the current node are determined among M nodes to be searched based on Morton code or Hilbert code.

As can be seen from the above, the geometric information of the point cloud has been encoded, so respective geometric information of each node in the octree is known. Based on this, the encoding side may determine the Morton code or Hilbert code of the current node and the M nodes to be searched according to the geometric information of the current node and the geometric information of the M nodes to be searched. Since the attribute information of nodes with similar Morton codes or Hilbert codes is relatively similar, the current node and the M nodes to be searched are sorted based on Morton codes or Hilbert codes of the current node and the M nodes to be searched. From the sorted current node and the M nodes to be searched, the N nodes to be searched that are closest to the current node are selected as the N neighborhood nodes of the current node.

In some embodiments, the encoding side may also search for N neighborhood nodes of the current node among the M nodes to be searched in other manners.

In some embodiments, the N neighborhood nodes of the current node may include, in addition to at least one node co-planar with the current node, and/or at least one node co-edge with the current node, and/or at least one node co-vertex with the current node, nodes within a preset range, such as a node that is one node away from the current node.

In some embodiments, the above N is a fixed value, for example, the above N equals 3. When the encoding side searches out, among M nodes to be searched, 3 nodes co-planar with the current node, 5 nodes co-edge with the current node, and 3 nodes co-vertex with the current node based on the above steps, 3 nodes are selected from these 11 nodes as neighborhood nodes of the current node. For example, 3 nodes co-planar with the current node are selected as 3 neighborhood nodes of the current node. In an example, if the encoding side determines, among M nodes to be searched, one neighborhood node that meets the requirement based on the above steps, the encoding side may use at least one neighborhood node of the co-located node as a neighborhood node of the current node, or expand the neighborhood search range indicated by the first parameter to search for more neighborhood nodes of the current node within a larger search range.

In some embodiments, the N is a changing value. For example, if the encoding side searches out, among M nodes to be searched, 3 nodes co-planar with the current node, 5 nodes co-edge with the current node, and 3 nodes co-vertex with the current node based on the above steps, then these 11 nodes are determined as the N neighborhood nodes of the current node. For another example, if the encoding side searches out, among M nodes to be searched, 3 nodes co-planar with the current node and 5 nodes co-edge with the current node based on the above steps, then these 8 nodes are determined as the N neighborhood nodes of the current node.

In some embodiments, the memory of the encoding device includes a neighborhood reference buffer. In this case, encoding side performs the step S202-A, that is, after the M nodes to be searched of the current node are determined based on the neighborhood search range indicated by the first parameter, the M neighborhood nodes are stored in the neighborhood reference buffer. In this way, the encoding side determines the N neighborhood nodes of the current node based on the nodes included in the neighborhood reference buffer. That is, in the embodiments of the present disclosure, the encoding side stores the M nodes to be searched in the neighborhood reference buffer instead of storing all nodes in the current level in the neighborhood reference buffer, which may reduce the proportion of memory occupied by the neighborhood reference buffer, so that the encoding device may use more memory for other attribute encoding operations, thereby improving the efficiency of attribute encoding of the point cloud.

The manner in which the encoding side stores the M nodes to be searched in the neighborhood reference buffer is not limited in the embodiments of the present disclosure.

In a possible implementation, all nodes in the neighborhood reference buffer are deleted, and the M nodes to be searched are stored in the neighborhood reference buffer. That is, in this implementation, when the encoding side performs attribute prediction on different nodes, before storing the M nodes to be searched of the current node into the neighborhood reference buffer, all buffered nodes in the neighborhood reference buffer are deleted to obtain an idle neighborhood reference buffer, and then stores the M nodes to be searched of the current node in the idle neighborhood reference buffer. In this implementation, the operation at the encoding side is relatively simple, which may reduce the complexity of attribute encoding.

In another possible implementation, nodes in the neighborhood reference buffer that are different from the M nodes to be searched are deleted to obtain a neighborhood reference buffer after the nodes are deleted; and nodes among the M nodes to be searched that are different from nodes in the neighborhood reference buffer are stored in the neighborhood reference buffer after the nodes are deleted. That is, in this implementation, the nodes in the current neighborhood reference buffer that are different from the M nodes to be searched of the current node are deleted, and the nodes that are the same as the M nodes to be searched of the current node are retained, and the nodes among the M nodes to be searched that are not included in the current neighborhood reference buffer are stored in the neighborhood reference buffer to reduce the number of node updates.

After the encoding side determines the N neighborhood nodes of the current node based on the above steps, the encoding side performs the following step S203.

In S203, attribute prediction encoding is performed on the current node based on attribute information of the N neighborhood nodes.

The encoding side determines N neighborhood nodes of the current node from the attribute-encoded nodes based on the first parameter, and then performs attribute prediction encoding on the current node based on the attribute information of the N neighborhood nodes.

The manner in which the encoding side performs attribute prediction encoding on the current node based on the attribute information of the N neighborhood nodes is not limited in the embodiments of the present disclosure.

In some embodiments, the encoding side may perform weighting on the attribute information of the N neighborhood nodes to obtain an attribute prediction value of the current node, and subtract the attribute information of the current node from the attribute prediction value of the current node to obtain an attribute residual of the current node. Next, the attribute residual of the current node is encoded to obtain a bitstream. For example, the attribute residual of the current node is quantized and then encoded to obtain a bitstream.

In some embodiments, the S203 includes the following steps S203-A and S203-B.

In S203-A, attribute prediction values of child nodes of the current node are determined based on the attribute information of the N neighborhood nodes.

In S203-B, encoding is performed based on the attribute prediction values of the child nodes of the current node to obtain the bitstream

In this embodiment, performing attribute prediction encoding on the current node includes performing prediction encoding on the attribute information of the child nodes of the current node. That is, the encoding side performs prediction encoding on the attribute information of the child nodes of the current node based on the attribute information of the N neighborhood nodes of the current node.

As can be seen from FIG. 9B, the encoding side determines the N neighborhood nodes of the current node based on the above steps, then performs up-sampling on the current node to obtain the child nodes of the current node, and then predicts the respective attribute prediction value of each child node of the current node based on the attribute information of the N neighborhood nodes.

The attribute prediction values of the child nodes of the current node constitute prediction nodes of the current node.

The process in which the encoding side determines the attribute prediction values of the child nodes of the current node based on the attribute information of N neighborhood nodes will be introduced below.

In the embodiments of the present disclosure, the process of determining a respective attribute prediction value of each child node of the current node based on the attribute information of N neighborhood nodes is consistent. For the sake of convenience of description, the process of determining an attribute prediction value of an i-th child node of the current node is used as an example to illustrate.

In the embodiments of the present disclosure, the manners in which the encoding side determines the attribute prediction value of the i-th child node of the current node based on the attribute information of the N neighborhood nodes include but are not limited to the following contents.

In a manner 1, one or several nearest neighborhood nodes to the i-th child node are selected from the N neighboring nodes, and the attribute prediction value of the i-th child node is determined based on the attribute information of the one or several neighborhood nodes. For example, an average value of the attribute information of one or several neighborhood nodes is determined as the attribute prediction value of the i-th child node.

In a manner 2, the S203-A includes the following steps.

In S203-A1, for an i-th child node of the current node, weighted weights between the i-th child node and the N neighborhood nodes are determined based on distances between the i-th child node and the N neighborhood nodes, where i is a positive integer.

In S203-A2, weighting is performed on the attribute information of the N neighborhood nodes to obtain an attribute prediction value of the i-th child node based on the weighted weights between the i-th child node and the N neighborhood nodes.

In the manner 2, the encoding side determines the weighted weights between the i-th child node and the N neighborhood nodes based on the distance between the i-th child node and the N neighborhood nodes, and then performs, based on the weighted weights between the i-th child node and the N neighborhood nodes, weighting on the attribute information of the N neighborhood nodes to obtain the attribute prediction value of the i-th child node.

In some embodiments, the N neighborhood nodes include the current node itself.

Exemplarily, as illustrated in FIG. 13, the current node includes four neighborhood nodes, including the current node itself, aᵤₚ is an i-th child node in the current node, aₖ is a geometric center of the k-th neighborhood node among the four neighborhood nodes, and dₖ is a geometric distance between the i-th child node and the k-th neighborhood node.

Exemplarily, the encoding side determines the attribute prediction value of the i-th child node based on the following formula (27):

$${\hat{a}}_{i} = Round ( {\sum }_{j = 0}^{N - 1} \frac{{\tilde{w}}_{ij}}{{\sum }_{j = 0}^{N - 1} {\tilde{w}}_{ij}} {\hat{a}}_{j} ) ; \qquad ( 27 )$$

where âᵢ represents the attribute prediction value of the i-th child node, j represents an index of the j-th neighborhood node among the N neighborhood nodes, ãⱼ represents attribute information (i.e., the attribute reconstructed value) of the j-th neighborhood node, and \tilde{w}ᵢⱼ represents a weighted weight between the j-th neighborhood node and the i-th child node.

Exemplarily, the weighted weight between the j-th neighborhood node and the i-th child node may be determined by the following formula (28):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} ; \qquad ( 28 )$$

where (xᵢ,yᵢ, zᵢ) is a geometric coordinate of the i-th child node, and (xᵢⱼ, yᵢⱼ, zᵢⱼ) is a geometric coordinate of the j-th neighborhood node.

The above example takes determining the attribute prediction value of the i-th child node in the current node as an example. Other nodes in the current node may also use the above steps to determine attribute prediction values.

After the encoding side determines the respective attribute prediction value of each child node in the current node based on the above steps, the encoding side performs the step S203-B to perform encoding based on the attribute prediction values of the child nodes of the current node to obtain a bitstream.

The manner in which the encoding side performs encoding based on the attribute prediction values of the child nodes of the current node to obtain the bitstream is not limited in the embodiments of the present disclosure.

In some embodiments, the encoding side subtracts the respective attribute information of each child node of the current node from the respective attribute prediction value of each child node of the current node to obtain the respective attribute residual of each child node in the current node. Next, the respective attribute residual of each child node in the current node is encoded to obtain a bitstream. For example, the respective attribute residual of each child node of the current node is quantized and then encoded to obtain a bitstream.

In some embodiments, the S203-B includes the following steps S203-B1 to S203-B4.

In S203-B1, transform is performed on the attribute prediction values of the child nodes of the current node to obtain prediction values of the transform coefficients of the child nodes of the current node.

In S203-B2, transform is performed on attribute information of the child nodes of the current node to obtain transform coefficients of the child nodes of the current node.

In S203-B3, residuals of transform coefficients of the child nodes of the current node are obtained based on the transform coefficients of the child nodes of the current node and the prediction values of the transform coefficients of the child nodes of the current node.

In S203-B4, the bitstream is obtained based on the residuals of transform coefficients of the child nodes of the current node.

In this embodiment, the encoding side uses a transform prediction method to perform prediction encoding on the respective attribute information of each child node of the current node.

Firstly, the encoding side performs transform on the attribute prediction values of the child nodes of the current node to obtain the prediction values of the transform coefficients of the child nodes of the current node.

Next, the encoding side performs transform on the attribute information of the child nodes of the current node to obtain the transform coefficients of the child nodes of the current node.

Then, the encoding side obtains the residuals of transform coefficients of the child nodes of the current node based on the transform coefficients and the prediction values of the transform coefficients of the child nodes of the current node. For example, the respective transform coefficient of each child node of the current node is subtracted from the respective transform coefficient prediction value of each child node of the current node to obtain the respective transform coefficient residual of each child node.

Finally, encoding is performed based on the residuals of the transform coefficients of the child nodes of the current node to obtain the bitstream.

For example, the residuals of transform coefficients of the child nodes of the current node are directly encoded to obtain the bitstream.

For another example, the residuals of transform coefficients of the child nodes of the current node are quantized and then encoded to obtain the bitstream.

The transform manner in which the encoding side performs transform on the attribute prediction values of the child nodes of the current node to obtain the prediction values of the transform coefficients of the child nodes of the current node is not limited in the embodiments of the present disclosure.

In some embodiments, the encoding side uses region adaptive hierarchical transform (i.e., RAHT transform) to perform prediction transform on the child nodes of the current node. In this case, the transform coefficients include high frequency coefficients (i.e., AC coefficients). In this case, the above steps S203-B1 to S203-B4 may be replaced by the following steps.

In Step 1, region adaptive hierarchical transform is performed on the attribute prediction values of the child nodes of the current node to obtain prediction values of high frequency coefficients of the child nodes of the current node.

In Step 2, region adaptive hierarchical transform is performed on the attribute prediction values of the child nodes of the current node to obtain high frequency coefficients of the child nodes of the current node.

In Step 3, residuals of high frequency coefficients of the child nodes of the current node are obtained based on the high frequency coefficients and the prediction values of high frequency coefficients of the child nodes of the current node.

In Step 4, the bitstream is obtained based on the residuals of high frequency coefficients of the child nodes of the current node.

In this embodiment, if the encoding side uses RAHT transform prediction, as illustrated in FIG. 9B, the encoding side performs RAHT encoding on the attribute prediction values of the child nodes of the current node (i.e., (d) in FIG. 9B) and the attribute information of the child nodes of the current node (i.e., (e) in FIG. 9B), respectively, to obtain the prediction values of AC coefficients and AC coefficients of the child nodes of the current node.

Exemplarily, the encoding side obtains the AC coefficients of the child nodes of the current node by the method shown in the following formula (33):

$$[ \begin{matrix}* \\ {AC}_{1 , orig} \\ ⋮ \\ {AC}_{k - 1 , orig}\end{matrix} ] = {T}_{node 2} [ \begin{matrix}{A}_{1 , orig} / \sqrt{{w}_{1}} \\ ⋮ \\ {A}_{k , orig} / \sqrt{{w}_{k}}\end{matrix} ] ; \qquad ( 33 )$$

where the current node includes k child nodes, A_{1,orig} is attribute information of the first child node of the current node, A_{k,orig} is attribute information of the k-th child node of the current node, AC_{1,orig} to AC_{k-1,orig} are k−1 AC coefficients corresponding to the k child nodes. “*” represents one DC coefficient corresponding to k child nodes. T_{node2} is a transform matrix corresponding to the current node, which is determined by the respective number of points included in each child node of the current node. w₁ is weight corresponding to the first child node, and wₖ is weight corresponding to the k-th child node.

Similarly, the encoding side may determine the prediction values of the AC coefficients of the child nodes of the current node by the method shown in the formula (29).

Next, the encoding side subtracts the AC coefficients of the child nodes of the current node from the prediction values of AC coefficients of the child nodes of the current node to obtain residuals of AC coefficients of the child nodes of the current node.

Exemplarily, the encoding side obtains the residuals of AC coefficients of the child nodes of the current node by the following formula (34):

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ] ; \qquad ( 34 )$$

where the k−1 residuals of the AC coefficient corresponding to the k child nodes included in the current node.

Finally, the RAHT inverse transform is performed based on the reconstructed values of AC coefficients of the child nodes of the current node to obtain the residuals of the AC coefficients of the child nodes of the current node.

In the embodiments of the present disclosure, the encoding side may determine the respective AC coefficient residual of each child node in the current node based on the formula (34), and then obtain the bitstream based on the respective AC coefficient residual of each child node in the current node.

For example, the respective AC coefficient residual of each child node in the current node is directly encoded to obtain the bitstream.

For another example, the respective AC coefficient residual of each child node in the current node is quantized and then encoded to obtain the bitstream.

In the point cloud encoding method provided in the embodiments of the present disclosure, when performing attribute encoding, an encoding side first determines a first parameter, which is used to indicate a neighborhood search range. Then, the encoding side searches for N neighborhood nodes of a current node based on the neighborhood search range indicated by the first parameter, and then performs attribute prediction encoding on the current node based on attribute information of the N neighborhood nodes. That is, in the embodiments of the present disclosure, the first parameter is used to indicate the neighborhood search range, so that the neighborhood search range may be controlled, avoiding large-scale occupation of memory resources during the neighborhood search, thereby saving memory resources of an encoding device and improving attribute encoding performance of the point cloud.

The preferred embodiments of the present disclosure are described in detail above in conjunction with the accompanying drawings; however, the present disclosure is not limited to the specific details in the above embodiments. Within scope of the technical concept of the present disclosure, a variety of simple variations may be made to the technical solution of the present disclosure, and these simple variations all fall within the protection scope of the present disclosure. For example, the various specific technical features described in the above specific embodiments may be combined in any suitable manner without contradiction. In order to avoid unnecessary repetition, the various possible combinations are not described additionally in the present disclosure. As another example, any combination of different implementations of the present disclosure is also possible. Any such combination that does not violate the concept of the present disclosure should be regarded as the contents disclosed in the present disclosure.

It should also be understood that in various method embodiments of the present disclosure, the magnitude of a serial number of each of the above processes does not imply a sequential order of execution, and that the order of execution of the processes should be determined by their function and inherent logic without constituting any limitation of the process of implementing the embodiments of the present disclosure. In addition, in the embodiments of the present disclosure, the term “and/or” is only a description of an association relationship of associated objects, which indicates that there may be three kinds of relationships. In some implementations, “A and/or B” may represent three situations: A exists alone, both A and B exist, and B exists alone. In addition, the character “/” herein generally indicates that the associated objects before and after the character “/” are in an “or” relationship.

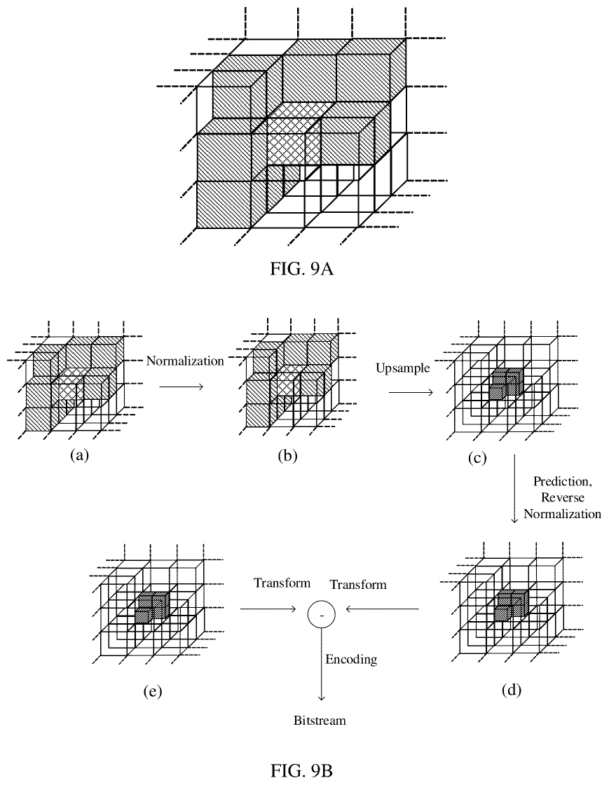

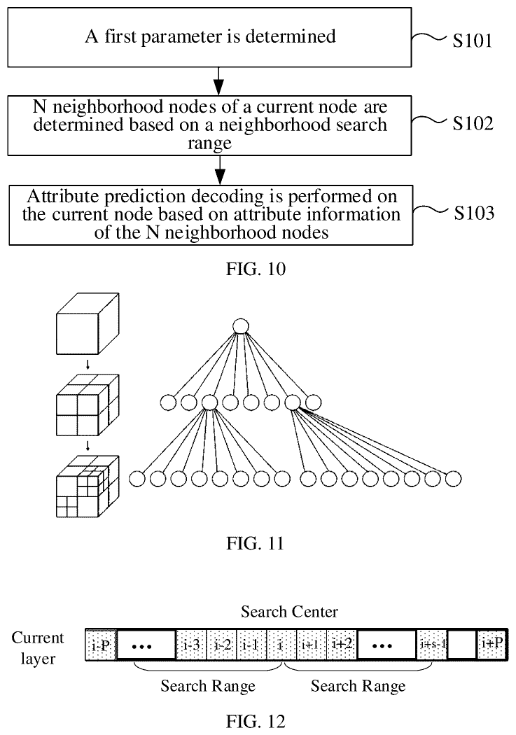

In conjunction with FIGS. 10 to 14, the method embodiments of the present disclosure are described in detail above, and the apparatus embodiments of the present disclosure will be described in detail below in conjunction with FIGS. 15 and 16.

FIG. 15 is a schematic block diagram of a point cloud decoding apparatus provided in the embodiments of the present disclosure.

As illustrated in FIG. 15, the point cloud decoding apparatus 10 may include:
a parameter determining unit 11, configured to determine a first parameter, where the first parameter is used to indicate a neighborhood search range;
a neighborhood node determining unit 12, configured to determine N neighborhood nodes of a current node based on the neighborhood search range, where N is a positive integer; and
a decoding unit 13, configured to perform attribute prediction decoding on the current node based on attribute information of the N neighborhood nodes.

In some embodiments, the parameter determination unit 11 is In some implementations configured to decode a bitstream to obtain the first parameter.

In some embodiments, the bitstream includes an attribute parameter set, the attribute parameter set includes the first parameter, and the parameter determination unit 11 decodes the bitstream to obtain the attribute parameter set, and obtains the first parameter from the attribute parameter set.

In some embodiments, the neighborhood node determining unit 12 is In some implementations configured to determine M nodes to be searched of the current node based on the neighborhood search range, where M is a positive integer; and determine the N neighborhood nodes of the current node based on the M nodes to be searched.

In some embodiments, the neighborhood node determining unit 12 is In some implementations configured to determine, based on the neighborhood search range, the M nodes to be searched among nodes included in a current level where the current node is located.

In some embodiments, the neighborhood node determining unit 12 is In some implementations configured to determine, based on the neighborhood search range and the current node, the M nodes to be searched among the nodes included in the current level.

In some embodiments, the neighborhood node determining unit 12 is In some implementations configured to determine the M nodes to be searched among the nodes included in the current level by taking the current node as a search center and taking the neighborhood search range as a search radius.

In some embodiments, the neighborhood node determining unit 12 is In some implementations configured to obtain the N neighborhood nodes by searching among the M nodes to be searched based on geometric information of the current node and geometric information of the M nodes to be searched.

In some embodiments, the N neighborhood nodes include at least one of: at least one node co-planar with the current node, at least one node co-edge with the current node, or at least one node co-vertex with the current node.

In some embodiments, the N neighborhood nodes include the current node.

In some embodiments, the neighborhood node determining unit 12 is further configured to: before determining the N neighborhood nodes of the current node based on the M nodes to be searched, store the M nodes to be searched in a neighborhood reference buffer; and determine the N neighborhood nodes of the current node based on nodes included in the neighborhood reference buffer.

In some embodiments, the neighborhood node determining unit 12 is In some implementations configured to delete all nodes in the neighborhood reference buffer, and store the M nodes to be searched in the neighborhood reference buffer.

In some embodiments, the neighborhood node determining unit 12 configured to delete nodes in the neighborhood reference buffer that are different from the M nodes to be searched, to obtain a neighborhood reference buffer after the nodes are deleted; and store nodes among the M nodes to be searched that are different from nodes in the neighborhood reference buffer after the nodes are deleted.

In some embodiments, the decoding unit 13 is configured to determine attribute prediction values of child nodes of the current node based on the attribute information of the N neighborhood nodes; and obtain attribute reconstructed values of the child nodes of the current node based on the attribute prediction values of the child nodes of the current node.

In some embodiments, the decoding unit 13 is configured to, for an i-th child node of the current node, determine weighted weights between the i-th child node and the N neighborhood nodes based on distances between the i-th child node and the N neighborhood nodes, where i is a positive integer; and perform, based on the weighted weights between the i-th child node and the N neighborhood nodes, weighting on the attribute information of the N neighborhood nodes to obtain an attribute prediction value of the i-th child node.

In some embodiments, the decoding unit 13 is configured to decode the bitstream to obtain residuals of transform coefficients of the child nodes of the current node; perform transform on the attribute prediction values of the child nodes of the current node to obtain prediction values of the transform coefficients of the child nodes of the current node; obtain reconstructed values of the transform coefficients of the child nodes of the current node based on the residuals of the transform coefficients and the prediction values of the transform coefficients of the child nodes of the current node; and perform inverse transform on the reconstructed values of the transform coefficients of the child nodes of the current node to obtain the attribute reconstructed values of the child nodes of the current node.

In some embodiments, the transform coefficients include high frequency coefficients; the decoding unit 13 is configured to decode the bitstream to obtain residuals of the high frequency coefficients of the child nodes of the current node; perform region adaptive hierarchical transform on the attribute prediction values of the child nodes of the current node to obtain prediction values of the high frequency coefficients of the child nodes of the current node; obtain reconstructed values of the high frequency coefficients of the child nodes of the current node based on the residuals of the high frequency coefficients and the prediction values of the high frequency coefficients of the child nodes of the current node; and perform inverse region adaptive hierarchical transform based on the reconstructed values of high frequency coefficients of the child nodes of the current node, to obtain the attribute reconstructed values of the child nodes of the current node.

In some embodiments, the decoding unit 13 is configured to perform, based on a low frequency coefficient of the current node and the reconstructed values of the high frequency coefficients of the child nodes of the current node, inverse region adaptive hierarchical transform to obtain the attribute reconstructed values of the child nodes of the current node.

It should be understood that the apparatus embodiments and the method embodiments may correspond to each other, and similar descriptions may be referred to that of the method embodiments, which will not be repeated here to avoid repetition. In some implementations, the point cloud decoding apparatus 10 illustrated in FIG. 15 may correspond to a corresponding subject performing the point cloud decoding method in the embodiments of the present disclosure, and the above and other operations and/or functions of each unit in the point cloud decoding apparatus 10 are respectively for implementing corresponding processes in the point cloud decoding method, which will not be repeated here for the sake of brevity.

FIG. 16 is a schematic block diagram of a point cloud encoding apparatus provided in the embodiments of the present disclosure.

As illustrated in FIG. 16, the point cloud encoding apparatus 20 includes:
a parameter determining unit 21, configured to determine a first parameter, where the first parameter is used to indicate a neighborhood search range;
a neighborhood node determining unit 22, configured to determine N neighborhood nodes of a current node based on the neighborhood search range, where N is a positive integer; and
an encoding unit 23, configured to perform attribute prediction encoding on the current node based on attribute information of the N neighborhood nodes.

In some embodiments, the encoding unit 23 is further configured to signal the first parameter into a bitstream.

In some embodiments, the bitstream includes an attribute parameter set, and the encoding unit 23 is configured to signal the first parameter into the attribute parameter set.

In some embodiments, the neighborhood node determining unit 22 is configured to determine M nodes to be searched of the current node based on the neighborhood search range, where M is a positive integer; and determine the N neighborhood nodes of the current node based on the M nodes to be searched.

In some embodiments, the neighborhood node determining unit 22 is configured to determine, based on the neighborhood search range, the M nodes to be searched among nodes included in a current level where the current node is located.

In some embodiments, the neighborhood node determining unit 22 is configured to determine, based on the neighborhood search range and the current node, the M nodes to be searched among the nodes included in the current level.

In some embodiments, the neighborhood node determining unit 22 is configured to determine the M nodes to be searched among the nodes included in the current level by taking the current node as a search center and taking the neighborhood search range as a search radius.

In some embodiments, the neighborhood node determining unit 22 is configured to obtain the N neighborhood nodes by searching among the M nodes to be searched based on geometric information of the current node and geometric information of the M nodes to be searched.

In some embodiments, the N neighborhood nodes include at least one of: at least one node co-planar with the current node, at least one node co-edge with the current node, or at least one node co-vertex with the current node.

In some embodiments, the N neighborhood nodes include the current node.

In some embodiments, the neighborhood node determining unit 22 is further configured to: before determining the N neighborhood nodes of the current node based on the M nodes to be searched, store the M nodes to be searched in a neighborhood reference buffer; and determine the N neighborhood nodes of the current node based on nodes included in the neighborhood reference buffer.

In some embodiments, the neighborhood node determining unit 22 is configured to delete all nodes in the neighborhood reference buffer, and store the M nodes to be searched in the neighborhood reference buffer.

In some embodiments, the neighborhood node determining unit 22 is used to delete nodes in the neighborhood reference buffer that are different from the M nodes to be searched, to obtain a neighborhood reference buffer after the nodes are deleted; and store nodes among the M nodes to be searched that are different from nodes in the neighborhood reference buffer after the nodes are deleted.

In some embodiments, the encoding unit 23 is configured to determine attribute prediction values of child nodes of the current node based on the attribute information of the N neighborhood nodes; and perform encoding based on the attribute prediction values of the child nodes of the current node to obtain the bitstream.

In some embodiments, the encoding unit 23 is configured to: for an i-th child node included in the current node, determine weighted weights between the i-th child node and the N neighborhood nodes based on distances between the i-th child node and the N neighborhood nodes, where i is a positive integer; and perform, based on the weighted weights between the i-th child node and the N neighborhood nodes, weighting on the attribute information of the N neighborhood nodes to obtain an attribute prediction value of the i-th child node.

In some embodiments, the encoding unit 23 is configured to perform transform on the attribute prediction values of the child nodes of the current node to obtain prediction values of transform coefficients of the child nodes of the current node; perform transform on attribute information of the child nodes of the current node to obtain the transform coefficients of the child nodes of the current node; obtain residuals of the transform coefficients of the child nodes of the current node based on the transform coefficients of the child nodes of the current node and the prediction values of the transform coefficients of the child nodes of the current node; and obtain the bitstream based on the residuals of the transform coefficients of the child nodes of the current node.

In some embodiments, the encoding unit 23 is configured to perform region adaptive hierarchical transform on the attribute prediction values of the child nodes of the current node to obtain prediction values of high frequency coefficients of the child nodes of the current node; perform region adaptive hierarchical transform on the attribute prediction values of the child nodes of the current node to obtain the high frequency coefficients of the child nodes of the current node; obtain residuals of the high frequency coefficients of the child nodes of the current node based on the high frequency coefficients and the prediction values of the high frequency coefficients of the child nodes of the current node; and obtain the bitstream based on the residuals of the high frequency coefficients of the child nodes of the current node.

It should be understood that the apparatus embodiments and the method embodiments may correspond to each other, and similar descriptions may be referred to that of the method embodiments, which will not be repeated here to avoid repetition. In some implementations, the point cloud encoding apparatus 20 illustrated in FIG. 16 may correspond to a corresponding subject performing the point cloud encoding method in the embodiments of the present disclosure, and the above and other operations and/or functions of each unit in the point cloud encoding apparatus 20 are respectively for implementing corresponding processes in the point cloud encoding method, which will not be repeated here for the sake of brevity.

The above describes the apparatuses and the system of the embodiments of the present disclosure from the perspective of functional units in conjunction with the accompanying drawings. It should be understood that the functional units may be implemented in the form of hardware, or may be implemented by instructions in the form of software, or may be implemented by a combination of hardware units and software units. In some implementations, each step of the method embodiments in the embodiments of the present disclosure may be completed by the hardware integrated logic circuit and/or software instructions in the processor. The steps of the method disclosed in the embodiments of the present disclosure may be directly embodied as being performed by a hardware decoding processor, or being performed by a combination of hardware units and software units in the decoding processor. Optionally, the software unit may be located in a mature storage medium in the art, such as a random access memory, a flash memory, a read-only memory, a programmable read-only memory, an electrically erasable programmable memory, and a register. The storage medium is located in the memory, and the processor reads the information in the memory and completes the steps in the above method embodiments in conjunction with its hardware.

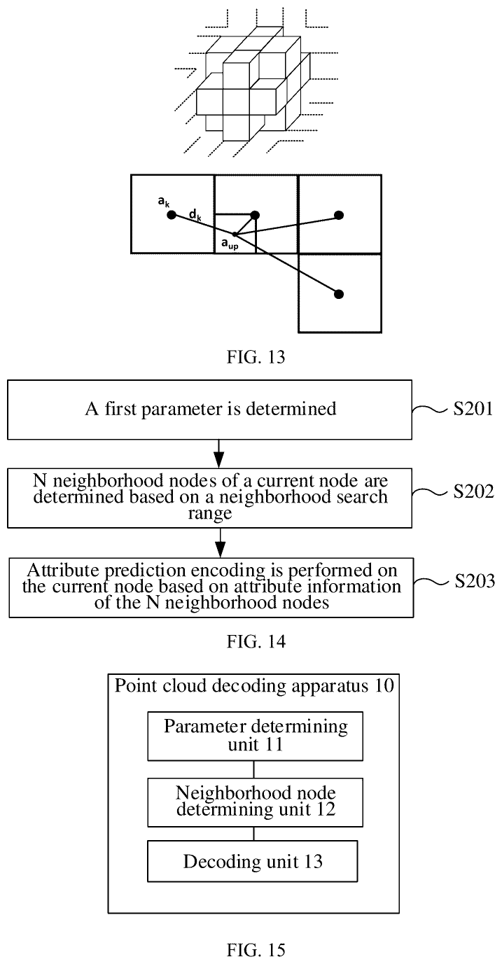

FIG. 17 is a schematic block diagram of an electronic device provided in embodiments of the present disclosure.

As illustrated in FIG. 17, the electronic device 30 may be the point cloud decoding apparatus or the point cloud encoding apparatus as described in the embodiments of the present disclosure, and the electronic device 30 may include:
a memory 31 and a processor 32, where the memory 31 is used to store a computer program 34 and transmit the computer program 34 to the processor 32, in other words, the processor 32 may call the computer program 34 from the memory 31 and run the computer program 34, to implement the method in the embodiments of the present disclosure.

For example, the processor 32 may be used to perform the steps in the method according to the instructions in the computer program 34.

In some embodiments of the present disclosure, the processor 32 may include but is not limited to:
a general purpose processor, a digital signal processor (DSP), an application specific integrated circuits (ASIC), a field programmable gate array (FPGA) or other programmable logic device, a discrete gate. a transistor logic device, a discrete hardware component, or the like.

In some embodiments of the present disclosure, the memory 31 includes but is not limited to:
a volatile (transitory) memory and/or a non-volatile (non-transitory) memory, where the non-volatile memory may be a read-only memory (ROM), a programmable read-only memory (programmable ROM, PROM), an erasable programmable read-only memory (Erasable PROM, EPROM), an electrically erasable programmable read-only memory (Electrically, EEPROM), or a flash memory; and the volatile memory may be a random access memory (RAM), serving as an external cache. As an example and not limitation, a variety of forms of RAMs are available, such as a static random access memory (Static RAM, SRAM), a dynamic random access memory (Dynamic RAM, DRAM), a synchronous dynamic random access memory (Synchronous, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM), and a direct memory bus random access memory (Direct Rambus RAM, DR RAM).

In some embodiments of the present disclosure, the computer program 34 may be partitioned into one or more units. The one or more units are stored in the memory 31 and performed by the processor 32, to complete the method provided in the present disclosure. The one or more units may be a series of computer program instruction segments capable of completing specific functions, and the instruction segments are used to describe the performing process of the computer program 34 in the electronic device 30.

As illustrated in FIG. 17, the electronic device 30 may further include:
a transceiver 33, where the transceiver 33 is connectable to the processor 32 or the memory 31.

The processor 32 may control the transceiver 33 to communicate with other devices, and in some implementations, may control the transceiver 33 to transmit information or data to other devices, or control the transceiver 33 to receive information or data transmitted by other devices. The transceiver 33 may include a transmitter and a receiver. The transceiver 33 may further include an antenna, and there may be one or more antennas.

It should be understood that various components in the electronic device 30 are connected via a bus system, where the bus system includes not only a data bus but also a power bus, a control bus and a status signal bus.

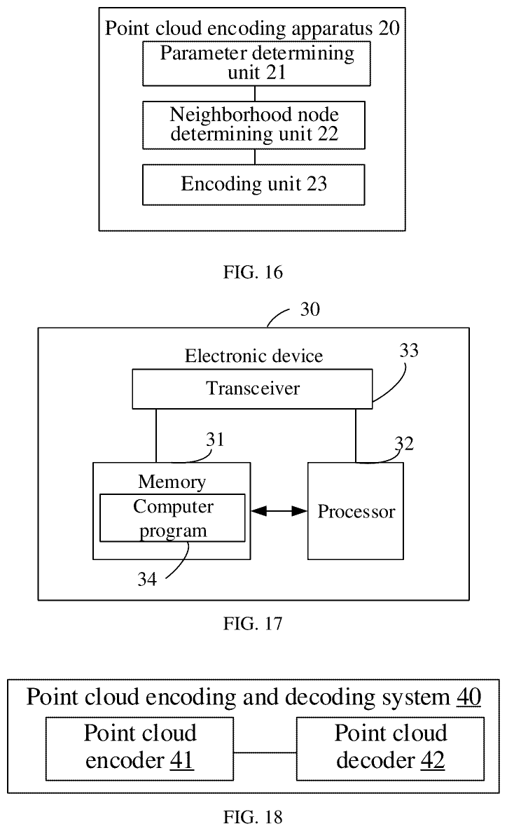

FIG. 18 is a schematic block diagram of a point cloud encoding and decoding system provided in embodiments of the present disclosure.

As illustrated in FIG. 18, the point cloud encoding and decoding system 40 may include: a point cloud encoder 41 and a point cloud decoder 42, where the point cloud encoder 41 is used to perform the point cloud encoding method involved in the embodiments of the present disclosure, and the point cloud decoder 42 is used to perform the point cloud decoding method involved in the embodiments of the present disclosure.

The present disclosure further provides a bitstream, which is generated according to the above encoding method.

The present disclosure further provides a non-transitory computer storage medium with a computer program stored thereon. The computer program, when being executed on a computer, enables the computer to perform the method of the above method embodiments. In other words, the embodiments of the present disclosure further provide a computer program product including instructions, where the instructions, when being executed on a computer, enable the computer to perform the method of the above method embodiments.

When implemented using software, all or part of the above embodiments may be implemented in a form of a computer program product. The computer program product includes one or more computer instructions. When loaded and executed on a computer, the computer program instructions produce, in all or in part, a process or function in accordance with the embodiments of the present disclosure. The computer may be a general purpose computer, a special purpose computer, a computer network, or any of other programmable apparatuses. The computer instructions may be stored in a non-transitory computer-readable storage medium, or transmitted from one non-transitory computer-readable storage medium to another non-transitory computer-readable storage medium. For example, the computer instructions may be transmitted from a website, a computer, a server, or a data center to another website, computer, server, or data center through wired manner (e.g., coaxial cable, optical fiber, or digital subscriber line (DSL)) or wireless (e.g., infrared, radio, or microwave) manner. The non-transitory computer-readable storage medium may be any available medium to which a computer can access or may be a data storage device, such as a server or a data center that includes one or more available media. The available medium may be a magnetic medium (e.g., a floppy disk, a hard disk, or a magnetic tape), an optical medium (e.g., a digital video disc (DVD)), or a semiconductor medium (e.g., a solid state disk (SSD)).

Those skilled in the art will appreciate that the units and algorithm steps of each example described in conjunction with the embodiments disclosed herein may be implemented by electronic hardware, or a combination of computer software and electronic hardware. Whether these functions are performed in hardware or software depends on the specific application and design constraints of the technical solution. Professional technicians may use different methods to implement the described functions for each specific application, but such implementation should not be considered to be beyond the scope of the present disclosure.

In several embodiments provided by the present disclosure, it should be understood that the disclosed system, apparatuses and methods may be implemented in other manners. For example, the apparatus embodiments described above are only schematic. For example, the partition of the units is only partition of logical functions, and there may be other partition manners in the actual implementation, such as a plurality of units or components may be combined or integrated into another system, or some features may be ignored or not implemented. In addition, the mutual coupling or direct coupling or communication connection illustrated or discussed may be indirect coupling or communication connection through some interfaces, apparatuses or units, which may be in electrical, mechanical or other forms.

The units described as discrete components may or may not be physically separated, and the components illustrated as units may or may not be physical units, that is, they may be located at one place, or may be distributed onto a plurality of network units. Some or all of these units may be selected depending on actual requirements to fulfill the purpose of the solution of the embodiments. For example, various functional units in various embodiments of the present disclosure may be integrated into one processing unit, or various units may exist physically alone, or two or more units may be integrated into one unit.

The foregoing descriptions are merely specific implementations of the present disclosure, but the protection scope of the present disclosure is not limited thereto. Any skilled person in the art could readily conceive of variations or replacements within the technical scope of the present disclosure, which shall be all included in the protection scope of the present disclosure. Therefore, the protection scope of the present disclosure shall be subject to the protection scope of claims.

What is claimed is:

1. A point cloud decoding method, comprising:
determining a first parameter, wherein the first parameter is used to indicate a neighborhood search range;
determining N neighborhood nodes of a current node based on the neighborhood search range, wherein N is a positive integer; and
performing attribute prediction decoding on the current node based on attribute information of the N neighborhood nodes.

2. The method according to claim 1, wherein determining the first parameter comprises:
decoding a bitstream to obtain the first parameter,
wherein the bitstream comprises an attribute parameter set, the attribute parameter set comprises the first parameter, and decoding the bitstream to obtain the first parameter comprises:
decoding the bitstream to obtain the attribute parameter set, and obtaining the first parameter from the attribute parameter set.

3. The method according to claim 1, wherein determining the N neighborhood nodes of the current node based on the neighborhood search range comprises:
determining M nodes to be searched of the current node based on the neighborhood search range, wherein M is a positive integer; and
determining the N neighborhood nodes of the current node based on the M nodes to be searched.

4. The method according to claim 3, wherein determining the M nodes to be searched of the current node based on the neighborhood search range comprises:
determining, based on the neighborhood search range, the M nodes to be searched among nodes comprised in a current level where the current node is located.

5. The method according to claim 4, wherein determining, based on the neighborhood search range, the M nodes to be searched among the nodes comprised in the current level where the current node is located comprises:
determining, based on the neighborhood search range and the current node, the M nodes to be searched among the nodes comprised in the current level.

6. The method according to claim 3, wherein determining the N neighborhood nodes of the current node based on the M nodes to be searched comprises:
obtaining the N neighborhood nodes by searching among the M nodes to be searched based on geometric information of the current node and geometric information of the M nodes to be searched.

7. The method according to claim 1, wherein the N neighborhood nodes comprise at least one of: at least one node co-planar with the current node, at least one node co-edge with the current node, or at least one node co-vertex with the current node.

8. The method according to claim 1, wherein performing attribute prediction decoding on the current node based on the attribute information of the N neighborhood nodes comprises:
determining attribute prediction values of child nodes of the current node based on the attribute information of the N neighborhood nodes; and
obtaining attribute reconstructed values of the child nodes of the current node based on the attribute prediction values of the child nodes of the current node.

9. The method according to claim 8, wherein determining the attribute prediction values of the child nodes of the current node based on the attribute information of the N neighborhood nodes comprises:
for an i-th child node of the current node, determining weighted weights between the i-th child node and the N neighborhood nodes based on distances between the i-th child node and the N neighborhood nodes, wherein i is a positive integer; and
performing, based on the weighted weights between the i-th child node and the N neighborhood nodes, weighting on the attribute information of the N neighborhood nodes to obtain an attribute prediction value of the i-th child node.

10. The method according to claim 8, wherein obtaining the attribute reconstructed values of the child nodes of the current node based on the attribute prediction values of the child nodes of the current node comprises:
decoding a bitstream to obtain residuals of transform coefficients of the child nodes of the current node;
performing transform on the attribute prediction values of the child nodes of the current node to obtain prediction values of the transform coefficients of the child nodes of the current node;
obtaining reconstructed values of the transform coefficients of the child nodes of the current node based on the residuals of the transform coefficients and the prediction values of the transform coefficients of the child nodes of the current node; and
performing inverse transform on the reconstructed values of the transform coefficients of the child nodes of the current node to obtain the attribute reconstructed values of the child nodes of the current node.

11. The method according to claim 10, wherein the transform coefficients comprise high frequency coefficients; and
decoding the bitstream to obtain the residuals of the transform coefficients of the child nodes of the current node comprises: decoding the bitstream to obtain residuals of the high frequency coefficients of the child nodes of the current node;
performing transform on the attribute prediction values of the child nodes of the current node to obtain the prediction values of the transform coefficients of the child nodes of the current node comprises: performing region adaptive hierarchical transform on the attribute prediction values of the child nodes of the current node to obtain prediction values of the high frequency coefficients of the child nodes of the current node;
obtaining the reconstructed values of the transform coefficients of the child nodes of the current node based on the residuals of the transform coefficients and the prediction values of the transform coefficients of the child nodes of the current node comprises: obtaining reconstructed values of the high frequency coefficients of the child nodes of the current node based on the residuals of the high frequency coefficients and the prediction values of the high frequency coefficients of the child nodes of the current node; and
performing inverse transform on the reconstructed values of the transform coefficients of the child nodes of the current node to obtain the attribute reconstructed values of the child nodes of the current node comprises: performing inverse region adaptive hierarchical transform based on the reconstructed values of the high frequency coefficients of the child nodes of the current node, to obtain the attribute reconstructed values of the child nodes of the current node.

12. The method according to claim 11, wherein performing inverse region adaptive hierarchical transform based on the reconstructed values of the high frequency coefficients of the child nodes of the current node to obtain the attribute reconstructed values of the child nodes of the current node comprises:
performing, based on a low frequency coefficient of the current node and the reconstructed values of the high frequency coefficients of the child nodes of the current node inverse region adaptive hierarchical transform to obtain the attribute reconstructed values of the child nodes of the current node.

13. A point cloud encoding method, comprising:
determining a first parameter, wherein the first parameter is used to indicate a neighborhood search range;
determining N neighborhood nodes of a current node based on the neighborhood search range, wherein N is a positive integer; and
performing attribute prediction encoding on the current node based on attribute information of the N neighborhood nodes.

14. The method according to claim 13, further comprising:
signaling the first parameter into a bitstream,
wherein the bitstream comprises an attribute parameter set, and signaling the first parameter into the bitstream comprises:
signaling the first parameter into the attribute parameter set.

15. The method according to claim 13, wherein determining the N neighborhood nodes of the current node based on the neighborhood search range comprises:
determining M nodes to be searched of the current node based on the neighborhood search range, wherein M is a positive integer; and
determining the N neighborhood nodes of the current node based on the M nodes to be searched.

16. The method according to claim 15, wherein determining the M nodes to be searched of the current node based on the neighborhood search range comprises:
determining, based on the neighborhood search range, the M nodes to be searched among nodes comprised in a current level where the current node is located.

17. The method according to claim 16, wherein determining, based on the neighborhood search range, the M nodes to be searched among the nodes comprised in the current level where the current node is located comprises:
determining, based on the neighborhood search range and the current node, the M nodes to be searched among the nodes comprised in the current level.

18. The method according to claim 15, wherein determining the N neighborhood nodes of the current node based on the M nodes to be searched comprises:
obtaining the N neighborhood nodes by searching among the M nodes to be searched based on geometric information of the current node and geometric information of the M nodes to be searched.

19. The method according to claim 13, wherein the N neighborhood nodes comprise at least one of: at least one node co-planar with the current node, at least one node co-edge with the current node, or at least one node co-vertex with the current node.

20. A non-transitory computer-readable storage medium, wherein the non-transitory computer-readable storage medium is configured to store a computer program and a bitstream, and the computer program enables a computer to perform following operations to generate the bitstream:
determine a first parameter, wherein the first parameter is used to indicate a neighborhood search range;
determine N neighborhood nodes of a current node based on the neighborhood search range, wherein N is a positive integer; and
perform attribute prediction decoding on the current node based on attribute information of the N neighborhood nodes.
